(19) United States
(12) Patent Application Publication
(10) Pub. No.: US 2025/0138141 A1
(43) Pub. Date: May 1, 2025

(54) RADAR APPARATUS AND METHOD FOR TRANSMISSION AND RECEPTION BY RADAR APPARATUS

(71) Applicant: Panasonic Automotive Systems Co., Ltd., Kanagawa (JP)

(72) Inventor: Takaaki KISHIGAMI, Tokyo (JP)

(21) Appl. No.: 18/923,245

(22) Filed: Oct. 22, 2024

(30) Foreign Application Priority Data
Oct. 30, 2023 (JP) 2023-185377

(51) Int. Cl. G01S 7/03; G01S 7/285; G01S 13/46

(52) U.S. Cl. CPC G01S 7/03; G01S 7/285; G01S 13/46; G01S 2013/466

(57) ABSTRACT

A radar apparatus includes: first radar circuitry that includes a plurality of first transmission antennas and a plurality of first reception antennas; and second radar circuitry that includes a plurality of second transmission antennas and a plurality of second reception antennas, in which the plurality of first transmission antennas transmit a first transmission signal having a predetermined center frequency, the plurality of second transmission antennas transmit a second transmission signal having the predetermined center frequency, the plurality of first reception antennas receive at least one of a first reflected wave signal corresponding to the first transmission signal and a second reflected wave signal corresponding to the second transmission signal, the plurality of second reception antennas receive at least one of the first reflected wave signal and the second reflected wave signal, and in a first direction, a minimum spacing between the plurality of first transmission antennas and a minimum spacing between the plurality of second reception antennas are different from each other by one wavelength or more of the first and the second transmission signals, and a minimum spacing between the plurality of first reception antennas and a minimum spacing between the plurality of second transmission antennas are different from each other by one wavelength or more of the first and the second transmission signals.

### TECHNICAL FIELD

The present disclosure relates to a radar apparatus and a method for transmission and reception by a radar apparatus.

### BACKGROUND ART

Recently, studies have been developed on radar apparatuses that use a radar transmission signal (hereinafter, referred to as “TxSig”) of a short wavelength including a microwave or a millimeter wave that can achieve high resolution. Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

### PTL 1

U.S. Patent Application Publication No. 2020/0300965

### PTL 2

U.S. Patent Application Publication No. 2022/0244370

### PTL 3

Japanese Patent Application Laid-Open No. 2020-148754

### PTL 4

Japanese Patent Application Laid-Open No. 2020-204603

### Non-Patent Literature

### NPL 1

J. Li, and P. Stoica, “MIMO Radar with Colocated Antennas,” Signal Processing Magazine, IEEE Vol. 24, Issue: 5, pp. 106-114, 2007

### NPL 2

E. Fishler, A. Haimovich, R. Blum, D. Chizhik, L. Cimini and R. Valenzuela, “MIMO radar: an idea whose time has come,” Proceedings of the 2004 IEEE Radar Conference, 2004, pp. 71-78

### NPL 3

B. Meinecke, D. Werbunat, Q. Haidari, M. Linder and C. Waldschmidt, “Near-Field Compensation for Coherent Radar Networks,” IEEE Microwave and Wireless Components Letters, vol. 32, no. 10, pp. 1251-1254.

### NPL 4

M. Kronauge, H. Rohling, “Fast two-dimensional CFAR procedure,” IEEE Trans. Aerosp. Electron. Syst., 2013, 49, (3), pp. 1817-1823

### NPL 5

Direction-of-arrival estimation using signal subspace modeling Cadzow, J. A.; Aerospace and Electronic Systems, IEEE Transactions on Volume: 28, Issue: 1 Publication Year: 1992,

### NPL 6

H. Yan, J. Li and G. Liao, “Multitarget Identification and Localization Using Bistatic MIMO Radar Systems,” EURASIP Journal on Advances In Signal Processing, vol. 2008, Article ID 283483, 8 pages, 2008.

### SUMMARY OF INVENTION

However, methods for a radar apparatus (e.g., MIMO radar) to sense a target object (or a target) have not been comprehensively studied.

A non-limiting embodiment of the present disclosure contributes to providing a radar apparatus and a method for transmission and reception by a radar apparatus, with which it is possible to efficiently detect a target object.

A radar apparatus according to an exemplary embodiment of the present disclosure includes: first radar circuitry that includes a plurality of first transmission antennas and a plurality of first reception antennas; and second radar circuitry that includes a plurality of second transmission antennas and a plurality of second reception antennas, in which the plurality of first transmission antennas transmit a first transmission signal having a predetermined center frequency the plurality of second transmission antennas transmit a second transmission signal having the predetermined center frequency, the plurality of first reception antennas receive at least one of a first reflected wave signal corresponding to the first transmission signal and a second reflected wave signal corresponding to the second transmission signal, the plurality of second reception antennas receive at least one of the first reflected wave signal and the second reflected wave signal, and the minimum spacing between the plurality of first transmission antennas and the minimum spacing between the plurality of second reception antennas in the first direction are 0.5 wavelengths or more and less than one wavelength of the first and the second transmission signals.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, a radar apparatus is capable of efficiently detecting a target object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a radar apparatus having a mono-& multi-static configuration;

FIG. 2 illustrates exemplary positioning using a radar apparatus including a multi-static configuration;

FIG. 3 is a block diagram illustrating an exemplary configuration of the radar apparatus;

FIG. 4 is a block diagram illustrating an exemplary configuration of a radar apparatus;

FIG. 5 illustrates an exemplary transmission signal;

FIG. 6 illustrates an exemplary chirp signal;

FIG. 7 illustrates an arrangement example of MIMO antennas;

FIG. 8 illustrates an arrangement example of virtual reception antennas;

FIG. 9 illustrates an arrangement example of MIMO antennas;

FIG. 10 illustrates an arrangement example of virtual reception antennas;

FIG. 11 illustrates an arrangement example of MIMO antennas;

FIG. 12 illustrates an arrangement example of virtual reception antennas;

FIG. 13 illustrates an arrangement example of MIMO antennas;

FIG. 14 illustrates an arrangement example of virtual reception antennas;

FIG. 15 illustrates an arrangement example of MIMO antennas;

FIG. 16 illustrates an arrangement example of MIMO antennas;

FIG. 17 illustrates an arrangement example of MIMO antennas;

FIG. 18 illustrates an arrangement example of MIMO antennas;

FIG. 19 illustrates an arrangement example of MIMO antennas;

FIG. 20 illustrates an arrangement example of MIMO antennas; and

FIG. 21 illustrates an arrangement example of MIMO antennas.

### DESCRIPTION OF EMBODIMENTS

MIMO radars are roughly divided into, for example, a “monostatic configuration” and a bistatic configuration or a multistatic configuration (hereinafter, referred to as a “bistatic/multistatic configuration”). Hereinafter, the monostatic configuration is referred to as a “MNS configuration,” and the bistatic/multistatic configuration is referred to as a “BMS configuration.”

The MNS configuration may, for example, be a configuration in which a transmitter (for example, including a plurality of transmission antennas and a high-frequency radio) and a receiver (for example, including a plurality of reception antennas and a high-frequency radio) are included in the same housing.

In the BMS configuration, for example, the transmitter and the receiver may be included respectively in different housings. For example, the BMS configuration is a configuration in which the housings are installed at distances apart from each other, and the transmitter and the receiver are connected to a controller that performs synchronization control. In the bistatic configuration, for example, a pair of the transmitter and the receiver is provided, and the transmitter and the receiver are disposed at distances apart from each other. The multistatic configuration is, for example, a configuration in which at least one or both of the transmitter and the receiver are plural. The multistatic configuration is disclosed in, for example, NPL 2.

In the following, a non-limiting exemplary embodiment of the present disclosure focuses on the BMS configuration. For example, in the non-limiting exemplary embodiment, the BMS configuration using a plurality of MIMO radars having the MNS configuration will be described. The BMS configuration using a plurality of MIMO radars having the MNS configuration may be referred to as a “mono-& multi-static configuration,” for example.

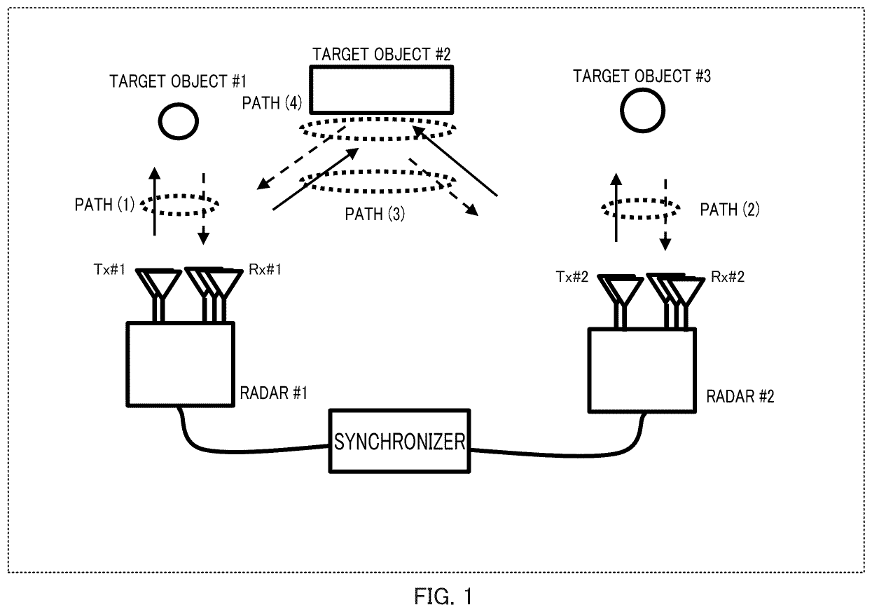

FIG. 1 illustrates an exemplary radar apparatus having the mono-& multi-static configuration in which radar #1 and radar #2 being MIMO radars having the MNS configuration are used.

Radar #1 is, for example, a “first MIMO radar having the MNS configuration” that outputs a radar transmission wave (also referred to as “TxSig”) from radar transmission antenna group Tx #1 and receives a reflected wave signal from target object #1 by radar reception antenna group Rx #1 in the same housing (for example, path (1)).

Similarly, radar #2 is, for example, a “second MIMO radar having the MNS configuration” that outputs a radar transmission wave from radar transmission antenna group Tx #2 and receives a reflected wave signal from target object #3 by radar reception antenna group Rx #2 in the same housing (for example, path (2)).

Further, the radar apparatus illustrated in FIG. 1 may also perform an operation of transmitting a radar transmission wave from transmission antenna group Tx #1 of radar #1 and receiving a reflected wave signal from target object #2 by reception antenna group Rx #2 of radar #2. The radar apparatus performing this operation may be regarded as, for example, a “first MIMO radar having the BMS configuration” (for example, path (3)).

Similarly, the radar apparatus illustrated in FIG. 1 may also perform an operation of transmitting a radar transmission wave from transmission antenna group Tx #2 of radar #2 and receiving a reflected wave signal from target object #2 at the reception antenna group Rx #1 of radar #1. The radar apparatus performing this operation may be regarded as, for example, a “MIMO radar having a second BMS configuration” (for example, path (4)).

For using a radar not only as the radar having the MNS configuration, but also as the radar having the BMS configuration, a synchronizer that performs synchronization control between a plurality of radars having the MNS configuration installed at distant positions may, for example, be used. For example, in FIG. 1, when a Frequency modulated continuous wave (FMCW) signal (for example, a “chirp signal”) is used as the radar transmission wave, the synchronizer may generate the chirp signal and supply a common chirp signal to radar #1 and radar #2. Thus, such a radar can be used as the first MIMO radar having the MNS configuration and the second MIMO radar having the MNS configuration, and can also be used as the first MIMO radar having the BMS configuration and the second MIMO radar having the BMS configuration.

The radar apparatus illustrated in FIG. 1 may generate TxSig in the synchronizer and provide TxSig to both radar #1 and radar #2.

For example, when the first and second radars of the MNS configuration operate at the same time using the same radar transmission wave, interference may occur with each other, so that erroneous detection or missed detection may easily occur, and the positioning accuracy or the detection performance of the radar may deteriorate. Therefore, for example, for the transmission by the radars having the BMS configuration using the first and second radars having the MNS configuration, there may be application of multiplexing transmission in which Time Division Multiplexing (TDM) or Code Division Multiplexing (CDM) is applied.

Note that the radar apparatus according to an exemplary embodiment of the present disclosure may be mounted on a mobile entity such as a vehicle, for example. For example, the radar apparatus may be mounted near at least one of the front and rear corners of a vehicle, or may be mounted near at least one of the front and rear centers of the vehicle or near corners from the centers.

A positioning output (information on an estimation result) of the radar apparatus mounted on a mobile entity may be output to, for example, an Advanced Driver Assistance System (ADAS) that enhances collision safety or a control Electronic Control Unit (ECU) (not illustrated) such as an automated driving system, and may be used for vehicle-drive control or alarm call control.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians, or a suspicious person intrusion prevention system. Further, the positioning output of the radar apparatus may be output to, for example, a control apparatus (not illustrated) in the support system for enhancing the safety or the suspicious person intrusion prevention system, and may be used for alarm call control or abnormality detection control.

The use of the radar apparatus is not limited to the above, and the radar apparatus may also be used for other uses.

Further, the target object is an object to be detected by the radar apparatus, and includes, for example, a vehicle (including four wheels and two wheels), a person, a block, a curbstone, or the like.

Embodiments according to exemplary embodiments of the present disclosure will be described below in detail with reference to the accompanying drawings. In the embodiments, the same constituent elements are identified with the same numerals, and a description thereof is omitted because of redundancy.

For example, a MIMO radar including an MNS configuration performs angle measurement processing assuming that the far-field approximation holds. In this case, the direction in which the transmission wave is emitted (or the transmission direction (Direction of Departure (DOD))) in the target object reflected wave and the direction in which the target object reflected wave arrives (or the reception direction (Direction of Arrival (DOA)) are in a relationship in which the directions match each other, and thus, the angle measurement technique (or the positioning technique or the azimuth estimation technique) using a virtual reception antenna (see, for example, NPL 1) can be applied.

In the angle measurement processing in a MIMO radar including the BMS configuration, for example, the same as in the MIMO radar including the MNS configuration, for a target object (hereinafter, referred to as a “distant target object”) present at a distance at which a far-field approximation holds, DOD and DOA have a relationship in which DOD and DOA substantially coincide with each other, and the angle measurement technique using a virtual reception antenna can be applied.

On the other hand, in the angle measurement processing in a MIMO radar including a BMS configuration, DOD and DOA do not match for a target object (hereinafter, referred to as a “near target object”) present at a distance closer than a distance at which the far-field approximation holds, and thus, the angle measurement error is likely to increase when the angle measurement technique is applied using a virtual reception antenna. In the angle measurement processing for the near target object, for example, it is desirable that a MIMO radar including the BMS configuration performs angle measurement estimation for DOD and DOA individually (or integrally), or determines the target object position from at least one of DOD and DOA and the target object distance.

For example, the distance at which the far-field approximation holds depends on the distance between MIMO radars in a BMS configuration (hereinafter, referred to as “D_{BMS}”) (see, for example, NPL 3). For example, the distance dF at which the far-field approximation holds can be calculated by dF=2D_{BMS}²/λ. For example, in a case where the center frequency of the chirp signal is 77 GHz, when D_{BMS} is 0.1 m, 0.25 m, and 0.5 m, dF becomes approximately 5.1 m, 32 m, and 128 m, respectively.

For example, a case in which a near target object is present within the radar detection distance and a case in which both a near target object and a distant target object are included are conceivable depending on the relationship between the distance D_{BMS} between MIMO radars in the BMS configuration and the radar detection distance.

Accordingly, a MIMO radar having a mono-& multi-static configuration in which a near target object is included in a radar detection range is expected to have a MIMO antenna arrangement that takes into account both angle measurement for a near target object in a BMS configuration and angle measurement in a MNS configuration. Further, for example, when a distant target object is included in the radar detection range in the BMS configuration, the MIMO antenna arrangement that takes into consideration the angle measurement for the distant target object in the BMS configuration is expected.

As a MIMO antenna arrangement, the following arrangement examples are conceivable.

### Arrangement Example 1

For example, an arrangement in which the transmission antenna spacing (or reception antenna spacing) of radar #1 that constitutes the BMS is a half wavelength of the transmission signal, and the reception antenna spacing (or transmission antenna spacing) of radar #2 is 1 wavelength or more of the transmission signal (see, for example, PTL 1).

### Arrangement Example 2

For example, an arrangement in which the transmission antenna spacing (or the reception antenna spacing) of radar #1, which constitutes the BMS, is equal to or larger than 1 wavelength of the transmission signal and the reception antenna spacing (or the transmission antenna spacing) of radar #2 is equal to or larger than 1 wavelength of the transmission signal, and the spacings are prime to each other (see, for example, PTL 2).

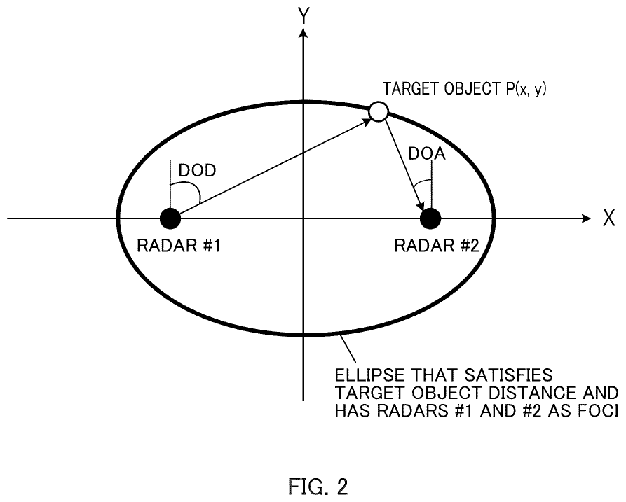

The angle measurement of a near target object in the BMS configuration is, for example, as illustrated in FIG. 2, in a case where the transmission wave is directly applied onto target object P by radar #1 and radar #2 directly receives the reflected wave (hereinafter, the reflected wave of target object P, which radar #2 receives, will be referred to as “target object direct wave”), target object P is present on an ellipse that satisfies the target object distance (for example, an ellipse having radars #1 and #2 as foci). In this case, the radar can determine intersection P with an ellipse determined in the direction specified in DOD or DOA by specifying at least one of DOD and DOA, and thus can definitively determine the target object position (x, y).

Note that, the “ellipse that satisfies the target object distance” is, for example, an elliptical curve defined by a trajectory in which two radars #1 and #2 are respectively two foci, and the sum of distances between each of the two foci and the target object is constant. Further, in a case where the transmission wave is directly applied to target object P from radar #1 and the reflected wave is directly received by radar #2, the distance of target object P measured by radar #2 can be used as the target object distance.

Further, the specification of the target object position described above is a case where the target object is present in a two-dimensional plane. In a case where a target object is present in three dimensions, the radar can definitively determine the target object position in three dimensions by using an ellipsoid and DOD or DOA including an azimuth component and an elevation angle component.

Thus, for example, by using the MIMO antenna arrangement such as that in Arrangement Example 1, it is possible to perform positioning to a near target object in a BMS configuration. Further, even in a case where a grating is generated in DOD and DOA, the radar can definitively determine the target object position by selecting, from combinations of candidate angles of DOD and DOA including the grating direction, an angle at which intersection P on the ellipse satisfying the target object distance is obtained. Thus, for example, it is possible to perform the positioning of a near target object in a BMS configuration by using a MIMO antenna arrangement such as in Arrangement Example 2.

On the other hand, in a case where the reflected wave that the radar receives is not a target object direct wave (hereinafter, the reflected wave that such a radar receives is referred to as a “target object indirect wave”), for example, in a case where a reflection path other than the target object direct wave (for example, a path that reflects at a wall, a road surface, or the like) is included in the reflection path of the radar transmission wave, the object is not present on an ellipse with radars #1 and #2 as foci, which satisfies the target object distance. For this reason, in a case where the radar receives the target object indirect wave, it is difficult for the radar to accurately position the target object position of the near target object.

In a BMS configuration such as this, when Arrangement Example 1 is applied to the target object indirect wave of a near target object, the radar may output a positioning result including an error since one of DOD and DOA is used. Further, when Arrangement Example 2 is applied to the target object indirect wave of the near target object in a BMS configuration, the radar may output a misplaced positioning result in a case where the DOD or DOA of the target object indirect wave coincides with the grating direction, for example.

In a non-limiting embodiment of the present disclosure, an antenna arrangement is described, which makes it possible to remove target object indirect wave in a near target object in BMS configuration in a plurality of MIMO radars including a mono-& multi-static configuration, and which improves the angle measurement performance in MNS configuration and BMS configuration.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

### Embodiments

[Configuration of Radar Apparatus]

The radar apparatus (or radar system) according to the present embodiment may include, for example, a plurality of radar sections (which corresponds to radar circuitry and is, for example, a MIMO radar). Further, the radar apparatus according to the present embodiment may include, for example, a synchronizer that performs synchronization control between a plurality of radar sections, and an integrator (for example, corresponding to control circuitry) that integrates positioning outputs of the plurality of radar sections.

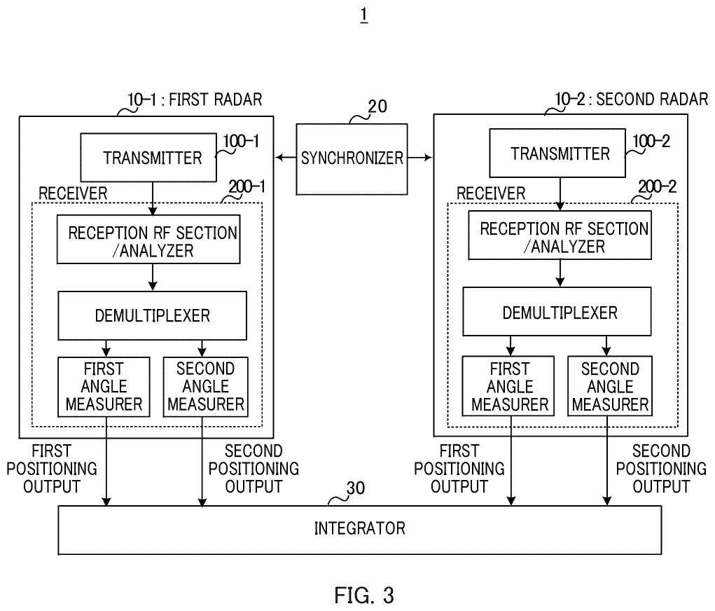

For example, radar apparatus 1 illustrated in FIG. 3 is a radar system including first radar section 10 (or expressed by radar section 10-1) having a plurality of transmission/reception antennas (not illustrated), and second radar section 10 (or expressed by radar section 10-2) having a plurality of transmission/reception antennas (not illustrated).

In radar apparatus 1 illustrated in FIG. 3, synchronizer 20 performs synchronization control between first radar section 10 and second radar section 10. For example, synchronizer 20 may generate a chirp signal or a reference clock signal (also referred to as a reference signal) as a synchronization control signal to first radar section 10 and second radar section 10 for synchronization control.

Here, the reference signal is, for example, a reference signal of a Voltage Controlled Oscillator (VCO) that generates a chirp signal, and is a high-frequency signal of about several tens to several hundreds MHz. In the case where synchronizer 20 uses the reference signal as the synchronization control signal, a system cost can be lowered as compared with the case where the chirp signal (for example, GHz order) is used. Note that, in the case where synchronizer 20 uses the reference signal, the chirp signal is generated individually in each of first radar section 10 and second radar section 10. Thus, the coherence of the phases between first radar section 10 and second radar section 10 is not guaranteed, and the phase shift to such an extent as to drift to cause displacement may occur. For example, radar apparatus 1 may measure and correct a drift component of the phase between first radar section 10 and second radar section 10 in advance.

For example, radar apparatus 1 may transmit a transmission signal from a plurality of transmission antennas of transmitter 100-1 of first radar section 10. Radar apparatus 1 may perform positioning processing of target object #1, for example, by receiving a reflected wave signal by receiver 200-1 having a plurality of reception antennas of first radar section 10, the reflected wave signal being the transmission signal of first radar section 10 reflected by target object #1 (corresponding to target object #1 in FIG. 1) (for example, radar positioning using the MNS configuration).

Further, radar apparatus 1 may perform positioning processing of target object #2, for example, by receiving a reflected wave signal by receiver 200-2 having a plurality of reception antennas of second radar section 10, the reflected wave signal being the transmission signal of first radar section 10 reflected by target object #2 (corresponding to target object #2 in FIG. 1) (for example, radar positioning using the BMS configuration).

Similarly, for example, radar apparatus 1 may transmit a transmission signal from a plurality of transmission antennas of radar transmitter 100-2 of second radar section 10. Radar apparatus 1 may perform positioning processing of target object #3, for example, by receiving a reflected wave signal by receiver 200-2 having a plurality of reception antennas of second radar section 10, the reflected wave signal being the transmission signal of second radar section 10 reflected by target object #3 (corresponding to target object #3 in FIG. 1) (for example, radar positioning using the MNS configuration).

Further, radar apparatus 1 may perform positioning processing of target object #2, for example, by receiving a reflected wave signal by receiver 200-1 having a plurality of reception antennas of first radar section 10, the reflected wave signal being the transmission signal of second radar section 10 reflected by target object #2 (corresponding to target object #2 in FIG. 1) (for example, radar positioning using the BMS configuration).

Note that the reception processing in first radar section 10 and second radar section 10 may be performed using, for example, a MIMO virtual antenna.

Further, in the present embodiment, radar apparatus 1 may perform time-division multiplexing transmission, Doppler multiplexing transmission or code multiplexing transmission of the transmission signal transmitted from first radar section 10 and the transmission signal transmitted from second radar section 10, and the same effect can be obtained by using any of the multiplexing transmissions.

For example, each of first radar section 10 and second radar section 10 may include a demultiplexer that demultiplexes, from the reception signal, the reflected wave signal corresponding to the transmission signal from transmitter 100 of the corresponding radar section, and also demultiplexes the reflected wave signal corresponding to the transmission signal from transmitter 100 of the other radar section.

Further, for example, each of first radar section 10 and second radar section 10 may include a first angle measurer that measures an angle using the reflected wave signal for the transmission signal from transmitter 100 of the corresponding radar section as demultiplexed by the demultiplexer, and a second angle measurer that measures an angle using the reflected wave signal for the transmission signal from transmitter 100 of the other radar section as demultiplexed by the demultiplexer.

In FIG. 3, for example, integrator 30 may integrate positioning outputs from first radar section 10 (for example, a first and a second positioning outputs) and positioning outputs from second radar section 10 (for example, a first and a second positioning outputs) to perform positioning of the target object. Note that the positioning is information including a direction, a distance, and a Doppler frequency.

With such a configuration, radar apparatus 1 can receive the reflected wave signal at receiver 200-1 and receiver 200-2, and demultiplex the reception signal depending on whether the received signal is a reflected wave signal for the transmission signal from the corresponding radar section or a reflected wave signal for the transmission signal from the other radar section, so as to appropriately perform the positioning processing based on the positional information of each of first radar section 10 and second radar section 10.

For example, in FIG. 3, first radar section 10 and second radar section 10 may be disposed at locations apart from each other. In this case, radar apparatus 1 can be used as a radar of the so-called BMS configuration.

Since first radar section 10 and second radar section 10 illustrated in FIG. 3 have the same configuration, they are collectively denoted and described as “radar sections 10” thereinbelow, and different operations between first radar section 10 and second radar section 10 will be described distinctively.

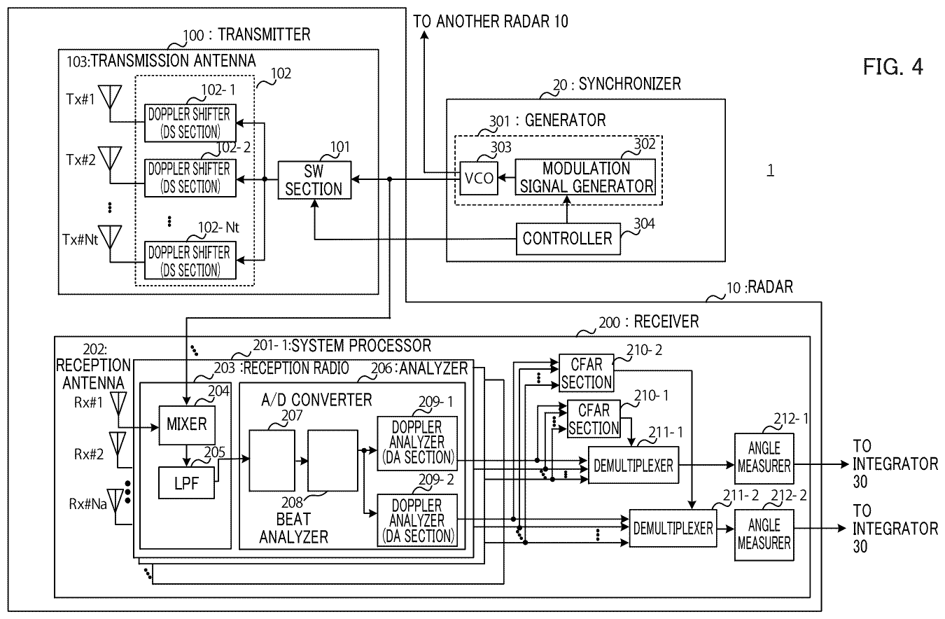

FIG. 4 illustrates an exemplary configuration of radar apparatus 1 in which a frequency-modulated chirp signal is used as a radar transmission wave.

Radar apparatus 1 in FIG. 4 illustrates details of first radar section 10-1 and synchronizer 20 in FIG. 3. For example, first radar section 10-1 corresponds to radar section 10. In FIG. 4, an exemplary configuration supported by a radar other than first radar section 10-1 and second radar section 10-2 in FIG. 3 is illustrated, and illustration of other radar section 10 is omitted.

Further, by way of example, FIG. 4 illustrates a configuration in which radar apparatus 1 performs time-division multiplexing transmission of a transmission signal transmitted from first radar section 10 and a transmission signal transmitted from second radar section 10.

Further, FIG. 4 illustrates a configuration in which radar apparatus 1 performs Doppler division multiplexing (DDM) transmission of the transmission signals transmitted from a plurality of transmission antennas in radar sections 10. Note that, the multiplexing transmission in each radar section 10 is not limited to DDM, and may be time division multiplexing transmission or code division multiplexing transmission, which can achieve similar effects.

Radar section 10 includes, for example, transmitter (corresponding to a transmission branch or radar transmission circuitry) 100 and receiver (corresponding to a reception branch or radar reception circuitry) 200.

Transmitter 100 transmits TxSig generated, for example, in synchronizer 20 at a predetermined transmission period using a transmission array antenna including a plurality of transmission antennas 103-1 to 103-Nt.

Receiver 200 receives reflected wave signals, which are TxSig reflected by a target object (target) (corresponding to target objects #1 to #3 in FIG. 1), using a reception array antenna composed of a plurality of reception antennas 202-1 to 202-Na, for example. Receiver 200 performs signal processing on the reflected wave signals received at reception antennas 202 to, for example, detect the presence or absence of the target object, or perform positioning of the target object.

Synchronizer 20 generates a predetermined frequency-modulated wave (for example, a frequency chirp signal or a chirp signal), for example, and supplies the wave to the plurality of radar sections 10. Note that, synchronizer 20 may output a reference signal and radar section 10 may generate a predetermined frequency-modulated wave.

### [Exemplary Configuration of Synchronizer 20]

Synchronizer 20 includes, for example, generator 301 and controller 304.

Generator 301 generates TxSig based on, for example, control by controller 304. Generator 301 outputs the generated TxSig to a plurality of radar sections 10 (for example, transmitters 100). For this reason, each of the plurality of radar sections 10 transmits a transmission signal based on TxSig.

Generator 301 includes, for example, modulation signal generator 302 and VCO 303. Hereinafter, the components of generator 301 will be described.

Modulation signal generator 302 periodically generates, for example, saw-toothed modulation signals. The transmission period of TxSig is herein represented by Tr.

VCO 303 generates a chirp signal based on the modulation signal output from modulation signal generator 302, and outputs the chirp signal to transmitter 100 (for example, Doppler shifters 102-1 to 102-Nt) and receiver 200 (mixer 204 described later) of radar section 10. Hereinafter, the Doppler shifter is also referred to as “DS section.”

Controller 304 controls generation of TxSig of generator 301 (for example, modulation signal generator 302 and VCO 303). For example, controller 304 may configure parameters (for example, modulation parameters) related to the chirp signal such that the chirp signal is transmitted N_{c} times for transmission periods Tᵣ per one radar positioning.

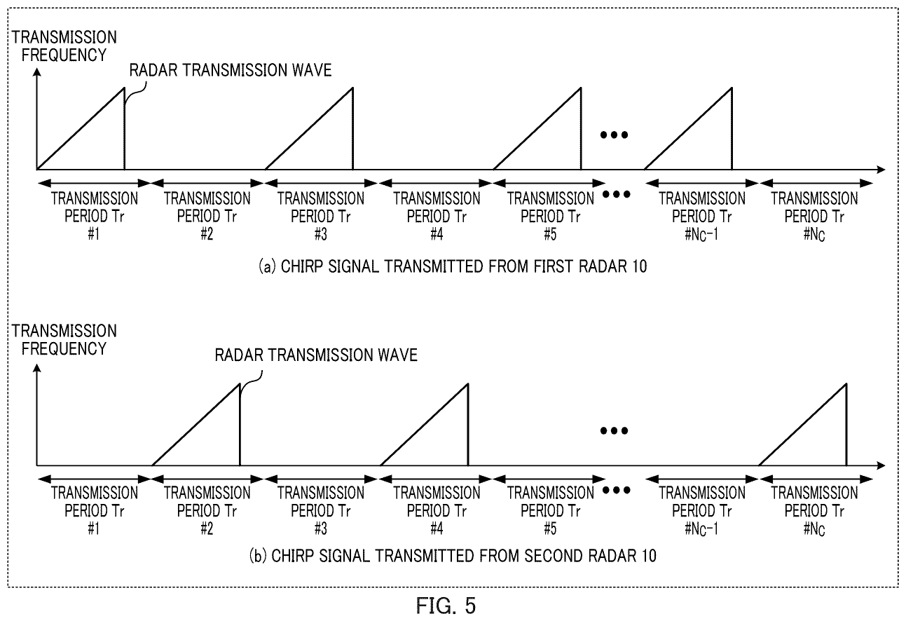

Part (a) in FIG. 5 illustrates an example of a chirp signal transmitted from first radar section 10, and part (b) in FIG. 5 illustrates an example of a chirp signal transmitted from second radar section 10. The chirp signals in part (a) in FIG. 5 and part (b) in FIG. 5 are each configured with the same center frequency.

The chirp signal generated by generator 301 of synchronizer 20 is output to transmitter 100 and receiver 200 of radar section 10. In the example of FIG. 5, controller 304 outputs a transmission switching control signal to switch (SW) section 101 of transmitter 100 of each radar section 10 such that the transmission signal transmitted from first radar section 10 and the transmission signal transmitted from second radar section 10 are switched between each other in a time division manner for each transmission period Tᵣ.

Hereinafter, the transmission period in which controller 304 outputs a transmission signal from each radar section 10 will be referred to as “N_{sw}×Tᵣ.” N_{sw} is a predetermined integer value equal to or greater than 2. In the example in FIG. 5, N_{sw}=2.

For example, radar apparatus 1 can detect a time variation of the positioning result for a target object as a Doppler frequency by transmitting the chirp signal N_{c} times and measuring the reflected wave signal being the chirp signal reflected by the target object N_{c} times. In the following description, each of the transmission periods among N_{c} transmission periods Tᵣ are represented by the index “m.” Here, m is an integer of from 1 through N_{c}.

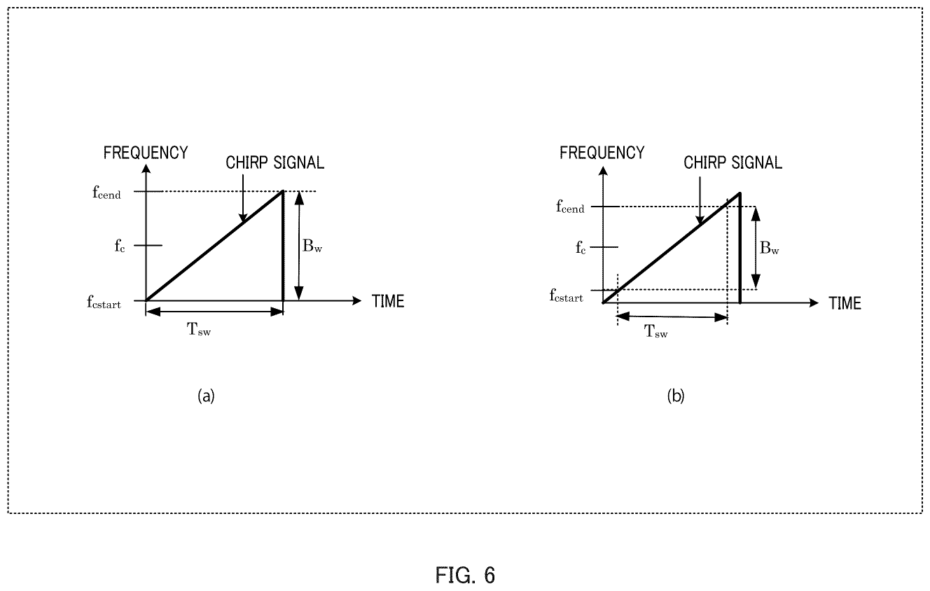

As illustrated in FIG. 6, the modulation parameters for the chirp signal may include, for example, center frequency f_{c}, frequency sweep bandwidth B_{w}, sweep start frequency f_{cstart}, sweep end frequency f_{cend}, frequency sweep duration T_{sw}, and frequency sweep change rate Dₘ. Note that Dₘ=B_{w}/T_{sw}. Note also that B_{w}=f_{cend}−f_{cstart}, and f_{c}=(f_{cstart}+f_{cend})/2.

Frequency sweep time T_{sw} corresponds to, for example, a time range (also called a range gate) in which A/D sampled data is taken by A/D converter 207 of receiver 200, which will be described later. Frequency sweep time T_{sw} may be set to an entire time section of the chirp signal illustrated at (a) in FIG. 6, or to a partial time section of the chirp signal illustrated at (b) in FIG. 6, for example.

Note that FIGS. 5 and 6 illustrate examples of up-chirp waveforms in which the modulation frequency gradually increases with time, but down-chirp may also be applied. The present disclosure can achieve the same effects regardless of whether the waveforms are up-chirp or down-chirp.

The chirp signals outputted by synchronizer 20 are inputted to, for example, each mixer 204 of receiver 200 and Nt DS sections 102.

### [Exemplary Configuration of Transmitter 100]

In FIG. 4, transmitter 100 of radar section 10 includes, for example, SW section 101, DS sections 102-1 to 102-Nt, and transmission antennas 103-1 to 103-Nt (for example, Tx #1 to Tx #Nt). Note that, transmission antennas 103 may be connected to respective DS sections 102. Radar section 10 in FIG. 4 corresponds to first radar section 10, but is hereinafter referred to as qth radar section 10, including second and subsequent radar sections 10. Here, “q” represents indices for identifying a plurality of radar sections 10 included in radar apparatus 1, and may be, for example, q=1 or 2. In the following description, elements included in qth radar section 10 are described with a subindex “−q.”

SW section 101 in qth radar section 10 outputs the chirp signal inputted from VCO 303 to DS section 102 based on the transmission switching control signal inputted from controller 304 at a timing (transmission period) in which the transmission signal is transmitted from qth radar section 10.

In order to apply Doppler shift amount (hereinafter, also referred to as “DS amount”) DOPₙ(q) to the chirp signal inputted from SW section 101, DS section 102 of qth radar section 10 applies phase rotation Φ_{n,q} to the chirp signal for each transmission period Tᵣ of the chirp signal, and outputs the Doppler-shifted signal to transmission antenna 103.

Further, for example, the number of transmission antennas 103 in each qth radar section 10 may be the same or may be different. Hereinafter, the number of transmission antennas in qth radar section 10 will be referred to as “Nt(q)” (or simply “Nt”). Here, Nt(q)≥1. In addition, n=1 to Nt(q).

For example, qth radar section 10 may perform outputs while giving the outpus predetermined phase rotations Φ_{n,q}(m) for applying respective different Doppler shifts to transmission antennas 103 used for the multiplexing transmission in the MNS configuration.

Further, qth radar section 10 may perform outputs while giving the outputs predetermined phase rotation Φ_{n,q}(m) to apply Doppler shifts that provide DS amount patterns different between radar sections 10 that perform multiplexing transmission, for example, in the BMS configuration. For example, the DS amount pattern (or also referred to as a Doppler shift pattern) applied to TxSig transmitted from the plurality of transmission antennas 103 of first radar section 10 may be different from the DS amount pattern in second radar section 10. The DS amount patterns may be configured according to, for example, at least one of a Doppler multiplexing interval (also referred to as “Doppler shift interval” or “Doppler interval,” which is also described as “DDM interval”) and the number of Doppler multiplexing (hereinafter, also referred to as “number of DDM”). Alternatively, qth radar section 10 may perform outputs while giving the outputs predetermined phase rotation Φ_{n,q}(m) to apply Doppler shifts that provide a pattern of DS amounts (e.g., the same DDM interval) the same between radar sections 10 that perform multiplexing transmission, for example, in the BMS configuration (an exemplary operation will be described later).

The output signals outputted from DS sections 102 are amplified to a predetermined transmission power and emitted into space from respective transmission antennas 103 (e.g., Tx #1 to Tx #Nt).

### [Exemplary Configuration of Receiver 200]

In FIG. 4, receiver 200 includes Na reception antennas 202 (for example, Rx #1 to Rx #Na), and serves as a component of an array antenna. Further, receiver 200 includes Na system processors 201, Constant False Alarm Rate (CFAR) sections 210, demultiplexers 211, and angle measurers 212.

Here, the number of reception antennas 202 may be the same or may be different between qth radar sections 10. Hereinafter, the number of reception antennas in qth radar section 10 will be referred to as “Na(q)” (also referred to simply as “Na”). Here, Na(q)≥1.

System processors 201 may be provided to correspond respectively to Na(q) reception antennas 202, for example. In addition, CFAR sections 210, demultiplexers 211, and angle measurers 212 may be provided, for example, in q radar sections 10, respectively.

Each of Na(q) reception antennas 202 receives a reflected wave signal being TxSig transmitted from each of the plurality of radar sections 10 and reflected by a target object (for example, a reflective object including a radar measurement target), and outputs the reflected wave signal to corresponding system processor 201 as a reception signal.

Each of system processors 201 includes reception radio 203 and analyzer 206.

Reception radio 203 includes mixer 204 and low pass filter (LPF) 205. In reception radio 203, mixer 204 mixes the received reflected wave signal (reception signal) with the chirp signal that is the transmission signal. Further, a beat signal having a frequency corresponding to a delay time of the reflected wave signal is extracted by passing an output of mixer 204 through LPF 205. For example, a difference frequency between a frequency of the transmission signal (transmission frequency-modulated wave) and a frequency of the reception signal (reception frequency-modulated wave) is obtained as the beat frequency (or beat signal). Note that the beat frequency is within the passband of LPF 205.

In FIG. 4, analyzer 206 of each system processor 201-z (where z=any one of 1 to Na(q)) includes A/D converter 207, beat analyzer 208, and Doppler analyzer (also referred to as “DA section”) 209.

The signal (for example, beat signal) outputted from LPF 205 is converted into discretely sampled data by A/D converter 207 in analyzer 206.

Beat analyzer 208 performs, for each transmission period Tᵣ, FFT processing on N_{data} pieces of discretely sampled data obtained in a predetermined time range (range gate). Here, the range gate may set frequency sweep time T_{sw}. Analyzer 206 thus outputs a frequency spectrum in which a peak appears at a beat frequency dependent on the delay time of the reflected wave signal (radar reflected wave). In the FFT processing, for example, beat analyzer 208 may perform multiplication by a window function coefficient such as the Han window or the Hamming window. The use of the window function coefficient can suppress sidelobes around the beat frequency peak.

Here, a beat frequency response (hereinafter, also referred to as “BF response”) obtained by the mth chirp pulse transmission of the chirp signal, which is outputted from beat analyzer 208 in zth analyzer 206, is denoted as “RFT_{z}(f_{b}, m).” Here, f_{b} denotes the beat frequency index and corresponds to an FFT index (bin number). For example, f_{b}=0 to N_{data}/2−1, z=an integer of from 1 to Na, and m=an integer of from 1 to N_{c}. A beat frequency having smaller beat frequency index f_{b} indicates a shorter delay time of the reflected wave signal (for example, a shorter distance to the target object).

In addition, beat frequency index f_{b} may be converted to distance information R (f_{b}) using Expression 1 for the MNS configuration and Expression 2 for the BMS configuration. Thus, in the following, beat frequency index f_{b} is also referred to as “distance index f_{b}.” The distance index is also described as “R-Index.”

$$\begin{matrix}[ 1 ] & \\ R ( {f}_{b} ) = \frac{{c}_{0}}{2 {B}_{w}} {f}_{b} & ( Expression 1 )\end{matrix}$$

$$\begin{matrix}[ 2 ] & \\ R ( {f}_{b} ) = \frac{{c}_{0}}{{B}_{w}} {f}_{b} & ( Expression 2 )\end{matrix}$$

Here, B_{w} denotes a frequency sweeping bandwidth within the range gate for a chirp signal, and C₀ denotes the speed of light.

DA sections 209 of zth analyzer 206 perform Doppler analysis for each R-Index by using BF response RFT_{z}(f_{b}, m) obtained by N_{C} chirp pulse transmissions of the chirp signal (e.g., m=1 to N_{C}).

Note that, hereinafter, as illustrated in FIG. 5, an exemplary operation of DA section 209 of a case where, in the BMS configuration, a transmission signal transmitted from first radar section 10 and a transmission signal transmitted from second radar section 10 are alternately switched every transmission period Tᵣ will be described.

The zth DA section 209 in qth radar section 10 performs Doppler analysis for each R-Index by using, from among BF responses RFT_{z}(f_{b}, m) obtained by N_{C} chirp pulse transmissions, BF responses (for example, BF responses in the case where m is an odd number in first radar section 10, and the BF responses in the case where m is an even number in second radar section 10) obtained from the reception signals received when qth radar section 10 outputs the transmission signals. Hereinafter, DA section 209 (in FIG. 4, Doppler analyzer 209-1) that performs the Doppler analysis using such reflected wave signals will be also referred to as “first Doppler analyzer (DA) 209” or “mono-reception Doppler analyzer (DA).”

Further, in qth radar section 10, DA section 209 performs Doppler analysis for each R-Index by using BF responses (for example, BF responses in the case where m is an even number in first radar section 10, BF responses in the case where m is an odd number in second radar section 10) obtained from the reception signals received when radar section 10 different from qth radar section 10 outputs the transmission signals. Hereinafter, DA section 209 (in FIG. 4, Doppler analyzer 209-2) that performs the Doppler analysis using such reflected wave signals will be also referred to as “second Doppler analyzer (DA) 209” or “multi-reception Doppler analyzer (DA).”

For example, when N_{VFT}=N_{c}/N_{sw} is a power of 2, DA section 209 of qth radar section 10 can apply FFT processing in the Doppler analysis. Here, the FFT size in the mono-reception DA section and the multi-reception DA section is N_{VFT}, and the maximum Doppler frequency (hereinafter, referred to as “DFreq”) at which no aliasing occurs and which is derived from the sampling theorem is ±1/(2N_{sw}Tᵣ). Further, the DFreq interval of DFreq index (also referred to as “DF-Index”) fₛ is 1/(N_{c}×Tᵣ), and the range of fₛ is fₛ=−N_{VFT}/2, . . . , 0, . . . , and N_{VFT}/2−1.

For example, output VFT_{z,q}^{Mono}(f_{b}, fₛ) of the mono-reception DA section and output VFT_{z,q}^{Mul}(f_{b}, fₛ) of the multi-reception DA section from among DA sections 209 in zth analyzer 206 of qth radar section 10 are given by following Expressions 3 and 4. Here, j is an imaginary unit, z is an integer of from 1 to Na(q), and q is 1 or 2. In addition, the BF response outputted by beat analyzer 208 in qth radar section 10 is expressed as “RFT_{z,q}(f_{b}, m”). The same applies hereinafter.

$$\begin{matrix}[ 3 ] & \\ {VFT}_{z , q}^{Mono} ( {f}_{b} , {f}_{s} ) = {\sum }_{s = 0}^{{N}_{VFT} - 1} {RFT}_{z , q} ( {f}_{b} , {N}_{s w} \times s + q ) exp [ - \frac{j 2 π {sf}_{s}}{{N}_{VFT}} ] & ( Expression 3 )\end{matrix}$$

$$\begin{matrix}[ 4 ] & \\ VF {T}_{z , q}^{Mul} ( {f}_{b} , {f}_{s} ) = {\sum }_{s = 0}^{{N}_{VFT} - 1} {RFT}_{z , q} ( {f}_{b} , {N}_{s w} \times s + 3 - q ) exp [ - \frac{j 2 π {sf}_{s}}{{N}_{VFT}} ] & ( Expression 4 )\end{matrix}$$

The processing in each component of analyzer 206 has been described above.

In FIG. 4, CFAR sections 210 of qth radar section 10 may include, for example, first CFAR section 210-q (also expressed as CFAR section 210-1-q) corresponding to the MNS configuration, and second CFAR section 210-q (also expressed as CFAR section 210-2-q) corresponding to the mono-& multi-static configuration.

First CFAR section 210-q performs CFAR processing (for example, adaptive threshold determination) using the outputs from first DA sections (mono-reception DA sections) 209 of first to Na(q)th analyzers 206 to extract R-Index (hereinafter, also referred to as f_{bp}^{Mono}) and DF-Index (hereinafter, also referred to as fₛₚ^{Mono}) that provide local peak signals.

Likewise, second CFAR section 210-q performs CFAR processing using the outputs from second DA sections (multi-reception DA sections) 209 of first to Na(q)th analyzers 206 to extract R-Index (hereinafter, also referred to as f_{bp}^{Mul}) and DF-Index (hereinafter, also referred to as fₛₚ^{Mul}) that provide local peak signals. Note that, fₛₚ^{Mono} and fₛₚ^{Mul} may include DF-Index for the number of Doppler multiplexing.

For example, first CFAR section 210-q selectively extracts local peaks of the reflected wave signals (referred to as reception signals or reflected wave signals in the MNS configuration) of TxSig from qth radar section 10 as the MNS configuration using the outputs of first DA sections 209 of first to Na(q)th analyzers 206. For example, first CFAR section 210-q may perform the CFAR processing of performing the adaptive threshold determination after power addition at intervals matching the DDM intervals configured for TxSig transmitted from qth radar section 10, extract f_{bp}^{Mono} and fₛₚ^{Mono}, and output extracted f_{bp}^{Mono} and fₛₚ^{Mono} to first demultiplexer 211 (an exemplary operation will be described later).

The transmitter of the MNS configuration in qth radar section 10 is transmitter 100 of qth radar section 10. Similarly, the transmitter of the MNS configuration in qeth radar section 10 is transmitter 100 of first geth radar section 10. Note that qth radar section 10 and qeth radar section 10 are different radar sections, and qe=2, for example, when q=1.

Further, for example, second CFAR section 210-q selectively extracts local peaks of the reflected wave signals (referred to as reception signals or reflected wave signals in the BMS configuration) of TxSig from qeth radar section 10 as the BMS configuration using the outputs of second DA sections 209 of first to Na(q)th analyzers 206.

For example, second CFAR section 210-q may perform the CFAR processing of performing the adaptive threshold determination after power addition at intervals matching the DDM intervals configured for TxSig transmitted from qeth radar section 10 different from qth radar section 10, extract f_{bp}^{Mul} and fₛₚ^{Mul} and output extracted f_{bp}^{Mul} and fₛₚ^{Mul} to second demultiplexer 211 (an exemplary operation will be described later).

Further, the transmitter having the BMS configuration in first radar section 10 is transmitter 100 of second radar section 10. Likewise, transmitter 100 having the BMS configuration in second radar section 10 is transmitter 100 of first radar section 10.

Demultiplexers 211 of qth radar section 10 may include first demultiplexer 211-q (also expressed as demultiplexer 211-1) that performs Doppler demultiplexing processing (hereinafter, also referred to as “DDM demultiplexing”) using the outputs of first DA section 209 and first CFAR section 210-q, and second demultiplexer 211-q (also referred to as demultiplexer 211-2) that performs DDM demultiplexing processing using the outputs of second DA section 209 and second CFAR section 210-q.

For example, first demultiplexer 211-q of qth radar section 10 performs the DDM demultiplexing on the reflected wave signals in the MNS configuration using the outputs of first CFAR section 210-q. Further, second demultiplexer 211-q of qth radar section 10 performs the DDM demultiplexing on the reflected wave signals in the BMS configuration, for example, using the outputs of second CFAR section 210-q.

First demultiplexer 211-q outputs, for example, information on the demultiplexed signals to first angle measurer 212-1. The output of first demultiplexer 211-q may include, for example, the outputs from first DA sections 209.

Further, for example, second demultiplexer 211-q outputs, to second angle measurer 212-2, information on a signal from which the reflected wave signal in the BMS configuration is demultiplexed. The output of second demultiplexer 211-q may include, for example, the output from second DA sections 209.

The information about the demultiplexed signal may include, for example, R-Index and DF-Index corresponding to the demultiplexed signal (which may also be referred to as demultiplexing index information below).

Hereinafter, an exemplary operation of qth demultiplexer 211 will be described together with exemplary operations of Doppler shifter 102 and qth CFAR section 210. For example, q=1 or 2 may hold true.

The operation of Nuth demultiplexer 211-q is related to the operation of DS section 102 in transmitter 100-q. Similarly, the operation of Nuth CFAR section 210-q is related to the operation of DS section 102 of transmitter 100-q. For example, Nu=1 or 2 may hold true.

Hereinafter, an exemplary operation of DS sections 102 will be described, and an exemplary operation of Nuth CFAR section 210-q and an exemplary operation of Nuth demultiplexer 211-q will then be described.

### [Configuration Method for DS Amount]

To begin with, an example of a configuration method the DS amount applied in DS sections 102 will be described.

First to Nt(q)th DS sections 102 of qth radar section 10 perform Doppler multiplexing transmission (hereinafter, also referred to as “DDM transmission”) by applying respective different DS amounts DOPₙ(q) of predetermined DDM intervals Δfd(q) to the chirp signals inputted from synchronizer 20. At this time, DDM intervals Δfd(q) may satisfy the following configuration condition (1) or (2).

### Configuration Condition (1):

The DDM intervals may be set to the same interval between the plurality of radar sections 10. For example, the intervals for respective DS amounts applied to TxSig transmitted from the plurality of transmission antennas 103 of first radar section 10 may be the same as the intervals for respective DS amounts applied to TxSig transmitted from the plurality of transmission antennas 103 of second radar section 10 (for example, Δfd(1)=Δfd(2)).

### Configuration Condition (2):

The DDM intervals between the plurality of radar sections 10 may be set to different intervals. For example, the intervals for respective DS amounts applied to TxSig transmitted from the plurality of transmission antennas 103 of first radar section 10 and the intervals for respective DS amounts applied to TxSig transmitted from the plurality of transmission antennas 103 of second radar section 10 may be different from each other (for example, Δfd(1)≠Δfd(2)).

Note that, for example, the ratio between Δfd(1) and Δfd(2) may be set in configuration condition (2) so as not to match an integer. For example, of Δfd(1) and Δfd(2), the ratio of the DDM interval having the larger value to the DDM interval having the smaller value may be different from the integer. For example, Δfd(1)/Δfd(2) or Δfd(2)/Δfd(1) may be set so as not to match the integer (so as to be different from the integer).

Hereinafter, a configuration example of DDM interval Δfd(q) will be described.

In the following description, the number of DDM for qth radar section 10 will be referred to as “N_{DM}(q),” and a description is given of a case of N_{DM}(q)=Nt(q), but the present disclosure is not limited thereto. For example, radar section 10 may bundle some of the plurality of transmission antennas 103 to form a transmission beam for performing DDM transmission. Here, N_{DM}(q)<Nt(q) holds true. Further, for example, index n of DS amount DOPₙ(q) represents an index of the DDM signal, and n is an integer of from 1 to N_{DM}(q). Also, N_{DM}(q)>1 and q=1 or 2. Note that, when Nt(q)=1, Doppler shift multiplexing does not have to be used, and qth radar section 10 does not have to include DS sections 102.

In the present embodiment, the transmission signal transmitted from first radar section 10 and the transmission signal transmitted from second radar section 10 are configured to be transmitted with time-division multiplexing. For example, controller 304 outputs the transmission switching control signal to SW section 101 of each transmitter 100 such that the transmission signal transmitted from first radar section 10 and the transmission signal transmitted from second radar section 10 are switched alternately in a time division manner in each transmission period Tᵣ. For this reason, for example, DS section 102 applies a phase rotation that is a predetermined DS amount to a chirp signal every time-division transmission period (for example, N_{sw}×Tr) of the chirp signal (for example, N_{SW}=2).

Here, in DA sections 209 (the mono-reception DA section or the multi-reception DA section), the range of DFreq f_{d} in which no aliasing is generated and which is derived from the sampling theorem is −1/(2N_{sw}Tᵣ)≤f_{d}<1/(2N_{sw}Tᵣ). For example, when the Doppler frequency exceeds the range of DFreq f_{d} in which no aliasing occurs, DA sections 209 observe an aliasing frequency in the range of −1/(2N_{sw}Tᵣ)≤f_{d}<1/(2N_{sw}Tᵣ). Even when the Doppler shift applied by DS sections 102 is set within a range exceeding −1/(2N_{sw}Tᵣ)≤f_{d}<1/(2N_{sw}Tᵣ), the Doppler shift is equivalent to that set within the range of −1/(2N_{sw}Tᵣ)≤f_{d}<1/(2N_{sw}Tᵣ).

Therefore, for example, when DS sections 102 apply the Doppler shift within the range of −1/(2N_{sw}Tᵣ)≤f_{d}<1/(2N_{sw}Tᵣ), the maximum DDM interval (for example, expressed as “Δfdmax”) for Nt(q) transmission antennas 103 (for example, the number equal to the number of DDM) is Δfdmax=1/(TᵣN_{sw}Nt(q))=1/(TᵣN_{sw}N_{DM}(q)). For example, DS sections 102 may set Δfd(1) and Δfd(2) within the range up to Δfdmax. Accordingly, DS sections 102 can set the Doppler shift within the range of 0 to 2π that is the phase rotation providing the Doppler shift.

For example, the DDM intervals of each of first radar section 10 and second radar section 10 may be set as given by following Expression 5:

$$\begin{matrix}[ 5 ] & \\ Δ fd ( q ) = 1 / ( {N}_{s w} {T}_{r} \times ( {N}_{DM} ( q ) + {δ}_{q} ) ) . & ( Expression 5 )\end{matrix}$$

For example, δ_{q} is a parameter that defines the DDM interval. Equations δ₁=δ₂≥0 and N_{DM}(1)=N_{DM}(2) may be set. With this configuration, the DDM interval is the same between the plurality of radar sections 10 (for example, between first radar section 10 and second radar section 10), and satisfies configuration condition (1) (Δfd(1)=Δfd(2)).

Alternatively, δ₁ and δ₂ may be set such that δ₁, δ₂≥0 holds true, N_{DM}(1)+δ₁≠N_{DM}(2)+δ₂ is satisfied, and the ratio between N_{DM}(1)+δ₁ and N_{DM}(2)+δ₂ does not match an integer. With this configuration, the DDM interval differs between the plurality of radar sections 10 (for example, between first radar section 10 and second radar section 10), and satisfies configuration condition (2).

Note that each of δ₁ and δ₂ may be a positive integer or a positive real number. For example, by setting δ₁ and δ₂ to be positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

The configuration examples of DS amounts have been described above.

For example, DS sections 102 may set the DS amounts corresponding to transmission antennas 103 using the DDM intervals set as described above, and apply the phase rotations for applying the DS amounts to the chirp signals at respective chirp transmission periods.

For example, nth DS section 101 of qth radar section 10 applies, to the mth chirp signal as input, phase rotation Φ_{n,q}(m) for applying DS amount DOPₙ(q) different for each nth transmission antenna 103, and outputs the resultant signal. As a result, different Doppler shifts are applied to the transmission signals transmitted respectively from multiple transmission antennas 103.

Here, n is an integer of from 1 to Nt(q), m is an integer of from 1 to Nₑ, and q is 1 or 2.

For example, phase rotations Φ_{n,q}(m) for applying DS amounts DOPₙ(q) for DDM intervals Δfd(q) to TxSig transmitted from Nt(q) (e.g., Nt(q)=N_{DM}(q)) transmission antennas 103 are expressed by following Expression 6. Expression 7 represents DS amounts DOPₙ(q) for DDM intervals Δfd(q).

$$\begin{matrix}[ 6 ] & \\ {ϕ}_{n , q} ( m ) = \{ 2 π {N}_{s w} {T}_{r} \times {DOP}_{n} ( q ) + Δ {ϕ}_{0} \} \times floor [ \frac{m - 1}{{N}_{sw}} ] + {ϕ}_{0} = \{ 2 π {N}_{s w} {T}_{r} \times Δ {f}_{d} ( q ) ( n - α ) + Δ {ϕ}_{0} \} \times floor [ \frac{m - 1}{{N}_{sw}} ] + {ϕ}_{0} & ( Expression 6 )\end{matrix}$$

$$\begin{matrix}[ 7 ] & \\ {DOP}_{n} ( q ) = Δ {f}_{d} ( q ) ( n - α ) & ( Expression 7 )\end{matrix}$$

In the expression, Φ₀ is the initial phase and ΔΦ₀ is a reference Doppler shift phase. Further, α is a coefficient for offsetting the DS amount for each DDM signal and a real value may be used for the coefficient. For example, when α=1, the DS amount for the first DDM signal is zero.

For example, when Nt(1)=Nt(2)=3, ΔΦ₀=0, Φ₀=0, δ₁=1, and δ₂=2, the DDM intervals are set to Δfd(1)=1/(4N_{sw}Tᵣ) and Δfd(2)=1/(5N_{sw}Tᵣ). Further, for example, when α=1, DS amount DOPₙ(q) corresponding to nth transmission antenna 103 is expressed by following Expression 8:

$$( Expression 8 )$$

$${DOP}_{n} ( q ) = Δ {f}_{d} ( q ) ( n - 1 ) \qquad [ 8 ]$$

Further, for example, phase rotations Φ_{n,q}(m) for applying DS amounts DOPₙ(q) different for nth (n=1, 2, 3) transmission antennas 103 to the mth chirp signal as input are expressed by following Expression 9:

$$( Expression 9 )$$

$$\begin{matrix}{ϕ}_{1 , 1} ( m ) = 0 , {ϕ}_{2 , 1} ( m ) = \frac{π}{2} floor [ \frac{m - 1}{{N}_{sw}} ] , {ϕ}_{3 , 1} ( m ) = π floor [ \frac{m - 1}{{N}_{sw}} ] , \\ {ϕ}_{1 , 2} ( m ) = 0 , {ϕ}_{2 , 2} ( m ) = \frac{2 π}{5} floor [ \frac{m - 1}{{N}_{sw}} ] , {ϕ}_{3 , 2} ( m ) = \frac{4 π}{5} floor [ \frac{m - 1}{{N}_{sw}} ]\end{matrix} \qquad [ 9 ]$$

For example, when first radar section 10 performs DDM transmission using number Nt of transmission antennas=3, first DS section 102 in first radar section 10 applies phase rotation Φ_{1,1}(m) to the chirp signal inputted from synchronizer 20 for each odd-numbered transmission period Tᵣ as shown in following Expression 10. The output of first DS section 102 is output from, for example, first transmission antenna 103 (Tx #1). Here, cp(t) denotes the chirp signal for each transmission period.

$$( Expression 10 )$$

$$exp \{ j {ϕ}_{1 , 1} ( 1 ) \} c p ( t ) , exp \{ j {ϕ}_{1 , 1} ( 3 ) \} cp ( t ) , … , exp \{ j {ϕ}_{1 , 1} ( {N}_{c} - 1 ) \} cp ( t ) \qquad [ 10 ]$$

Further, for example, when second radar section 10 performs DDM transmission using number Nt=3 of transmission antennas, first DS section 102 in second radar section 10 applies phase rotation Φ_{1,2}(m) to the chirp signal inputted from synchronizer 20 for each even-numbered transmission period Tᵣ as shown in following Expression 11. The output of first DS section 102 is output from, for example, first transmission antenna 103 (Tx #1).

$$( Expression 11 )$$

$$exp \{ j {ϕ}_{1 , 2} ( 2 ) \} cp ( t ) , exp \{ j {ϕ}_{1 , 2} ( 4 ) \} cp ( t ) , … , exp \{ j {ϕ}_{1 , 2} ( {N}_{c} ) \} cp ( t ) \qquad [ 11 ]$$

The configuration examples of DS amounts have been described above.

Next, an exemplary operation of first CFAR section 210, second CFAR section 210, first demultiplexer 211, and second demultiplexer 211 in qth radar section 10 corresponding to the operation of DS sections 102 described above will be described.

### [Exemplary Operation of First CFAR Section 210]

For example, in order to receive the reflected wave signals corresponding to the MNS configuration, first CFAR section 210 of qth radar section 10 may perform the following operation.

For example, first CFAR section 210 may perform peak detection by searching, in power addition values of outputs from first DA sections 209 of first to Na(q)th analyzer 206, for a power peak that matches a DDM interval set for TxSig of qth radar section 10 for each R-Index and performing adaptive threshold processing (CFAR processing). For example, first CFAR section 210 performs CFAR processing combined with CFAR processing in two dimensions including a distance axis and a DFreq axis (corresponding to a relative velocity) or with one-dimensional CFAR processing in the peak detection (for example, processing disclosed in NPL 4 may be applied).

Here, for example, when DS section 102 sets δ_{q} shown in Expression 5 to a positive integer, the interval of Δfd(q) or the interval of an integer multiple of Δfd(q) is used as the intervals between the DS amounts. In this case, q may be 1 or 2. Therefore, signals on which DDM is performed can be detected as aliasing at an interval of Δfd(q) in the DFreq region of the outputs of first DA section 209. By using such characteristics, for example, the operation of first CFAR section 210 can be simplified as follows.

For example, first CFAR section 210 of qth radar section 10 detects a Doppler peak by applying a threshold to a power addition value obtained by adding together the reception powers of the reflected wave signals for respective ranges (for example, ranges of Δfd(q)) within the DFreq range that is outputted from first DA sections 209 and subjected to the CFAR processing, the ranges corresponding to the intervals of the DS amounts applied respectively to TxSig.

For example, first CFAR section 210 performs the CFAR processing on the outputs from first DA sections 209 of first to Na(q)th analyzers 206 by calculating power addition value PowerDDM_{q}(f_{b}, f_{sdc}) obtained by adding power values Power_{q}FT(f_{b}, fₛ) at the intervals of Δfd(q) (for example, corresponding to N_{Δfd(q)}) as illustrated in following Expressions 12 and 13. Such CFAR processing is referred to as, for example, “Doppler domain compression CFAR processing,” and is referred to as “DC-CFAR.” DC-CFAR is described in, for example, PTL 4, and detailed explanation thereof is omitted.

$$( Expression 12 )$$

$${Power DDM}_{q} ( {f}_{b} , {f}_{sdc} ) = {\sum }_{ndm = 1}^{{N}_{DM} ( q ) + {δ}_{q}} {Power FT}_{q}^{mono} ( {f}_{b} , {f}_{sdc} + ( ndm - 1 ) \times {N}_{Δ {f}_{d} ( q )} ) \qquad [ 12 ]$$

$$( Expression 13 )$$

$${Power FT}_{q}^{mono} ( {f}_{b} , {f}_{s} ) = {\sum }_{z = 1}^{{N}_{a} ( q )} {\vert {VFT}_{z , q}^{mono} ( {f}_{b} , {f}_{s} ) \vert}^{2} \qquad [ 13 ]$$

In the expressions, f_{sdc}=−N_{VFT}/2, . . . , and −N_{VFT}/2+N_{Δfd(q)}−1 holds true and N_{Δfd(q)}=round(Δfd(q)/(1/(TᵣN_{c})) holds true. In addition, round(x) is an operator that rounds off real number x and outputs an integer value.

Accordingly, the range of DFreq subjected to the CFAR processing in first CFAR section 210 can be set (for example, reduced) to 1/(Nt(q)+δ_{q})=1/(N_{DM}(q)+δ_{q}) of the entire range (for example, the range of from −N_{VFT}/2 to N_{VFT}/2−1). It is thus possible to reduce the computational amount of the CFAR processing.

For example, first CFAR section 210 adaptively sets a threshold, and outputs, to first demultiplexer 211, f_{bp}^{mono} and f_{sdcp}^{mono} as f_{bp}^{Mono} and fₛₚ^{Mono} that provide reception power greater than the threshold, and, the reception power information (PowerFT_{q}^{mono}(f_{bp}^{mono}, f_{sdcp}^{mono}+(ndm−1)×N_{Δfd(q)})). Here, ndm is an integer of from 1 to N_{DM}(q)+δ_{q}.

### [Exemplary Operation of First Demultiplexer 211]

First demultiplexer 211 of qth radar section 10 performs DDM demultiplexing on first reflected wave signals in the MNS configuration using the outputs of first DA section 209, for example, based on f_{bp}^{mono}, fₛₚ^{mono}, and the reception power information inputted from first CFAR section 210.

<Case of δ_{q}>0:>

In first demultiplexer 211, for example, in a case of δ_{q}=0, DFreq of the target object may be determined assuming that −1/(2TᵣN_{sw}N_{DM}(q))≤f_{d}<1/(2TᵣN_{sw}N_{DM}(q)).

<Case of δ_{q}>0:>

In first demultiplexer 211, for example, DFreq of the target object may be determined assuming that −1/(2TᵣN_{sw})≤f_{d}<1/(2TᵣN_{sw}). Further, a large difference between, on one hand, the reception levels for top N_{DM}(q) DF-Indices of reception power and, on the other hand, the reception levels for δ_{q} DF-Indices different from the top N_{DM} DF-Indices of reception power (for example, the difference being equal to or greater than the threshold) may be used. For example, first demultiplexer 211 compares the reception power information inputted from first CFAR sections 210 and primarily determines DFreq. Note that an exemplary operation of first demultiplexer 211 is disclosed in, for example, PTL 3, and therefore description of the exemplary operation is omitted here.

For example, first demultiplexer 211 outputs information on the demultiplexed signal to first angle measurer 212. The information related to the demultiplexed signal may include R-Index and the DDM-signal demultiplexing index information corresponding to the demultiplexed reception signal. Further, the output of first demultiplexer 211 may include the output from first DA section 209. The DDM-signal demultiplexing index information is information in which the DDM-signal DS amounts applied to transmission antennas Tx #1 to Tx #N_{DM}(q) of qth radar section 10 which perform transmission are associated with f_{sdcp}^{mono}+(ndm−1)×N_{Δfd(q)} based on the relation between δ_{q} DF-Indices of a lower reception level and top N_{DM} DF-Indices of a higher reception power. First demultiplexer 211 outputs such association information to first angle measurer 212 as DDM-signal demultiplexing index information f_{Tx}(q)=(f_{dmlTx #1}(q) to f_{dmlTx #NDM}(q)).

Here, f_{dmlTx #n}(q) indicates the DF-Index of a reflected wave signal of TxSig by nth transmission antenna 103 (Tx #n) of qth radar section 10.

### [Exemplary Operation of Second CFAR Section 210]

For example, second CFAR section 210 of qth radar section 10 may perform the following operation in order to receive the reflected wave signal based on TxSig from qeth radar section 10.

Here, “qe” represents a radar number of radar section 10 that differs from qth radar section 10. For example, “qe” may be 2 in the case of first radar section 10 (q=1), or “qe” may be 1 in the case of second radar section 10 (q=2).

For example, second CFAR section 210 of qth radar section 10 may perform peak detection by, for example, searching, in the power addition values of outputs from second DA sections 209 of first to Na(q)th analyzers 206, for a power peak that matches the DDM interval set for TxSig of qeth radar section 10 for each R-Index, and performing adaptive threshold processing.

The operation of second CFAR section 210 of qth radar section 10 is the same as the operation of first CFAR section 210 except for a difference in that an output from second DA section 209 is used instead of an output from first DA section 209 in the operation of first CFAR section 210 and the DDM intervals set for TxSig in geth radar section 10 are used instead of the DDM intervals set for TxSig in qth radar section 10, and thus a detailed description of the operation is omitted.

Second CFAR section 210 adaptively sets the threshold, and outputs R-Index f_{bp}^{mul}, DFreq index f_{sdcp}^{mul} and the reception power information (PowerFT_{q}^{mul} (f_{bp}^{mul}, f_{sdcp}^{mul}+(ndm−1)×N_{Δfd(qe)}) that provide reception power greater than the threshold to second demultiplexer 211. Here, ndm is an integer of from 1 to N_{DM}(qe)+δ_{qe}. In the following, the CFAR processing in above-described second CFAR section 210 is also referred to as “multi-reception CFAR.”

### [Exemplary Operation of Second Demultiplexer 211]

Second demultiplexer 211 of qth radar section 10 performs DDM demultiplexing on the second reflected wave signals in the BMS configuration, for example, using the outputs of second DA sections 209 based on f_{bp}^{mul}, fₛₚ^{mul}, and reception power information inputted from second CFAR section 210.

The operation of second demultiplexer 211 is the same as the operation of first demultiplexer 211 except for a difference in that f_{bp}^{mono}, fₛₚ^{mono}, and reception power information inputted from first CFAR section 210 in the operation of first demultiplexer 211 are replaced with f_{bp}^{mul}, fₛₚ^{mul}, and reception power information inputted from second CFAR section 210, and the output of first DA section 209 is replaced with the output of second DA section 209, and thus, the description thereof will be omitted.

For example, second demultiplexer 211 associates the DS amounts of the DDM signals, which are transmitted from qeth radar section 10, with f_{sdcp}^{mul}+ (ndm−1)×N_{Δfd(qe)} based on the relation between δ_{qe} DF-Indices of a lower reception level and top N_{DM}(qe) DF-Indices of a higher reception power, and outputs it as DDM-signal demultiplexing index information f_{Tx}(qe) to second angle measurer 212. Here, f_{Tx}(qe) indicates DF-Index of the reflected wave signal of TxSig transmitted from each transmission antenna 103 of qeth radar section 10.

Further, second demultiplexer 211 outputs, for example, information on the demultiplexed signal to second angle measurer 212. The information about the demultiplexed signals may include, for example, R-Index and the DDM-signal demultiplexing index information corresponding to the demultiplexed reception signal. The outputs of second demultiplexer 211 may include an output from second DA section 209. Note that the detectable DFreq range is ±1/(2TᵣN_{sw}).

### [Exemplary Operation of First Angle Measurer 212]

First angle measurer 212 of qth radar section 10 performs, for example, angle measurement processing on the first reflected wave signal in the MNS configuration based on information inputted from first demultiplexer 211 (for example, R-Index f_{bp}^{mono}(q) and DDM-signal demultiplexing index information f_{Tx}(q)).

For example, first angle measurer 212 performs the angle measurement processing by extracting the outputs from first DA section 209 based on f_{bp}^{mono}(q) and DDM-signal demultiplexing index information f_{Tx}(q), and generating qth virtual reception array correlation vector h_{q}(f_{bp}^{mono}(q), f_{Tx}(q)) of first angle measurer 212 as represented in following Expression 14. Here, for example, q=1, 2.

The qth virtual reception array correlation vector h_{q}(f_{bp}^{mono}(q), f_{Tx}(q)) of first angle measurer 212 includes Nt(q)×Na(q) elements, which are products of number Nt(q) of transmission antennas and number Na(q) of reception antennas, as given by Expression 14. The qth virtual reception array correlation vector h_{q}(f_{bp}^{mono}(q), f_{Tx}(q)) is used for the angle measurement processing on reflected wave signals from a target based on the phase difference between reception antennas 202. Here, z is an integer of 1 to Na(q).

$$( Expression 14 )$$

$${h}_{q} ( {f}_{bp}^{mono} ( q ) , {f}_{Tx} ( q ) ) = [ \begin{matrix}{h}_{cal [ 1 ]} {VFT}_{1 , q}^{MONO} ( {f}_{bp}^{mono} ( q ) , {f}_{dmlTx \#1} ( q ) ) \\ {h}_{cal [ 2 ]} {VFT}_{2 , q}^{MONO} ( {f}_{bp}^{mono} ( q ) , {f}_{dmlTx \#1} ( q ) ) \\ ⋮ \\ {h}_{cal [ {N}_{a} ( q ) ]} {VFT}_{{N}_{a} ( q ) , q}^{MONO} ( {f}_{bp}^{mono} ( q ) , {f}_{dmlTx \#1} ( q ) ) \\ {h}_{cal [ {N}_{a} ( q ) + 1 ]} {VFT}_{1 , q}^{MONO} ( {f}_{bp}^{mono} ( q ) , {f}_{dmlTx \#2} ( q ) ) \\ {h}_{cal [ {N}_{a} ( q ) + 2 ]} {VFT}_{2 , q}^{MONO} ( {f}_{bp}^{mono} ( q ) , {f}_{dmlTx \#2} ( q ) ) \\ ⋮ \\ {h}_{cal [ 2 {N}_{a} ( q ) ]} {VFT}_{{N}_{a} ( q ) , q}^{MONO} ( {f}_{bp}^{mono} ( q ) , {f}_{dmlTx \#2} ( q ) ) \\ ⋮ \\ {h}_{cal [ {N}_{a} ( q ) ( {N}_{t} ( q ) - 1 ) + 1 ]} {VFT}_{1 , q}^{MONO} ( {f}_{bp}^{mono} ( q ) , {f}_{dmlTx {\# N}_{t}} ( q ) ) \\ {h}_{cal [ {N}_{a} ( q ) ( {N}_{t} ( q ) - 1 ) + 2 ]} {VFT}_{2 , q}^{MONO} ( {f}_{bp}^{mono} ( q ) , {f}_{dmlTx {\# N}_{t}} ( q ) ) \\ ⋮ \\ {h}_{cal [ {N}_{a} ( q ) ( {N}_{t} ( q ) ]} {VFT}_{{N}_{a} ( q ) , q} ( {f}_{bp}^{MONO} ( q ) , {f}_{dmlTx {\# N}_{t}} ( q ) )\end{matrix} ] \qquad [ 14 ]$$

In Expression 14, h_{cal[b]} is an array correction value that corrects a phase deviation and an amplitude deviation between transmission array antennas and between reception array antennas. The character “b” denotes an integer of 1 to (Nt(q)×Na(q)).

First angle measurer 212 of qth radar section 10 calculates a space profile by using, for example, qth virtual reception array correlation vector h_{q}(f_{bp}^{mono}(q), f_{Tx}(q)), and varying azimuth direction θᵤ in angle measurement evaluation function P_{H}(θᵤ, f_{bp}^{mono}(q), f_{Tx}(q)) within a predetermined angle range.

First angle measurer 212 may extract a predetermined number of maximum peaks of the calculated space profile in descending order, and may output the azimuth directions of the maximum peaks as angle measurement values (for example, positioning outputs).

Note that, there are various methods (beamformer method, Capon, MUSIC, and the like) as the angle measurement algorithm. For example, the estimation method using an array antenna disclosed in NPL 5 may be used. For example, in a case where the number of virtual reception antennas is Nt×Na and the virtual reception antennas are linearly disposed at equal spacings d_{H}, the beamformer method can be represented as following Expression 15. In addition to the beamformer method, a technique such as Capon or MUSIC is also applicable.

$$( Expression 15 )$$

$${P}_{H} ( {θ}_{u} , {f}_{bp}^{mono} ( q ) , {f}_{Tx} ( q ) ) = {a}^{H} ( {θ}_{u} ) {h}_{q} ( {f}_{bp}^{mono} ( q ) , {f}_{Tx} ( q ) ) \qquad [ 15 ]$$

In Expression 15, superscript H represents a Hermitian transpose operator. Further, in Expression 15, a(θᵤ) indicates the direction vector of the virtual reception array for the incoming wave in azimuth direction θᵤ at center frequency fc of the radar transmission signal, and is a column vector having Nt×Na elements as represented in Expression 16. In Expression 16, λ is the wavelength of a radar transmission signal (for example, a chirp signal) in a case of center frequency f_{c}, and λ=C₀/f_{c}.

$$( Expression 16 )$$

$$a ( {θ}_{u} ) = [ \begin{matrix}1 \\ exp ( - j 2 π {d}_{H} sin {θ}_{u} / λ ) \\ ⋮ \\ exp ( - j 2 π ( {N}_{t} {N}_{a} - 1 ) {d}_{H} sin {θ}_{u} / λ )\end{matrix} ] \qquad [ 16 ]$$

Further, azimuth direction θᵤ is a vector varied at predetermined azimuth interval β₁ within an azimuth range in which the arrival direction estimation is performed.

Through the above operations, first angle measurer 212 of qth radar section 10 may output, for example, the arrival direction estimation value for distance index f_{bp}^{mono}(q) and DDM-signal demultiplexing index information f_{Tx}(q) to integrator 30 as the positioning output. Further, first angle measurer 212 may further output distance index f_{bp}^{mono} and DDM-signal demultiplexing index information f_{Tx}(q) as the positioning output.

Further, distance index f_{bp}^{mono}(q) may be converted to distance information using Expression 1 for output.

Further, the Doppler frequency of a target object for distance index f_{bp}^{mono}(q) may be outputted. Since the DS amounts applied in DS sections 102 at the time of transmission are known for each transmission antenna 103, first angle measurer 212 may output the Doppler frequency of the target object based on the DDM-signal demultiplexing index information.

### [Exemplary Operation of Second Angle Measurer 212]

Second angle measurer 212 of qth radar section 10 performs, for example, the angle measurement processing on the second reflected wave signal in the BMS configuration based on information inputted from second demultiplexer 211 (for example, distance index f_{bp}^{mul}(q) and DDM-signal demultiplexing index information f_{Tx}(qe)). Here, for example, when q=1, qe=2, and when q=2, qe=1.

Second angle measurer 212 extracts the output of second DA section 209 based on, for example, distance index f_{bp}^{mul}(q) and DDM-signal demultiplexing index information f_{Tx}(qe), and generates qth reception array correlation matrix H_{q}(f_{bp}^{mul}(q), f_{Tx}(qe)) of second angle measurer 212 as given by Expression 17. For example, when the distance indicated by distance index f_{bp}^{mul}(q) is regarded as a near target object, second angle measurer 212 performs near target object angle measurement processing, and when the distance indicated by distance index f_{bp}^{mul}(q) is regarded as a distant target object, second angle measurer 212 performs distant target object angle measurement processing.

The qth reception array correlation matrix H_{q}(f_{bp}^{mul}(q), f_{Tx}(qe)) of second angle measurer 212 is, as given by Expression 17, an Na(q)×Nt(qe)th order matrix composed of columns corresponding to number Nt(qe) of transmission antennas of geth radar section 10 and rows corresponding to number Na(q) of reception antennas of qth radar section 10. The qth reception array correlation matrix H_{q}(f_{bp}^{mul}(q), f_{Tx}(qe)) performs direction estimation no reflected wave signals from the target based on a phase difference between reception antennas 202. Here, z=1 to Na(q).

$$( Expression 17 )$$

$${H}_{q} ( {f}_{bp}^{Mul} ( q ) , {f}_{Tx} ( qe ) ) = \\ \\ [ \begin{matrix}{h}_{cal [ 1 ]} {VFT}_{1 , q}^{Mul} ( {f}_{bp}^{Mul} ( q ) , {f}_{dmlTx \#1} ( qe ) ) {h}_{cal [ {N}_{a} ( q ) + 1 ]} {VFT}_{1 , q}^{Mul} ( {f}_{bp}^{Mul} ( q ) , {f}_{dmlTx \#2} ( qe ) ) … {h}_{cal [ {N}_{a} ( q ) ( Nt ( qe ) - 1 ) + 1 ]} {VFT}_{1 , q}^{Mul} ( {f}_{bp}^{Mul} ( q ) , {f}_{dmulTX \# Nt} ( qe ) ) \\ {h}_{cal [ 2 ]} {VFT}_{2 , q}^{Mul} ( {f}_{bp}^{Mul} ( q ) , {f}_{dmlTx \#1} ( qe ) ) {h}_{cal [ {N}_{a} ( q ) + 2 ]} {VFT}_{2 , q}^{Mul} ( {f}_{bp}^{Mul} ( q ) , {f}_{dmlTx \#2} ( qe ) ) … {h}_{cal [ {N}_{a} ( q ) ( Nt ( qe ) - 1 ) + 2 ]} {VFT}_{2 , q}^{Mul} ( {f}_{bp}^{Mul} ( q ) , {f}_{dmlTX \# Nt} ( qe ) ) \\ ⋮ \\ {h}_{cal [ {N}_{a} ( q ) ]} {VFT}_{{N}_{a} ( q ) , q}^{Mul} ( {f}_{bp}^{Mul} ( q ) , {f}_{dmlTx \#1} ( qe ) ) {h}_{cal [ 2 {N}_{a} ( q ) ]} {VFT}_{Na ( q ) , q}^{Mul} ( {f}_{bp}^{Mul} ( q ) , {f}_{dmlTx \#2} ( qe ) ) … {h}_{cal [ {N}_{a} ( q ) ( Nt ( qe ) ]} {VFT}_{Na ( q ) , q}^{Mul} ( {f}_{bp}^{Mul} ( q ) , {f}_{dmulTX \# Nt} ( qe ) )\end{matrix} ] \qquad [ 17 ]$$

In Expression 17, h_{cal[b]} is an array correction value that corrects a phase deviation and an amplitude deviation between transmission array antennas and between reception array antennas. The character “b” denotes an integer of 1 to (Nt(qe)×Na(q)).

### <Near Target Object Angle Measurement Processing>

In a case where the distance indicated by distance index f_{bp}^{mul}(q) is considered to be a near target object, second angle measurer 212 performs, based on geth reception array correlation matrix H_{q}(f_{bp}^{mul}(q), f_{Tx}(qe)) as given by Expression 17, the near target object angle measurement processing for estimating the direction of departure (DOD) and the direction of arrival (DOA).

Second angle measurer 212 of qth radar section 10 may output the direction of departure (DOD), for example, to integrator 30 as the angle measurement estimation value (for example, the positioning output). Further, second angle measurer 212 of qth radar section 10 may output the direction of arrival (DOA), for example, to integrator 30 as the angle measurement estimation value (for example, the positioning output).

Second angle measurer 212 of qth radar section 10 calculates the space profile by varying azimuth direction θᵤ in DOD angle measurement evaluation function P_{TxH}(θᵤ, f_{bp}^{mul}(q), f_{Tx}(qe)) in a predetermined angle range, for example. Second angle measurer 212 may extract a predetermined number of maximum peak directions of the calculated space profile in descending order, and may output the DODs of the maximum peaks to integrator 30 as angle measurement estimation values (for example, positioning outputs).

Note that, for DOD angle measurement evaluation function P_{TxH,q}(θᵤ, f_{bp}^{mul}(q), f_{Tx}(qe)), various angle measurement estimation algorithms may be used. For example, the angle measurement processing may be performed using the angle measurement processing in the BMS configuration described in, for example, NPL 2 or NPL 6. Further, the estimation method using an array antenna disclosed in NPL 5 may be used. For example, the beamformer method can be represented as Expression 18. In addition to the beamformer method, techniques such as Capon, MUSIC, and the like are also applicable. Note that, in Expression 18, superscript H represents a Hermitian transpose operator.

$$( Expression 18 )$$

$${P}_{TxH , q} ( {θ}_{u} , {f}_{bp}^{Mul} ( q ) , {f}_{Tx} ( q e ) ) = {a}_{Tx ( q e )}^{H} ( {θ}_{u} ) {H}_{q}^{H} ( {f}_{bp}^{Mul} ( q ) , {f}_{Tx} ( q e ) ) {H}_{q} ( {f}_{bp}^{Mul} ( q ) , {f}_{Tx} ( q e ) ) {a}_{Tx ( q e )} ( {θ}_{u} ) \qquad [ 18 ]$$

In Expression 18, a_{Tx(qe)}(θᵤ) indicates a transmission array direction vector for an incoming wave in azimuth direction θᵤ at center frequency fc in the transmission antenna in qeth radar section 10.

Further, second angle measurer 212 of qth radar section 10 calculates the space profile by varying azimuth direction θ_{Rx} in DOA angle measurement evaluation function P_{RxH,q}(θᵤ, f_{bp}^{mul}(q), f_{Tx}(qe)) in a predetermined angle range for each direction of arrival (DOA), for example. Second angle measurer 212 may extract a predetermined number of maximum peak directions of the calculated space profile in descending order, and may output the DOA of the maximum peak as a direction estimation value (for example, a positioning output) to integrator 30.

Note that, for DOA angle measurement evaluation function P_{RxH,q}(θᵤ, f_{bp}^{mul}(q), f_{Tx}(qe)), various angle measurement estimation algorithms may be used. For example, the beamformer method can be represented as Expression 19.

$$( Expression 19 )$$

$${P}_{RxH , q} ( {θ}_{u} , {f}_{bp}^{Mul} ( q ) , {f}_{Tx} ( q e ) ) = {a}_{Rx ( q )}^{H} ( {θ}_{u} ) {H}_{q} ( {f}_{bp}^{Mul} ( q ) , {f}_{Tx} ( q e ) ) {H}_{q}^{H} ( {f}_{bp}^{Mul} ( q ) , {f}_{Tx} ( q e ) ) {a}_{Rx ( q )} ( {θ}_{u} ) \qquad [ 19 ]$$

In Expression 19, a_{Rx(q)}(θᵤ) represents a reception array direction vector of the reception antenna in qth radar section 10 to an incoming wave in azimuth direction θᵤ at center frequency f_{c}. Further, azimuth direction θᵤ is a vector that is varied at predetermined azimuth interval β₁ in the azimuth range over which the direction estimation is performed.

### <Distant Target Object Angle Measurement Processing>

In a case where the distance indicated by distance index f_{bp}^{mul}(q) is considered to be a distant target object, second angle measurer 212 generates qth virtual reception array correlation vector h_{q}^{BMS}(f_{bp}^{mul}(q), f_{Tx}(qe)) in the BMS configuration as indicated in following Expression 20 based on qth reception array correlation matrix H_{q}(f_{bp}^{mul}(q), f_{Tx}(qe)) as indicated in Expression 17, and performs the angle measurement processing. Here, Vec[H] is an operator that concatenates column vectors of matrix H in order in the column direction to generate one column vector, and the Nt(qe)×Na(q)th order column vectors are generated by Expression 20. Further, in the case of q=1, qe=2, and in the case of q=2, qe=1.

$$( Expression 20 )$$

$${h}_{q}^{BMS} ( {f}_{bp}^{mul} ( q ) , {f}_{Tx} ( q e ) ) = Vec [ {H}_{q} ( {f}_{bp}^{Mul} ( q ) , {f}_{Tx} ( q e ) ) ] \qquad [ 20 ]$$

Second angle measurer 212 in qth radar section 10 calculates the space profile by changing azimuth direction θᵤ in BMS configuration angle measurement evaluation function P_{H}^{BMS}(θᵤ, f_{bp}^{mul}, f_{Tx}(qe)) within a predetermined angle range using, for example, qth virtual reception array correlation vector H_{q}^{BMS}(f_{bp}^{mul}(q), f_{Tx}(qe)) in the BMS configuration. Second angle measurer 212 may, for example, extract a predetermined number of maximum peaks of the calculated space profile in descending order, and output the azimuth directions of the maximum peaks as angle measurement values (for example, positioning outputs). Note that, the angle measurement algorithm may be implemented using various methods (beamformer method, Capon, MUSIC, and the like).

For example, when the number of qth virtual reception antennas in the BMS configuration is Nt(qe)×Na(q) and qth virtual reception antennas are linearly disposed at equal spacings d_{H}, the BMS configuration angle measurement evaluation function using the beamformer method can be represented by following Expression 21.

In Expression 21, superscript H represents a Hermitian transpose operator. Further, in Expression 21, a_{BMS,q}(θᵤ) indicates the direction vector of the qth virtual reception antenna in the BMS configuration for the incoming wave in azimuth direction θᵤ at center frequency fc of the radar transmission signal, and is a column vector including Nt(qe)×Na(q) elements as represented by Expression 22. In Expression 22, λ is the wavelength of a radar transmission signal (for example, a chirp signal) in a case of center frequency f_{c}, and λ=C₀/f_{c}. Further, azimuth direction θᵤ is a vector varied at predetermined azimuth interval β₁ within an azimuth range in which the arrival direction estimation is performed.

$$( Expression 21 )$$

$$\begin{matrix}{P}_{H , q}^{BMS} ( {θ}_{u} , {f}_{bp}^{mul} ( q ) , {f}_{Tx} ( qe ) ) \\ = {a}_{BMS , q}^{H} ( {θ}_{u} ) {h}_{q}^{BMS} ( {f}_{bp}^{mul} ( q ) , {f}_{Tx} ( qe ) )\end{matrix} \qquad [ 21 ]$$

$$( Expression 22 )$$

$${a}_{BMS , q}^{H} ( {θ}_{u} ) = [ \begin{matrix}1 \\ exp ( - j 2 π {d}_{H} sin {θ}_{u} / λ ) \\ ⋮ \\ exp ( - j 2 π ( {N}_{t} ( qe ) {N}_{a} ( q ) - 1 ) {d}_{H} sin {θ}_{u} / λ )\end{matrix} ] \qquad [ 22 ]$$

Note that, first and second angle measurers 212 are described as an example in which the azimuth direction is calculated as the angle measurement estimation value, but the present disclosure is not limited thereto, and a direction estimation in the elevation direction or a direction estimation in the azimuth direction and the elevation direction can also be performed by using MIMO antennas arranged in a rectangular grid pattern. For example, second angle measurer 212 may calculate the azimuth direction and the elevation direction as the measurement estimation values and use them as the positioning outputs.

According to the above-described operations, second angle measurer 212 of qth radar section 10 may, for example, output, as the positioning output, 1) the direction-of-departure (DOD) estimation value and the direction-of-arrival (DOA) estimation value in DDM-signal demultiplexing index information f_{Tx}(qe) when the distance indicated by distance index f_{bp}^{mul}(q) is considered as a near target object, and 2) the angle measurement value using BMS configuration angle measurement evaluation function P_{H,q}^{BMS}(θᵤ, f_{bp}^{mul}(q), f_{Tx}(qe)), assuming that the direction of departure (DOD) and the direction of arrival (DOA) are identical to each other, when the distance indicated by distance index f_{bp}^{mul}(q) is considered as a distant target object.

Further, second angle measurer 212 may further output f_{bp}^{mul}(q) and DDM-signal demultiplexing index information f_{Tx}(qe) as the positioning output.

Further, distance index f_{bp}^{mul}(q) may be converted into distance information using Expression 2 for output.

The DS amount that is applied in DS section 102 during transmission by qeth radar section 10 is known for each of transmission antennas 103 in geth radar section 10, and thus, second angle measurer 212 may output the Doppler frequency of a target object based on DDM-signal demultiplexing index information f_{Tx}(qe).

Here, the positions of first radar section 10 and second radar section 10 are known to radar apparatus 1 in advance. For example, the target object may be present on an ellipse that has the positions of first radar section 10 and second radar section 10 as foci, in which the sum of the distances from two foci is a distance for BMS as indicated by distance indices f_{bp}^{mul}(q) outputted from second angle measurer 212. Further, the direction of departure (DOD) of qeth radar section 10 and the direction of arrival (DOA) of qth radar section 10 are estimated, and thus, second angle measurer 212 can definitively determine the target object position with the use of the angle measurement results. Second angle measurer 212 may, for example, use the estimation result of the target object position in a radar having the BMS configuration described above as a positioning output.

Further, in a case where an intersection of the two straight lines based on DOD and DOA does not exist on the elliptical curve described above, second angle measurer 212 may determine that the wave is a target object indirect wave, and the target object positioning result is likely to be incorrect, and thus second angle measurer 212 does not have to use the positioning result as the positioning output, or may use the positioning result as the positioning output and output the result in which the wave is determined to be the target object indirect wave.

Note that, the determination of the target object indirect wave described above may be processed in subsequent integrator 30.

Further, the method for estimating the target object position in a radar including a BMS configuration is described in, for example, NPL 6, and thus, a detailed description of the estimation method will be omitted.

Hereinabove, the exemplary operation of second angle measurer 212 has been described.

### [Exemplary Operation of Integrator 30]

In FIG. 4, integrator 30 performs positioning of a target object by integrating the positioning outputs of first angle measurer 212 and second angle measurer 212 from first radar section 10 and the positioning outputs of first angle measurer 212 and second angle measurer 212 from second radar section 10.

Integrator 30 performs determination processing for determining the target object indirect wave based on the output of second angle measurer 212 in each radar section 10.

For example, when integrator 30 receives a reflected wave signal (for example, second reflected wave signal) corresponding to a radar transmission signal (for example, second transmission signal) transmitted from second radar section 10 in first radar section 10, integrator 30 determines, based on the second reflected wave signal, and based on the DOD of the second transmission signal transmitted from second radar section 10, the DOA of the second reflected wave signal received by first radar section 10, and the distance between first radar section 10 and the target object (target object that reflects the second transmission signal), whether the second reflected wave signal is a direct wave from the target object (or which of the target object direct wave and the target object indirect wave the second reflected wave signal is). Note that, even when integrator 30 receives the reflected wave signal (for example, first reflected wave signal) corresponding to the radar transmission signal (for example, first transmission signal) transmitted from first radar section 10 in second radar section 10, integrator 30 may also determine whether the reflected wave signal is a target object direct wave or a target object indirect wave.

For example, when the intersection of the two straight lines based on the direction of departure (DOD) of qeth radar section 10 and the direction of arrival (DOA) of qth radar section 10 is not present on the ellipse having the positions of first radar section 10 and second radar section 10 as foci, in which the sum of the distances from two foci is a distance for BMS as indicated by distance indices f_{bp}^{mul}(q) outputted from second angle measurer 212, it may be determined that the wave is a target object indirect wave. In this case, integrator 30 may, for example, not use the positioning result as the positioning output since there is a high possibility that the target object positioning result is incorrect, or may use the positioning result as the positioning output and output the result in which the positioning result is determined as the target object indirect wave.

In a case where the positioning result is determined as the target object indirect wave as described above, integrator 30 may exclude the positioning output determined as the target object indirect wave from the positioning of the target object and process the excluded positioning output. Further, for example, when a target object with a large lateral width is present, such as a wall or a vehicle, integrator 30 may estimate the target object position in a case where the target object indirect wave is regarded as a reflected wave of a target object with a large lateral width, and may output the target object position. Alternatively, when, for example, a road surface or the like is present, integrator 30 may estimate the target object position in a case where the target object indirect wave is regarded as a road surface reflected wave, and may output the estimated target object position.

Note that, even when a result in the positioning output of second angle measurer 212 in which the positioning result is determined as a target object indirect wave is output, the same applies.

Further, for example, integrator 30 may perform the type determination of the target object based on the consistency between the positioning result of second angle measurer 212 of first radar section 10, which is a positioning result in a BMS configuration, and the positioning result of second angle measurer 212 of second radar section 10. For example, integrator 30 may utilize the tendency of a high consistency in the case of poles (metal poles) and a low consistency at a reflection point in the case of a target object having a large horizontal dimension, such as a wall.

Further, for example, in a case where the detection areas overlap in the positioning output of first angle measurer 212 of first radar section 10 and the positioning output of first angle measurer 212 of second radar section 10, which are positioning results of MNS configurations, integrator 30 may output a component with a high consistency in both of the estimation results. For example, integrator 30 may not output less consistent components between both of the estimation results.

By performing the above-described operations, integrator 30 can remove target object indirect waves or multipath reflections that are virtual images.

Note that integrator 30 may output the positioning output (or the positioning result) to, for example, a control apparatus (ECU or the like) of a vehicle in the case of an in-vehicle radar, or to an infrastructure control apparatus in the case of an infrastructure radar, which are not illustrated.

### [Antenna Arrangement Example of Radar 10]

Next, an exemplary operation of angle measurer 212 in the cases where transmission antenna 103 and reception antenna 202 are disposed in first radar section 10 and second radar section 10, and an antenna arrangement example is used will be described.

Note that, hereinafter, transmission antenna 103 and reception antenna 202 in first radar section 10 and second radar section 10 are also referred to as “MIMO antenna” in a general sense.

Further, in the following description, each antenna that constitutes a MIMO antenna may be a sub-array configuration in which a plurality of antenna elements (for example, a planar patch antenna) are arrayed in the vertical direction and lateral direction, or a sub-array configuration made of a plurality of planar patch antennas that satisfies a desired beam width, for example. Further, the MIMO antenna may have a sub-array configuration in which planar patch antennas are arrayed in any one direction of the vertical direction and lateral direction. The more the number of planar patch antennas constituting the sub-array are in horizontal (or vertical) direction, directivity beam in horizontal (or vertical) direction can be formed sharply.

Further, Nt(q) transmission antennas 103 in qth radar section 10 are represented as Tx(q) #1 to #Nt(q), and Na(q) reception antennas 202 are represented as Rx(q) #1 to #Na(q). Here, q is, for example, q=1 or 2.

Hereinafter, MIMO antenna arrangements A, B, and C will be described as arrangement examples of the MIMO antenna. With these MIMO antenna arrangements, radar apparatus 1 can improve radar detection performance by reducing misdetermination for target object indirect waves. Further, MIMO antenna arrangements A, B, and C are antenna arrangements in which the aperture lengths of virtual reception antennas at the time of angle measurement in the MNS configuration and at the time of far-field angle measurement in the BMS configuration are increased, and thus, the angle measurement performance at the time of angle measurement in the MNS configuration and at the time of far-field angle measurement in the BMS configuration can be improved.

Note that, the same applies even when first radar section 10 and second radar section 10 are replaced with (for example, exchanged with) second radar section 10 and first radar section 10, respectively, in the arrangement conditions in each of MIMO antenna arrangements A, B, and C.

### [MIMO Antenna Arrangement A]

The MIMO antenna arrangements in first radar section 10 and second radar section 10 satisfy, for example, following arrangement condition A.

### <Arrangement Condition A>

### A-1)

Each of minimum antenna spacing MinAS(Tx(1)) for the antenna spacing (for example, the adjacent antenna spacing) between the plurality of transmission antennas 103 of first radar section 10 and minimum antenna spacing MinAS(Rx(2)) for the antenna spacing between the plurality of reception antennas 202 of second radar section 10 includes spacing Da that is equal to or larger than 0.5 wavelengths and is smaller than 1 wavelength. For example, MinAS(Tx(1))<λ and MinAS(Rx(2))<λ. Here, Da may be the maximum value of MinAS(Tx(1)) and MinAS(Rx(2)).

In addition, minimum antenna spacing MinAS(Rx(1)) of the plurality of reception antennas 202 of first radar section 10 and minimum antenna spacing MinAS(Tx(2)) of the plurality of transmission antennas 103 of second radar section 10 are wider tha spacing Da. For example, MinAS(Rx(1))>Da and MinAS(Tx(2))>Da.

### A-2)

The reception antenna spacing of first radar section 10 includes a spacing wider than aperture length ApTx(1) of the transmission antennas of first radar section 10, and
the transmission antenna spacing of second radar section 10 includes a spacing wider than aperture length ApRx(2) of the reception antennas of second radar section 10.

### A-3)

The reception antenna spacing of second radar section 10 includes a spacing wider than aperture length ApTx(1) of the transmission antennas of first radar section 10, or
the transmission antenna spacing of first radar section 10 includes a spacing wider than aperture length ApRx(2) of the reception antennas of second radar section 10.

Here, arrangement condition A-1 has a grating suppression effect at the time of the near target object positioning in the angle measurement with the BMS configuration. For example, radar apparatus 1 is capable of positioning DOD and DOA without a grating. Further, radar apparatus 1 can determine that the received reflected wave signal is a target object indirect wave in a case where the target object distance is satisfied and the intersection of two straight lines based on DOD and DOA is not present on an ellipse having the transmission antenna positions of first radar section 10 and second radar section 10 (for example, the transmission antenna positions of first transmission antennas Tx(1) #1 and Tx(2) #1) as foci, and thus prevent an erroneous positioning result from being outputted, the target object indirect wave can be removed.

Note that, arrangement condition A-1 is a condition (or a condition in which the BMS configuration is asymmetrical) in which the MIMO antenna arrangement in first radar section 10 and second radar section 10 is not the same arrangement. For example, in a case where the number of transmission antennas and the number of reception antennas are relatively small (for example, in a case where the numbers are equal to or less than a threshold), the degree of freedom in antenna arrangement between radars can be increased in a BMS configuration. Thus, it is possible to further increase the antenna aperture length and possible to improve the target object angle measurement accuracy and the angle measurement resolution in a near target object positioning in a BMS configuration as compared to a case where the MIMO antenna arrangements in first radar section 10 and second radar section 10 are the same arrangement.

Further, by adding at least one of arrangement condition A-2 and arrangement condition A-3 in addition to arrangement condition A-1, the aperture length of a virtual reception array in the MNS configuration can be increased, and the target object angle measurement accuracy and the angle measurement resolution in the MNS configuration can be improved.

Further, arrangement condition A-3 has an effect of increasing the aperture length of a virtual reception array at the time of distant target object positioning in an angle measurement with a BMS configuration. Thus, it is possible to improve the target object angle measurement accuracy and the angle measurement resolution in distant target object positioning in a BMS configuration.

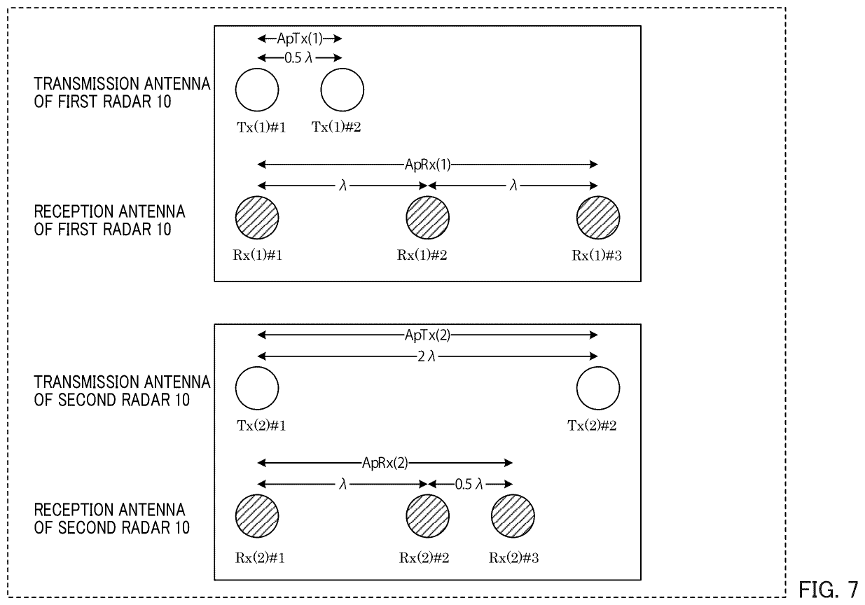

Hereinafter, FIG. 7 illustrates an arrangement example in a case of the number Nt(1)=Nt(2)=2 of transmission antennas and the number Na(1)=Na(2)=3 of reception antennas as an example of MIMO antenna arrangement in first radar section 10 and second radar section 10 that satisfy arrangement condition A.

In FIG. 7, minimum antenna spacing MinAS(Tx(1)) of the transmission antennas of first radar section 10 is the spacing (also called a pitch) between Tx(1) #1 and Tx(1) #2, and is 0.5 wavelengths (=0.5λ=Da). Further, in FIG. 7, minimum antenna spacing MinAS(Rx(2)) of the reception antennas of second radar section 10 is the spacing between Rx(2) #2 and Rx(2) #3, and is 0.5 wavelengths (=0.5λ=Da). Thus, MinAS(Tx(1))<λ, and MinAS(Rx(2))<λ are satisfied. Further, in FIG. 7, minimum antenna spacing MinAS(Rx(1)) of the reception antennas of first radar section 10, for example, is the spacing between Rx(1) #1 and Rx(1) #2, and is 1 wavelength (λ). Further, in FIG. 7, minimum antenna spacing MinAS(Tx(2)) of the transmission antennas of second radar section 10 is the spacing between Tx(2) #1 and Tx(2) #2, and is 2 wavelengths (2λ). Thus, MinAS(Rx(1))>Da and MinAS(Tx(2))>Da. Thus, the MIMO antenna arrangement illustrated in FIG. 7 satisfies arrangement condition A-1.

Further, the reception antenna spacings of first radar section 10 include a spacing (for example, a spacing of λ between Rx(1) #1 and Rx(1) #2) wider than aperture length ApTx(1)(=0.5λ) of the transmission antennas of first radar section 10, and the transmission antenna spacings of second radar section 10 include a spacing (a spacing of 2λ between Tx(2) #1 and Tx(2) #2) wider than aperture length ApRx(2)(=1.5λ) of the reception antenna of second radar section 10. Thus, the MIMO antenna arrangement illustrated in FIG. 7 satisfies arrangement condition A-2.

Further, the reception antenna spacings of second radar section 10 include a spacing (a spacing of λ between Rx(2) #1 and Rx(2) #2) wider than aperture length ApTx(1)(=0.5λ) of the transmission antennas of first radar section 10. Thus, the MIMO antenna arrangement illustrated in FIG. 7 satisfies arrangement condition A-3.

The MIMO antenna arrangement illustrated in FIG. 7 is an arrangement that satisfies arrangement conditions A.

For example, the arrangement of VA_{MN(q)} #1 to VA_{MN(q)} #(Na(q)×Nt(q)) of the virtual reception antennas (or MIMO virtual antennas) in the MNS configuration in qth radar section 10 are configured from the MIMO antenna arrangement in qth radar section 10.

Further, the arrangement of VA_{BM(q)} #1 to VA_{BM(q)} #(Na(q)×Nt(qe)) of virtual reception antennas (or MIMO virtual antenna) are configured for a distant target object in the BMS configuration in the qth radar section 10 from the transmission antenna arrangement in qeth radar section 10 and the reception antenna arrangement in qth radar section 10.

Here, the arrangement of the virtual reception antenna (virtual reception array) in qth radar section 10 in the MNS configuration may be represented as follows in following Expression 23, for example, based on the positions of the transmission antennas in the MNS configuration (for example, the positions of the feeding points) and the positions of the reception antennas in the MNS configuration (for example, the positions of the feeding points).

$$( Expression 23 )$$

$$\{ \begin{matrix}{X}_{VMN ( q ) \# b} = ( {X}_{Tx ( q ) \# [ ceil ( b / Na ( q ) ) ]} - {X}_{Tx ( q ) \#1} ) + ( {X}_{Rx ( q ) \# [ mod ( b - 1 , Na ( q ) ) + 1 ]} - {X}_{Rx ( q ) \#1} ) \\ {Y}_{VMN ( q ) \# b} = ( {Y}_{Tx ( q ) \# [ ceil ( b / Na ( q ) ) ]} - {Y}_{Tx ( q ) \#1} ) + ( {Y}_{Rx ( q ) \# [ mod ( b - 1 , Na ( q ) ) + 1 ]} - {Y}_{Rx ( q ) \#1} )\end{matrix} \qquad [ 23 ]$$

Here, the position coordinates of the transmission antenna (for example, Tx(q) #n) of qth radar section 10 are represented by (X_{Tx(q) #n}, Y_{Tx(q) #n}) (for example, n=1 to Nt(q)), the position coordinates of the reception antenna (for example, Rx(q) #z) are represented by (X_{Rx(q) #z}, Y_{Rx(q) #z}) (for example, z=1 to Na(q)), and the position coordinates of virtual antenna VA_{MN(q)} #b constituting the virtual reception array antenna are represented by (X_{VMN(q) #b}, Y_{VMN(q) #b}) (for example, b=1 to Nt(q)×Na(q)).

Note that, in Expression 23, VA_{MN(q)} #1 represents as a position reference (0,0) of the virtual reception array, for example. Further, hereinafter, X_{Tx(q) #n} represents the position coordinate in the horizontal direction, and Y_{Tx(q) #n} represents the position coordinate in the vertical direction, but the present disclosure is not limited thereto. Here, mod (x, y) is a remainder operator, and a remainder obtained by dividing integer x by integer y is outputted. The ceil (x) is an operator that outputs the smallest integer greater than or equal to argument x.

Further, the arrangement of a virtual reception antenna (virtual reception array) for the distant target object in qth radar section 10 is determined, for example, based on the positions of the transmission antennas in the BMS configuration (for example, the positions of the feeding points) and the positions of the reception antennas in the BMS configuration (for example, the positions of the feeding points). For example, when the position coordinates of the transmission antenna (for example, Tx(qe) #n) in geth radar section 10 are represented as (X_{Tx(qe) #n}, Y_{Tx(qe) #n}) (for example, n=1 to Nt(qe)), and the position coordinates of the reception antenna (for example, Rx(q) #z) in qth radar section 10 are represented as (X_{Rx(q) #z}, Y_{Rx(q) #z}) (for example, z=1 to Na(q)), the position coordinates (X_{VBM(q) #b}, Y_{VBM(q) #b}) (for example, b=1 to Nt(qe)×Na(q)) of virtual antenna VA_{BM(q)} #b constituting the virtual reception array antenna may be represented as in Expression 24.

$$( Expression 24 )$$

$$\{ \begin{matrix}{X}_{VBM ( q ) \# b} = ( {X}_{Tx ( qe ) \# [ ceil ( b / Na ( q ) ) ]} - {X}_{Tx ( qe ) \#1} ) + ( {X}_{Rx ( q ) \# [ mod ( b - 1 , Na ( q ) ) + 1 ]} - {X}_{Rx ( q ) \#1} ) \\ {Y}_{VBM ( q ) \# b} = ( {Y}_{Tx ( qe ) \# [ ceil ( b / Na ( q ) ) ]} - {Y}_{Tx ( qe ) \#1} ) + ( {Y}_{Rx ( q ) \# [ mod ( b - 1 , Na ( q ) ) + 1 ]} - {Y}_{Rx ( q ) \#1} )\end{matrix} \qquad [ 24 ]$$

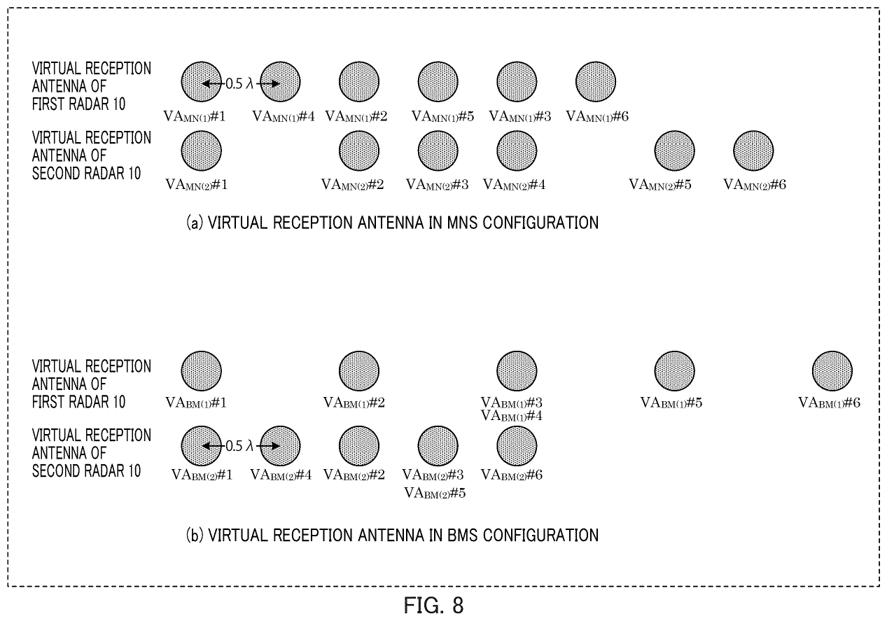

Part (a) in FIG. 8 and part (b) in FIG. 8 illustrate arrangement examples of virtual reception antennas for the MNS configuration and the BMS configuration in each radar section 10 configured with the MIMO antenna arrangement illustrated in FIG. 7.

For example, in a case where the arrangements (X_{Tx(1) #1}, Y_{Tx(1) #1})=(0, 0) and (X_{Tx(1) #2}, Y_{Tx(1) #2})=(0.5λ, 0) of transmission antennas Tx #1(1) and Tx #2(1) of first radar section 10 illustrated in FIG. 7, and the arrangements (X_{Rx(1) #1}, Y_{Rx(1) #1})=(ax, ay), (X_{Rx(1) #2}, Y_{Rx(1) #2})=(ax+λ, ay), and (X_{Rx(1) #3}, Y_{Rx(1) #3})=(ax+2λ, ay) of reception antennas Rx #1 to Rx #3, the position coordinates of the virtual antenna that configure the virtual reception antenna in the MNS configuration are calculated from Expression 23. Here, ax and ay are arbitrary constants. For example, the position coordinates of virtual antennas VA_{MN(1)} #1 to VA_{MN(1)} #6 do not depend on ax and ay, and are as illustrated in part (a) in FIG. 8 as follows: (X_{VMN(1) #1}, Y_{VMN(1) #1})=(0, 0), (X_{VMN(1) #4}, Y_{VMN(1) #4})=(0.5λ, 0), (X_{VMN(1) #2}, Y_{VMN(1) #2})=(λ, 0), (X_{VMN(1) #5}, Y_{VMN(1) #5})=(1.5λ, 0), (X_{VMN(1) #3}, Y_{VMN(1) #3})=(2λ, 0), and (X_{VMN(1) #6}, Y_{VMN(1) #6})=(2.5λ, 0).

Further, as illustrated in part (b) in FIG. 8, the position coordinates of virtual reception antennas VA_{BM(q)} #1 to VA_{BM(q)} #6 for the distant target object in the BMS configuration in qth radar section 10 are calculated in the same manner by Expression 24.

For example, first angle measurer 212 of qth radar section 10 described above performs the angle measurement processing by extracting the output from first DA section 209 based on f_{bp}^{mono}(q) and DDM-signal demultiplexing index information f_{Tx}(q), and generating qth virtual reception array correlation vector h_{q}(f_{bp}^{mono}(q), f_{Tx}(q)) of first angle measurer 212 as given by Expression 14 (the same applies to MIMO antenna arrangement B and MIMO antenna arrangement C to be described later). Here, the reception signal by bth virtual antenna VA_{MN(q)} #b is represented by bth element of virtual reception array correlation vector h_{q}(f_{bp}^{mono}(q), f_{Tx}(q)). Further, first angle measurer 212 performs the angle measurement processing using, as the direction vector of qth virtual reception antenna in the MNS configuration, a direction vector generated based on the arrangement of the MIMO virtual reception antennas illustrated in part (a) in FIG. 8, for example.

For example, second angle measurer 212 of qth radar section 10 described above performs the angle measurement processing of the near target object in the BMS configuration by extracting the output of second DA section 209 based on f_{bp}^{mul}(q) and DDM-signal demultiplexing index information f_{Tx}(qe), and generating qth reception array correlation matrix H_{q}(f_{bp}^{mul}(q), f_{Tx}(qe)) of second angle measurer 212 as given by Expression 17. Here, the element in zth row and ndmth column in qth reception array correlation matrix H_{q}(f_{bp}^{mul}(q), f_{Tx}(qe)) corresponds to a reception signal of reception antenna Rx(q) #z for transmission antenna Tx(qe) #ndm (the same applies to MIMO antenna arrangement B and MIMO antenna arrangement C to be described later). Further, second angle measurer 212 performs the angle measurement processing in the direction of departure (DOD) with a vector generated based on the transmission antenna arrangement in qeth radar section 10 (for example, the arrangement of the transmission antennas in FIG. 7) as transmission array direction vector a_{Tx(qe)}(θᵤ). Further, second angle measurer 212 performs the angle measurement processing in the direction of arrival (DOA) with a vector generated based on the reception antenna arrangement in qth radar section 10 (for example, the arrangement of reception antennas in FIG. 7) as reception array direction vector a_{Rx(q)}(θᵤ).

Further, in the angle measurement processing for the near target object in the BMS configuration, the reception signal from bth virtual antenna VA_{BM} #b corresponds to the bth element of virtual reception array correlation vector h_{q}^{BMS}(f_{bp}^{mono}, f_{Tx}(q)) in the BMS configuration (the same applies to MIMO antenna arrangement B and MIMO antenna arrangement C to be described later). Further, second angle measurer 212 performs the angle measurement processing using a direction vector generated based on the arrangement of the MIMO virtual reception antennas illustrated in part (b) in FIG. 8 as a direction vector of the qth virtual reception antenna in the BMS configuration.

### [MIMO Antenna Arrangement B]

In MIMO antenna arrangement B, number Nt(q) of transmission antennas ≥3 and number Na(q) of reception antennas ≥3 in first radar section 10 and second radar section 10. The MIMO antenna arrangements in first radar section 10 and second radar section 10 satisfy, for example, following arrangement conditions B.

### <Arrangement Condition B>

An arrangement that satisfies arrangement condition B is an arrangement in which number Nt(q) of transmission antennas ≥3 and number Na(q) of reception antennas ≥3 and which satisfies the following conditions.

### B-1)

Each of minimum antenna spacing MinAS(Tx(1)) for the antenna spacings between the plurality of transmission antennas 103 of first radar section 10 and minimum antenna spacing MinAS(Rx(2)) for the antenna spacings between the plurality of reception antennas 202 of second radar section 10 includes spacing Da, which is equal to or larger than 0.5 wavelengths and is smaller than 1 wavelength. For example, MinAS(Tx(1))<λ and MinAS(Rx(2))<λ.

Further, each of minimum antenna spacing MinAS(Rx(1)) for the antenna spacings between the plurality of reception antennas 202 of first radar section 10 and minimum antenna spacing MinAS(Tx(2)) for the antenna spacings between the plurality of transmission antennas 103 of second radar section 10 includes spacing Da that is 0.5 wavelengths or more and less than 1 wavelength. For example, MinAS(Rx(1))<λ and MinAS(Tx(2))<λ.

### B-2)

The reception antenna spacing of each radar section 10 includes a spacing wider than aperture length ApTx(1) of the transmission antennas, or the transmission antenna spacing of each radar section 10 includes a spacing wider than aperture length ApRx(2) of the reception antennas.

Here, arrangement condition B-1 has a grating suppression effect at the time of the near target object positioning in the angle measurement in a BMS configuration. For example, radar apparatus 1 is capable of positioning DOD and DOA without a grating. Further, radar apparatus 1 can determine that the reflected wave signal is a target object indirect wave in a case where the target object distance is satisfied and the intersection of two straight lines based on DOD and DOA is not present on an ellipse having the transmission antenna positions of first radar section 10 and second radar section 10 (for example, the transmission antenna positions of first transmission antennas Tx(1) #1 and Tx(2) #1) as foci, and thus prevent an erroneous positioning result from being outputted, the target object indirect wave can be removed.

Note that, arrangement condition B-1 is a condition (or a condition in which the BMS configuration is a symmetrical configuration) that can be satisfied even in a case where the MIMO antenna arrangements in first radar section 10 and second radar section 10 are the same arrangements. For example, in a case where the number of transmission antennas and the number of reception antennas are three or more, the effect of increasing the antenna aperture length can be obtained, and the target object angle measurement accuracy and the angle measurement resolution at the time of the near target object positioning in a BMS configuration can be improved. Further, by making the MIMO antenna arrangements in first radar section 10 and second radar section 10 the same as each other, it is possible to achieve an effect of reducing the radar manufacturing cost.

Further, by adding arrangement condition B-2 in addition to arrangement condition B-1, it is possible to increase the aperture length of a virtual reception array in the MNS configuration and to improve the target object angle measurement accuracy and the angle measurement resolution in the MNS configuration. For example, in arrangement condition B-2, the antenna spacing between the plurality of reception antennas 202 of first radar section 10 may include a spacing wider than the aperture length of the plurality of transmission antennas 103 of first radar section 10, or the antenna spacing between the plurality of transmission antennas 103 of second radar section 10 may include a spacing wider than the aperture length of the plurality of reception antennas 202 of second radar section 10. Thus, it is possible to increase the aperture length of the MIMO virtual antenna at the time of near target object positioning in the MNS configuration, and possible to improve the target object angle measurement accuracy and the angle measurement resolution.

Further, arrangement condition B-2 has an effect of increasing the aperture length of a virtual reception array at the time of distant target object positioning in the angle measurement in a BMS configuration. Thus, it is possible to improve the target object angle measurement accuracy and the angle measurement resolution in distant target object positioning in a BMS configuration. For example, in arrangement condition B-2, the antenna spacing between a plurality of reception antennas 202 of second radar section 10 may include a spacing wider than the aperture length of a plurality of transmission antennas 103 of first radar section 10, or the antenna spacing between a plurality of transmission antennas 103 of first radar section 10 may include a spacing wider than the aperture length of a plurality of reception antennas 202 of second radar section 10. Thus, it is possible to increase the aperture length of the MIMO virtual antenna at the time of near target object positioning in the BMS configuration, and possible to improve the target object angle measurement accuracy and the angle measurement resolution.

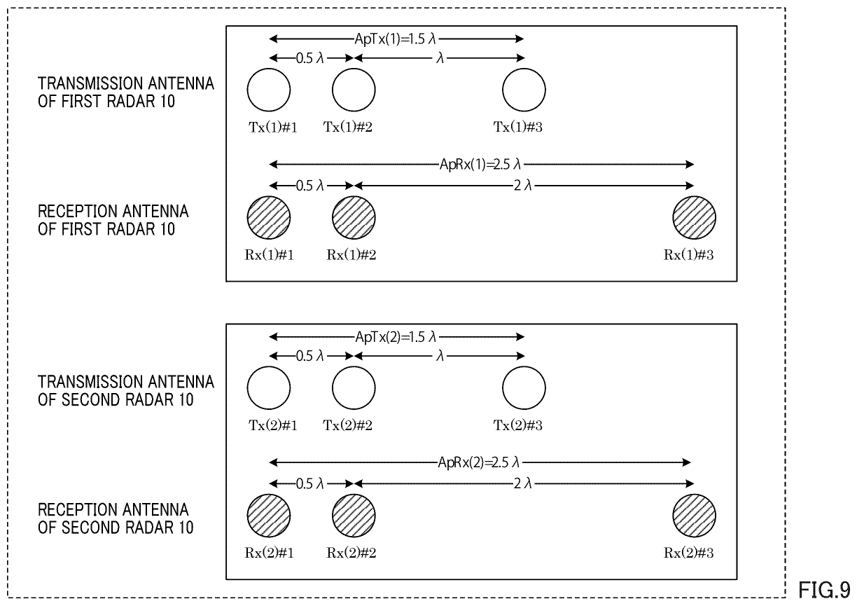

Hereinafter, FIG. 9 illustrates an arrangement example in a case where number Nt(1)=Nt(2)=3 of transmission antennas and number Na(1)=Na(2)=3 of reception antennas as an example of the MIMO antenna arrangements in first radar section 10 and second radar section 10 that satisfy arrangement condition B.

In FIG. 9, minimum antenna spacing MinAS(Tx(1)) of the transmission antennas of first radar section 10 is the spacing between Tx(1) #1 and Tx(1) #2, and is 0.5 wavelengths (=0.5λ). Further, in FIG. 9, minimum antenna spacing MinAS(Rx(2)) of the reception antennas of second radar section 10 is the spacing between Rx(2) #1 and Rx(2) #2, and is 0.5 wavelengths (=0.5λ). Thus, MinAS(Tx(1))<λ, and MinAS(Rx(2))<λ are satisfied. Further, in FIG. 9, minimum antenna spacing MinAS(Rx(1)) for the reception antenna of first radar section 10 is the spacing between Rx(1) #1 and Rx(1) #2, for example, and is 0.5 wavelengths (0.5λ). Further, in FIG. 9, minimum antenna spacing MinAS(Tx(2)) for the transmission antenna of second radar section 10 is the spacing between Tx(2) #1 and Tx(2) #2, and is 0.5 wavelengths (0.5λ). Thus, MinAS(Rx(1))<λ, and MinAS(Tx(2))<λ. Thus, the MIMO antenna arrangement illustrated in FIG. 9 satisfies arrangement condition B-1.

Further, the reception antenna spacings of first radar section 10 include a spacing wider than aperture length ApTx(1)(=1.5λ) of the transmission antennas of first radar section 10 (for example, a spacing of 2λ between Rx(1) #2 and Rx(1) #3), and the reception antenna spacings of second radar section 10 include a spacing wider than aperture length ApTx(2)(=1.5λ) of the transmission antennas of second radar section 10 (a spacing of 2λ between Rx(2) #2 and Rx(2) #3). Thus, the MIMO antenna arrangement illustrated in FIG. 9 satisfies arrangement condition B-2.

The MIMO antenna arrangement illustrated in FIG. 9 is an arrangement that satisfies arrangement conditions B.

For example, the arrangement of VA_{MN(1)} #1 to VA_{MN(1)} #9 and VA_{MN(2)} #1 to VA_{MN(2)} #9 of virtual reception antennas (or, MIMO virtual antennas) in the MNS configuration are configured from the MIMO antenna arrangements in first radar section 10 and second radar section 10.

Further, the arrangement of VA_{BM(q)} #1 to VA_{BM(q)} #9 of virtual reception antennas (or, MIMO virtual antennas) for the distant target object in the BMS configuration in qth radar section 10 are configured. q=1, 2.

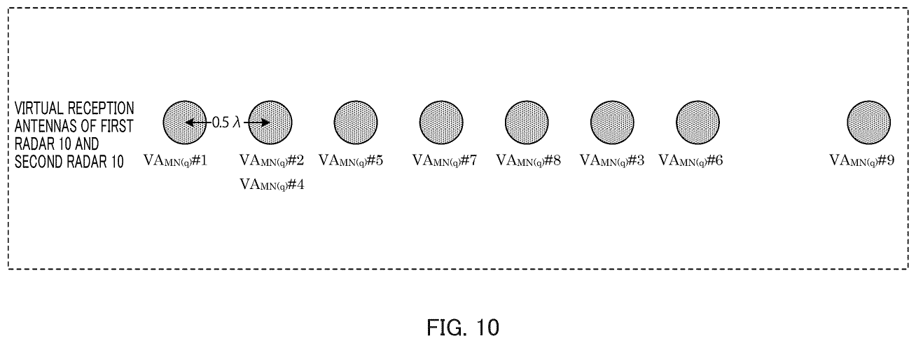

The arrangement of virtual reception antennas in the MNS configuration and BMS configuration constituted by the MIMO antenna arrangement illustrated in FIG. 9 is the same, for example, and is the arrangement illustrated in FIG. 10.

For example, first angle measurer 212 of qth radar section 10 described above performs the angle measurement processing using a direction vector generated based on the arrangement of the MIMO virtual reception antennas illustrated in FIG. 10 as a direction vector of the qth virtual reception antenna in the MNS configuration.

For example, second angle measurer 212 of above-described qth radar section 10 performs the angle measurement processing in the direction of departure (DOD) using a vector generated based on the transmission antenna arrangement in geth radar section 10 (for example, the arrangement of the transmission antennas in FIG. 9) as transmission array direction vector a_{Tx(qe)}(θᵤ). Further, second angle measurer 212 performs the angle measurement processing in the direction of arrival (DOA) using a vector generated based on the reception antenna arrangement in qth radar section 10 (for example, the arrangement of reception antenna in FIG. 9) as reception array direction vector a_{Rx(q)}(θᵤ).

Further, second angle measurer 212 performs the angle measurement processing using the direction vector generated based on the arrangement of the MIMO virtual reception antennas in FIG. 10 as a direction vector of the qth virtual reception antenna in the BMS configuration.

### [MIMO Antenna Arrangement C]

The MIMO antenna arrangements in first radar section 10 and second radar section 10 each satisfy, for example, following arrangement conditions C.

### <Arrangement Condition C>

### C-1)

Minimum antenna spacing MinAS(Tx(1)) for the antenna spacings between the plurality of transmission antennas 103 of first radar section 10 and minimum antenna spacing MinAS(Rx(2)) for the antenna spacings between the plurality of reception antennas 202 of second radar section 10 are equal to or larger than 1 wavelength and are different from each other (do not have a relationship of being integer multiples). For example, MinAS(Tx(1))≥λ, MinAS(Rx(2))≥λ, and MinAS(Tx(1))≠MinAS(Rx(2)).

Further, minimum antenna spacing MinAS(Rx(1)) for the antenna spacings between a plurality of reception antennas 202 of first radar section 10 and minimum antenna spacing MinAS(Tx(2)) for the antenna spacings between a plurality of transmission antennas 103 of second radar section 10 are larger than or equal to 1 wavelength, are different from each other (do not have a relationship of being integer multiples), and at least one of the minimum antenna spacing of the transmission antennas or the minimum antenna spacing of the reception antenna between radar sections 10 is different. For example, MinAS(Rx(1))≥λ and MinAS(Tx(2))≥λ, and at least one of MinAS(Rx(1))≠MinAS(Rx(2)) and MinAS(Tx(1))≠MinAS(Tx(2)) is satisfied.

### C-2)

The transmission antenna spacing and the reception antenna spacing of first radar section 10 include spacings providing absolute value SD_{MN1} of a difference between the transmission antenna spacing and the reception antenna spacing of first radar section 10 being equal to or larger than 0.5 wavelengths and equal to or smaller than 0.8 wavelengths, and the transmission antenna spacing and the reception antenna spacing of second radar section 10 include spacings providing absolute value SD_{MN2} of a difference between the transmission antenna spacing and the reception antenna spacing of second radar section 10 being equal to or larger than 0.5 wavelengths and equal to or smaller than 0.8 wavelengths.

### C-3)

The transmission antenna spacing of first radar section 10 and the reception antenna spacing of second radar section 10 include spacings providing absolute value SD_{BM12} of the difference between the transmission antenna spacing of first radar section 10 and the reception antenna spacing of second radar section 10 being equal to or larger than 0.5 wavelengths and equal to or smaller than 0.8 wavelengths, and the transmission antenna spacing of second radar section 10 and the reception antenna spacing of first radar section 10 include spacings providing absolute value SD_{BM21} of the difference between the transmission antenna spacing of second radar section 10 and the reception antenna spacing of first radar section 10 being equal to or larger than 0.5 wavelengths and equal to or smaller than 0.8 wavelengths.

Here, in the angle measurement in the BMS configuration, at the time of the near target object positioning, radar apparatus 1 performs determination by selecting, from among combinations of peak directions (for example, peak directions including a grating) in DOD/DOA, DOD/DOA that is on the ellipse (for example, an ellipse having transmission antenna positions of first transmission antennas Tx(1) #1 and Tx(2) #1 as foci) that satisfies the target object distance. In this case, for example, the DOD or DOA of the target object indirect wave may match the grating direction defined by the transmission antenna spacing of first radar section 10 or the reception antenna spacing of second radar section 10. Even in this case, arrangement condition C-1 is satisfied and the transmission antenna spacing of second radar section 10 or the reception antenna spacing of first radar section 10 is a spacing different from the transmission antenna spacing in first radar section 10 and the reception antenna spacing in second radar section 10, and thus the DOD or the DOA of the target object indirect wave no longer matches the grating direction of the transmission antenna spacing of second radar section 10 or the reception antenna spacing of first radar section 10. Accordingly, in the case of the near target object positioning in a BMS configuration in first radar section 10 or second radar section 10, the detection and removal of the target object indirect wave become possible in subsequent integrator 30.

For example, integrator 30 determines, based on a comparison between a positioning result (for example, DOD and DOA) using a reflected wave signal (for example, first reflected wave signal) corresponding to a transmission signal transmitted from second radar section 10 and received in first radar section 10 and a positioning result (for example, DOD and DOA) using a reflected wave signal (for example, second reflected wave signal) corresponding to a transmission signal transmitted from first radar section 10 and received in second radar section 10, whether the first reflected wave signal and the second reflected wave signal are a direct wave from a target object or not (or the first reflected wave signal and the second reflected wave signal are any one of the target object direct wave and target object indirect wave or not). As described above, the antenna arrangement between first radar section 10 and second radar section 10 is asymmetric, so that the grating direction with respect to the transmission signals from first radar section 10 to second radar section 10, which constitute BMS, and the grating direction with respect to the transmission signals from second radar section 10 to first radar section 10, which constitute BMS, are different from each other. Accordingly, radar apparatus 1 makes it possible to detect and remove the target object indirect waves based on the comparison of the positioning results in each BMS configuration.

Note that, arrangement condition C-1 is a condition (or a condition in which the BMS configuration is asymmetric) in which the MIMO antenna arrangements in first radar section 10 and second radar section 10 are not the same arrangement. For example, in a case where the number of transmission antennas and the number of reception antennas are relatively small (for example, in a case where the numbers are equal to or less than a threshold), the degree of freedom in antenna arrangement between radars can be increased in a BMS configuration. Thus, it is possible to further increase the antenna aperture length and possible to improve the target object angle measurement accuracy and the angle measurement resolution in a near target object positioning in a BMS configuration as compared to a case where the MIMO antenna arrangements in first radar section 10 and second radar section 10 are the same arrangement.

Further, by satisfying arrangement condition C-2, the virtual reception antenna spacing includes the absolute value of the difference between the transmission antenna spacing and the reception antenna spacing, and thus, the virtual reception antenna spacing includes a spacing between 0.5 and 0.8 wavelengths as given by Expression 23, and thus, it is possible to increase the aperture length of the virtual reception array in the MNS configuration, to suppress the grating lobe, and to improve the target object angle measurement accuracy and the angle measurement resolution in the MNS configuration.

Further, in the same manner, by satisfying arrangement condition C-3, the virtual reception antenna spacing in the case of the distant target object measurement in the BMS configuration includes a spacing between 0.5 and 0.8 wavelengths as given by Expression 24, and thus, it is possible to increase the aperture length of the virtual reception array in the BMS configuration while also making it possible to suppress the generation of grating lobes, and it is possible to improve the target object angle measurement accuracy and the angle measurement resolution in the BMS configuration.

Note that, SD_{MN1}, SD_{MN2}, SD_{BM12}, and SD_{BM21} may be configured, for example, according to the viewing angle of radar apparatus 1, and can suppress grating lobes within the viewing angle. For example, in a case where the transmission/reception antennas are disposed in the horizontal direction and the viewing angle in the horizontal direction is a wide viewing angle of approximately a range of ±70 degrees to ±90 degrees, each of SD_{MN1}, SD_{MN2}, SD_{BM12}, and SD_{BM21} may be set to approximately 0.5λ. Alternatively, in a case where the viewing angle in the horizontal direction is a narrow viewing angle approximately in a range of ±20 degrees to ±40 degrees, each of SD_{MN1}, SD_{MN2}, SD_{BM12}, and SD_{BM21} may be set to, for example, 0.7λ as a wider spacing. Here, λ represents the wavelength of the carrier frequency of the radar transmission signal. For example, when a chirp signal is used as the radar transmission signal, λ is the wavelength of the center frequency in the frequency sweeping band of the chirp signal.

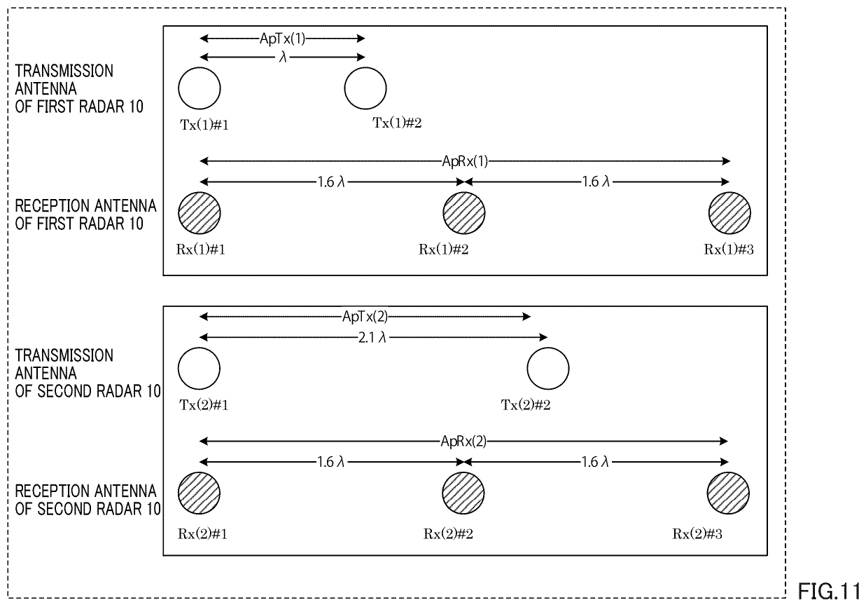

Hereinafter, FIG. 11 illustrates an arrangement example in the case of number Nt(1)=Nt(2)=2 of the transmission antennas and number Na(1)=Na(2)=3 of the reception antennas as an example of MIMO antenna arrangement in first radar section 10 and second radar section 10 that satisfy arrangement condition C.

In FIG. 11, minimum antenna spacings MinAS(Tx(1))=λ and MinAS(Rx(1))=1.6λ for the transmission/reception antennas of first radar section 10, and minimum antenna spacings MinAS(Tx(2))=2.1λ and MinAS(Rx(2))=1.6λ for the transmission/reception antennas of second radar section 10. Thus, MinAS(Tx(1))≠MinAS(Tx(2)) satisfies arrangement condition C-1.

Further, absolute value SD_{MN1} of the difference between the transmission antenna spacing and the reception antenna spacing in first radar section 10 is 0.6λ, absolute value SD_{MN2} of the difference between the transmission antenna spacing and the reception antenna spacing in second radar section 10 is 0.5λ, and the spacings providing the difference values being equal to or larger than 0.5 wavelengths and being equal to or smaller than 0.8 wavelengths are included, and thus arrangement condition C-2 is satisfied.

Further, absolute value SD_{BM12} of the difference between the transmission antenna spacing of first radar section 10 and the reception antenna spacing of second radar section 10 is 0.6λ, absolute value SD_{BM21} of the difference between the transmission antenna spacing of second radar section 10 and the reception antenna spacing of first radar section 10 is 0.5λ, and the spacings providing the difference values being 0.5 or more and 0.8 wavelengths or less are included, and accordingly, arrangement condition C-3 is satisfied.

The MIMO antenna arrangement illustrated in FIG. 11 is an arrangement that satisfies arrangement condition C.

For example, the arrangement of VA_{MN(q)} #1 to VA_{MN(q)} #6 of virtual reception antennas (or, MIMO virtual antennas) in the MNS configuration are configured from the MIMO antenna arrangements in first radar section 10 and second radar section 10.

Further, the arrangement of VA_{BM(q)} #1 to VA_{BM(q)} #6 of virtual reception antennas (or, MIMO virtual antennas) for the distant target object in the BMS configuration in qth radar section 10 are configured. q=1 or 2.

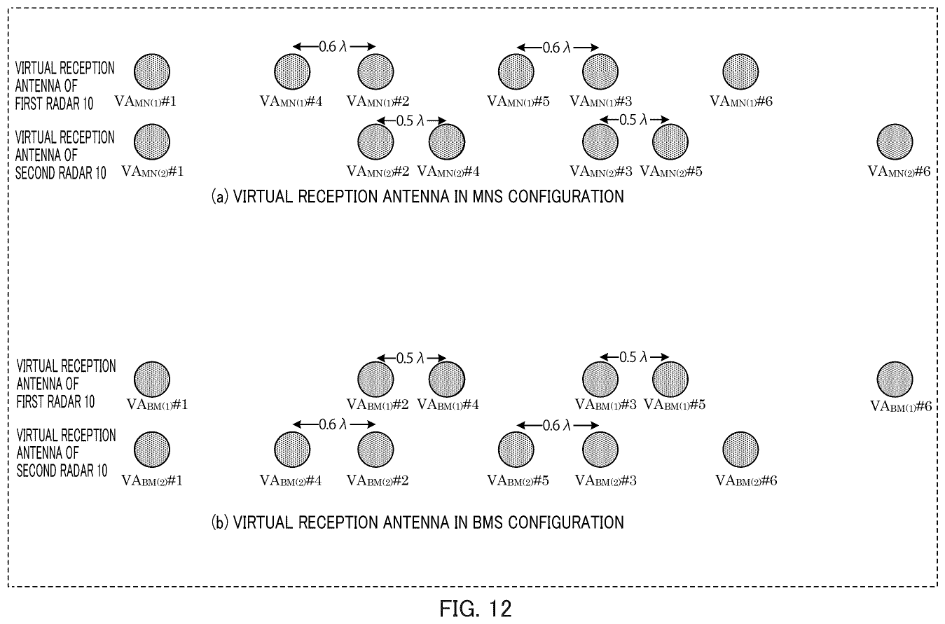

Part (a) in FIG. 12 and part (b) in FIG. 12 illustrate an arrangement example of a virtual reception antenna in the MNS configuration and the BMS configuration configured by the MIMO antenna arrangement in FIG. 11.

For example, first angle measurer 212 of qth radar section 10 described above performs the angle measurement processing using, as the direction vector of the qth virtual reception antenna in the MNS configuration, a direction vector generated based on the arrangement of the MIMO virtual reception antenna illustrated in part (a) in FIG. 12, for example.

For example, second angle measurer 212 of above-described qth radar section 10 performs the angle measurement processing in the direction of departure (DOD) using the vector generated based on the transmission antenna arrangement in geth radar section 10 (for example, the arrangement of the transmission antennas in FIG. 11) as transmission array direction vector a_{Tx(qe)}(θᵤ). Further, second angle measurer 212 performs the angle measurement processing in the direction of arrival (DOA) using a vector generated based on the reception antenna arrangement in qth radar section 10 (for example, the arrangement of reception antenna in FIG. 11) as reception array direction vector a_{Rx(q)}(θᵤ).

Further, second angle measurer 212 can perform the angle measurement processing using a direction vector generated based on the arrangement of the MIMO virtual reception antennas illustrated in part (b) in FIG. 12 as a direction vector of qth virtual reception antenna in the BMS configuration.

Hereinabove, arrangement examples of MIMO antennas have been described.

As described above, in the present embodiment, radar apparatus 1 makes it possible to remove a target object indirect wave in a near target object in a BMS configuration, and also makes it possible to improve the angle measurement performance in MNS configuration and BMS configuration. Therefore, according to the present embodiment, the target object can be efficiently detected in radar apparatus 1.

### (Variation 1)

The MIMO antenna arrangement may be an arrangement to which, in above-described arrangement condition A, condition A-4 described below is further added.

### A-4)

The antenna spacings between the plurality of transmission antennas 103 of second radar section 10 and the antenna spacings between the plurality of reception antennas 202 of first radar section 10 include spacings providing absolute value SD_{BM21} of the difference between the transmission antenna spacing of second radar section 10 and the reception antenna spacing of first radar section 10 being equal to or larger than 0.5 wavelengths and equal to or smaller than 0.8 wavelengths.

By satisfying arrangement condition A-4, the virtual reception antenna spacing in the case of the distant target object measurement in the BMS configuration includes a spacing between 0.5 and 0.8 wavelengths as given by Expression 24, and thus, it is possible to increase the aperture length of the virtual reception array in the BMS configuration and to suppress the grating lobe, and further, it is possible to improve the target object angle measurement accuracy and the angle measurement resolution in the BMS configuration.

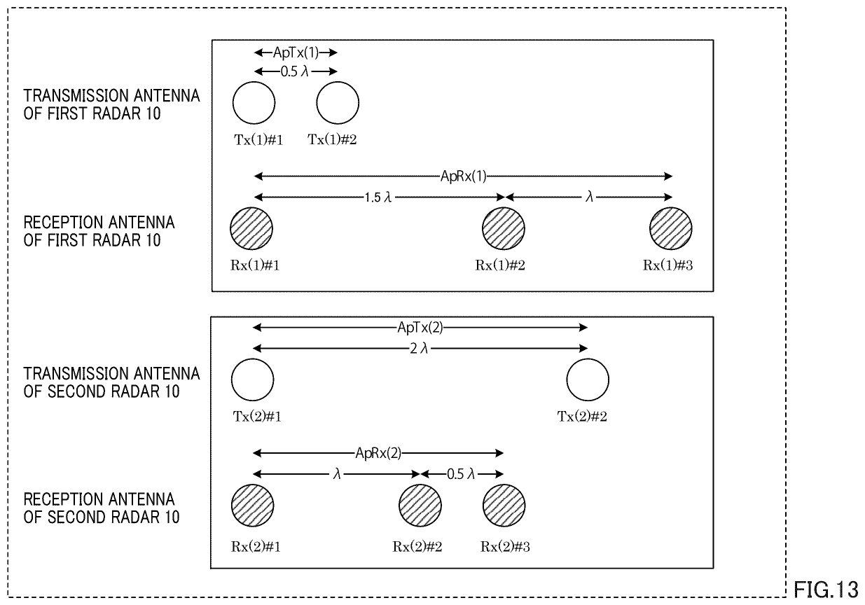

Hereinafter, FIG. 13 illustrates an arrangement example in the case of number Nt(1)=Nt(2)=2 of the transmission antennas and number Na(1)=Na(2)=3 of the reception antennas as an example of MIMO antenna arrangement in first radar section 10 and second radar section 10 that satisfy arrangement conditions A-1 to A-4.

FIG. 13 is an arrangement similar to the configuration of the MIMO antenna arrangement example illustrated in FIG. 7, but in which the spacing between reception antennas Rx(1) #1 and Rx(1) #2 of first radar section 10 is changed from λ to 1.5λ, and is the same arrangement as that in FIG. 7 in other respects. The MIMO antenna arrangement illustrated in FIG. 13 is an arrangement that satisfies arrangement conditions A-1, A-2, and A-3 in the same manner as in FIG. 7. Further, as illustrated in FIG. 13, the spacing between Rx(1) #1 and Rx(1) #2 is 1.5λ, and the spacing between Tx(2) #1 and Tx(2) #2 is 2λ, and thus, absolute value SD_{BM21} of the difference between these spacings is 0.5 wavelengths, and the arrangement is an arrangement that satisfies arrangement condition A-4.

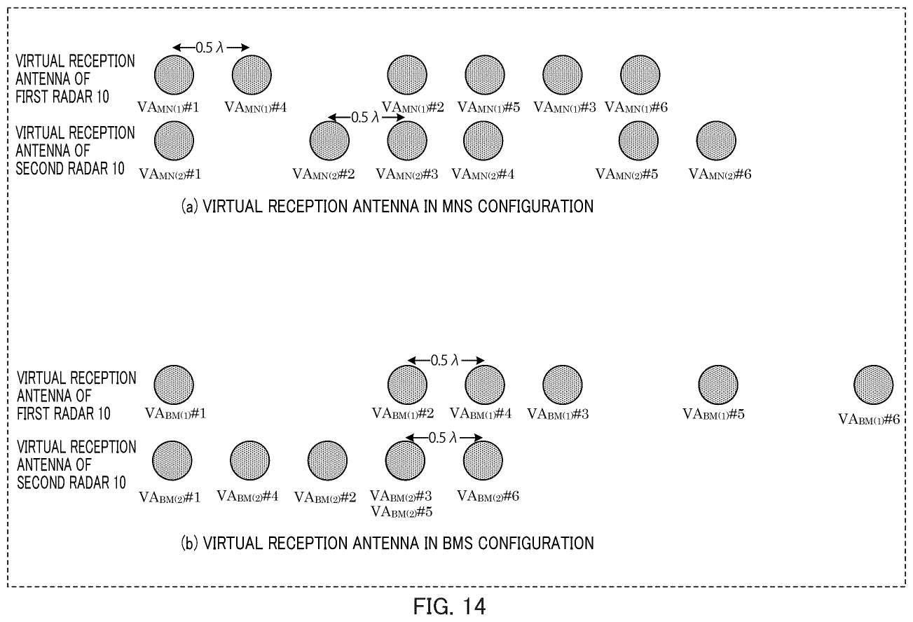

Part (a) in FIG. 14 and part (b) in FIG. 14 illustrate an arrangement example of virtual reception antennas in MNS configuration and BMS configuration in each radar section 10 configured with the MIMO antenna arrangement illustrated in FIG. 13.

For example, from the MIMO antenna arrangements in first radar section 10 and second radar section 10 illustrated in FIG. 13, the arrangement of VA_{MN(1)} #1 to VA_{MN(1)} #6 and VA_{MN(2)} #1 to VA_{MN(2)} #6 of virtual reception antennas (or, MIMO virtual antennas) in the MNS configuration as illustrated in part (a) in FIG. 14 are configured.

Further, as illustrated in part (b) in FIG. 14, the arrangement of VA_{BM(q)} #1 to VA_{BM(q)} #6 of virtual reception antennas (or, MIMO virtual antennas) for the distant target object in the BMS configuration are configured. q=1, 2.

For example, in the arrangement of VA_{BM(1)} #1 to VA_{BM(1)} #6 of the virtual reception antennas for the distant target object in the BMS configuration in first radar section 10 illustrated in part (b) in FIG. 8, the spacings are not narrower than 1 wavelength, and are spacings making it difficult to suppress grating lobes. In contrast, in the MIMO antenna arrangement illustrated in FIG. 13 that satisfies arrangement condition A-4, the arrangement of VA_{BM(1)} #1 to VA_{BM(1)} #6 of the virtual reception antennas for the distant target object in BMS configuration in first radar section 10 shown in part (b) in FIG. 14 includes a spacing of 0.5 wavelengths, which is narrower than 1 wavelength, and the aperture of the virtual reception antennas is expanded from 4λ in part (b) in FIG. 8 to 4.5λ. By thus satisfying arrangement condition A-4, it is possible to increase the aperture length of the virtual reception array in the BMS configuration, to also suppress grating lobes, and to improve the target object angle measurement accuracy and the angle measurement resolution in the BMS configuration.

### (Variation 2)

The MIMO antenna arrangement may be an arrangement to which, in arrangement condition B described above, further condition B-3 described below may be added.

### B-3)

The transmission antenna spacing of second radar section 10 and the reception antenna spacing of first radar section 10 include spacings providing absolute value SD_{BM21} of the difference between the transmission antenna spacing of second radar section 10 and the reception antenna spacing of first radar section 10 ranging between 0.5 and 0.8 wavelengths.

By satisfying arrangement condition B-3, the virtual reception antenna spacing in the case of the distant target object measurement in the BMS configuration includes a spacing between 0.5 and 0.8 wavelengths as given by Expression 24, and thus, it is possible to increase the aperture length of the virtual reception array in the BMS configuration and to suppress the generation of a grating lobe, and further, it is possible to improve the target object angle measurement accuracy and the angle measurement resolution in the BMS configuration.

### (Variation 3)

In the above-described arrangement examples that satisfy arrangement conditions A, B, and C, arrangements in the one-dimensional direction (for example, the horizontal direction) are illustrated, and an example in which angle measurement in the azimuth direction is performed in angle measurer 212 is described, but the present disclosure is not limited thereto.

For example, each arrangement example may be an arrangement in the vertical direction, and in this case, angle measurement in the elevation angle direction is possible in angle measurer 212.

Further, for example, in addition to a two-dimensional arrangement condition (Ya, Yb, or Yc) described below, in each of arrangement conditions A, B, and C, MIMO antennas may be disposed two-dimensionally (for example, in a horizontal direction and a vertical direction). A two-dimensional MIMO antenna arrangement makes it possible to perform angle measurement in, for example, the azimuth direction and further in the elevation angle direction in angle measurer 212. Thus, radar apparatus 1 can detect the three-dimensional coordinates of a target object. Here, Y may be any of A, B, or C.

Further, for example, a MIMO antenna arrangement that satisfies the following two-dimensional arrangement condition (Ya, Yb, or Yc) along with arrangement condition X has the grating suppression effect in a direction different from (for example, direction orthogonal to) the arrangement direction that satisfies arrangement condition X, in the case of the near target object positioning in a BMS configuration, together with the effect obtained by the arrangement that satisfies arrangement condition X.

Note that, in the following arrangement conditions, each of X and Y may be any of arrangement conditions A, B, or C, and X and Y may be different combinations.

### <Two-Dimensional Arrangement Condition X-Ya>

In addition to one-dimensional direction (for example, the horizontal direction) that satisfies arrangement condition X, arrangement condition Y-1 is satisfied in an orthogonal direction (for example, the vertical direction).

### <Two-Dimensional Arrangement Condition X-Yb>

In addition to one-dimensional direction (for example, the horizontal direction) that satisfies arrangement condition X, arrangement conditions Y-1 and Y-2 are satisfied in an orthogonal direction (for example, the vertical direction).

### <Two-Dimensional Arrangement Condition X-Yc>

In addition to one-dimensional direction (for example, the horizontal direction) that satisfies arrangement condition X, arrangement conditions Y-1, Y-2, and Y-3 are satisfied in an orthogonal direction (for example, the vertical direction) (provided that, excluding a case where Y is satisfied with arrangement condition B).

For example, when the arrangement direction that satisfies arrangement condition X is the horizontal direction, the grating suppression effect is exhibited in the direction (for example, the direction orthogonal to the horizontal direction) of the MIMO antenna arrangement that satisfies the two-dimensional arrangement condition (Ya, Yb, or Yc).

Further, in a case where the target object distance is satisfied and the intersection of two straight lines based on two-dimensional DOD and two-dimensional DOA does not exist on an ellipse with the transmission antenna positions (for example, the transmission antenna positions of first transmission antennas Tx(1) #1 and Tx(2) #1) of first radar section 10 and second radar section 10 as foci, radar apparatus 1 can determine the corresponding reflected wave to be the target object indirect wave and does not output a wrong positioning result, and thus, it is possible to remove the target object indirect wave.

Further, the MIMO antenna arrangement that satisfies two-dimensional arrangement condition (Yb or Yc) along with arrangement condition X can not only obtain the effect obtained by the arrangement satisfying arrangement condition X, but also increase the aperture length of a virtual reception array in an MNS configuration in a direction (for example, an orthogonal direction) different from the arrangement direction that satisfies arrangement condition X and can improve the target object angle measurement accuracy and the angle measurement resolution in the MNS configuration. Further, for example, a MIMO antenna arrangement that satisfies a two-dimensional arrangement condition (Yc) also has an effect of increasing the aperture length of a virtual reception array at the time of distant target object positioning in angle measurement in a BMS configuration, and the target object angle measurement accuracy and the angle measurement resolution at the time of distant target object positioning in a BMS configuration can be improved.

Note that, the same applies even when first radar section 10 and second radar section 10 are replaced respectively with (exchanged with) second radar section 10 and first radar section 10 in each arrangement condition. Further, the same applies even when first radar section 10 and second radar section 10 in arrangement condition X are replaced respectively with (exchanged with) second radar section 10 and first radar section 10 in arrangement condition Y.

Hereinafter, a MIMO antenna arrangement example that satisfies the two-dimensional arrangement condition will be described.

For example, the arrangement of the virtual reception antennas in qth radar section 10 in the MNS configuration can be indicated using Expression 23 based on the positions of the transmission antennas (for example, the positions of feeding points) and the positions of the reception antennas (for example, the positions of feeding points) in the MNS configuration (not illustrated). Similarly, the arrangement of virtual reception antennas for the distant target object in the BMS configuration in qth radar section 10 can be represented using Expression 24 based on the positions of the transmission antennas (for example, the positions of the feeding points) and the positions of the reception antennas (for example, the positions of the feeding points) in the BMS configuration (not illustrated).

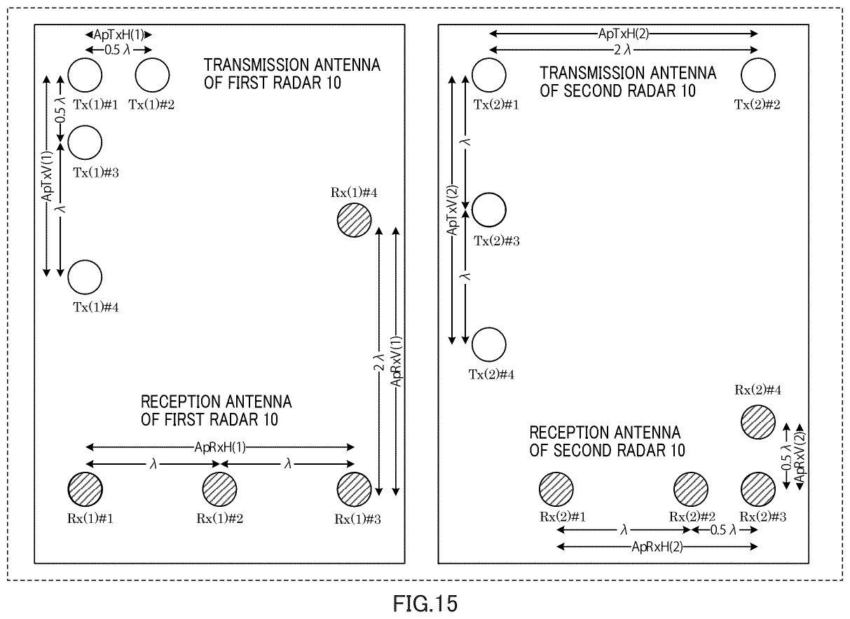

FIG. 15 illustrates an example of an arrangement in which MIMO antennas in first radar section 10 and second radar section 10 are added in the vertical direction (for example, the longitudinal direction in FIG. 15) to a MIMO antenna arrangement (for example, the arrangement illustrated in FIG. 7) that satisfies arrangement condition A in the horizontal direction (for example, the lateral direction in FIG. 15) to satisfy two-dimensional arrangement condition A-Ac. The example of FIG. 15 illustrates number Nt(1)=Nt(2)=4 of transmission antenna, and number Na(1)=Na(2)=4 of reception antennas.

Hereinafter, an arrangement portion added in the vertical direction in FIG. 15 will be described.

Minimum antenna spacing MinAS_{V}(Tx(1)) of the transmission antennas of first radar section 10 in the vertical direction is the spacing between Tx(1) #1 and Tx(1) #3 and is 0.5 wavelengths (=0.5λ=Da), and minimum antenna spacing MinAS_{V}(Rx(2)) of the reception antennas of second radar section 10 in the vertical direction is the spacing between Rx(2) #3 and Rx(2) #4 and is 0.5 wavelengths (=0.5λ=Da). Thus, MinAS_{V}(Tx(1))<λ and MinAS_{V}(Rx(2))<λ are satisfied.

Further, minimum antenna spacing MinAS_{V}(Rx(1)) of the reception antennas of first radar section 10 in the vertical direction is, for example, the spacing between Rx(1) #3 and Rx(1) #4 and is 2 wavelengths (2λ), and minimum antenna spacing MinAS_{V}(Tx(2)) of the transmission antennas of second radar section 10 in the vertical direction is, for example, the spacing between Tx(2) #1 and Tx(2) #3 and is 1 wavelength (λ). Thus, MinAS_{V}(Rx(1))>Da and MinAS_{V}(Tx(2))>Da.

Thus, the arrangement portion in the vertical direction in the MIMO antenna arrangement illustrated in FIG. 15 satisfies arrangement condition A-1.

Further, the reception antenna spacing of first radar section 10 in the vertical direction includes a spacing (for example, a spacing of 2λ between Rx(1) #3 and Rx(1) #4) wider than aperture length ApTxV(1)(=1.5λ) of the transmission antennas of first radar section 10 in the vertical direction. Further, the transmission antenna spacing of second radar section 10 in the vertical direction includes a spacing (for example, the spacing λ between Tx(2) #1 and Tx(2) #3) wider than aperture length ApRxV(2)(=0.5λ) of the reception antenna of second radar section 10 in the vertical direction. Thus, the arrangement portion in the vertical direction in the MIMO antenna arrangement illustrated in FIG. 15 satisfies arrangement condition A-2.

Further, the transmission antenna spacing of first radar section 10 in the vertical direction includes a spacing (a spacing λ between Tx(1) #3 and Tx(1) #4) wider than aperture length ApRxV(2)(=0.5λ) of the reception antenna of second radar section 10 in the vertical direction. Thus, the arrangement portion in the vertical direction in the MIMO antenna arrangement illustrated in FIG. 15 satisfies arrangement condition A-3.

The MIMO antenna arrangement illustrated in FIG. 15 satisfies two-dimensional arrangement condition A-Ac. Such an arrangement provides the effects described above.

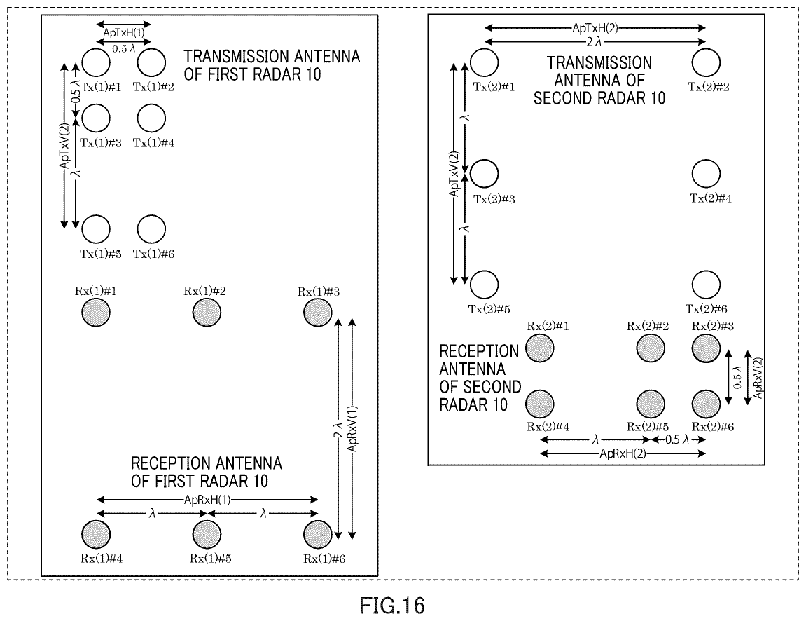

Note that, in FIG. 15, an arrangement example in which one column in the vertical direction satisfies two-dimensional arrangement condition A-Ac is illustrated, but the present disclosure is not limited thereto, and an arrangement in which a plurality of columns in the vertical direction satisfy two-dimensional arrangement condition A-Ac may be adopted, for example, as illustrated in FIG. 16.

Further, a non-limiting embodiment of the present disclosure is applicable not only to two-dimensional arrangement condition A-Ac illustrated in FIGS. 15 and 16, but also to other two-dimensional arrangement conditions.

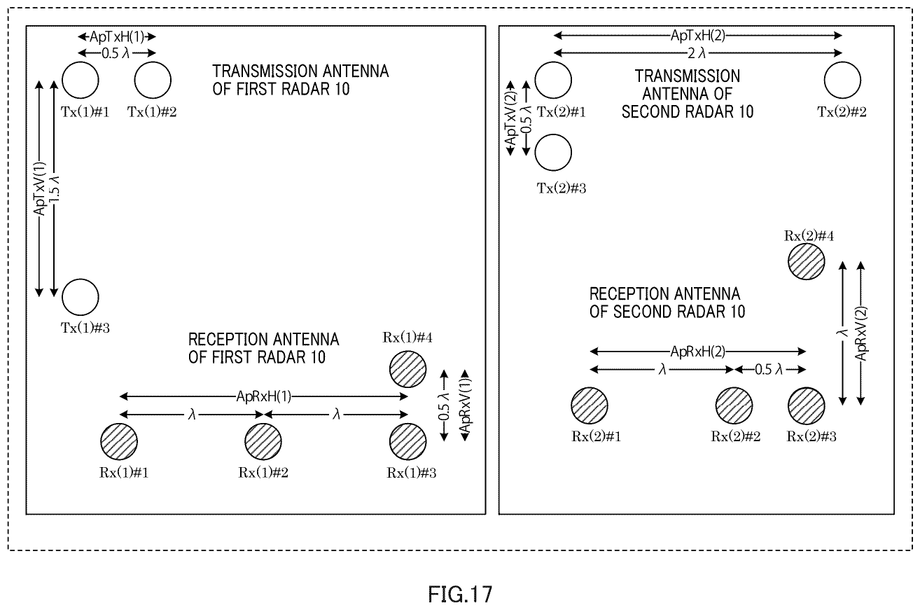

FIG. 17 illustrates an example of an arrangement in which a MIMO antenna arrangement (for example, the arrangement illustrated in FIG. 7) that satisfies arrangement condition A in the horizontal direction (for example, the lateral direction in FIG. 17) is provided with addition of MIMO antennas in first radar section 10 and second radar section 10 in the vertical direction (for example, the longitudinal direction in FIG. 17), to satisfy two-dimensional arrangement condition A-Ab. The example of FIG. 17 illustrates number Nt(1)=Nt(2)=3 of transmission antennas, and number Na(1)=Na(2)=4 of reception antennas.

Hereinafter, an arrangement portion added in the vertical direction in FIG. 17 will be described.

Minimum antenna spacing MinAS_{V}(Tx(2)) of the transmission antennas of second radar section 10 in the vertical direction is a spacing between Tx(2) #1 and Tx(2) #3 and is 0.5 wavelengths (=Da), and minimum antenna spacing MinAS_{V}(Rx(1)) of the reception antennas of first radar section 10 in the vertical direction is a spacing between Rx(1) #3 and Rx(2) #4 and is 0.5 wavelengths (=Da). Thus, MinAS_{V}(Tx(2))<λ and MinAS_{V}(Rx(1))<λ are satisfied.

Further, minimum antenna spacing MinAS_{V}(Rx(2)) of the reception antennas of second radar section 10 in the vertical direction is, for example, the spacing between Rx(2) #3 and Rx(2) #4 and is 1 wavelength (λ), and minimum antenna spacing MinAS_{V}(Tx(1)) of the reception antennas of first radar section 10 in the vertical direction is, for example, the spacing between Tx(1) #1 and Tx(1) #3 and is 1.5 wavelengths (1.5λ). Thus, MinAS_{V}(Rx(2))>Da and MinAS_{V}(Tx(1))>Da.

Thus, the arrangement portion in the vertical direction in the MIMO antenna arrangement illustrated in FIG. 17 satisfies arrangement condition A-1.

Further, the reception antenna spacing in second radar section 10 in the vertical direction includes a spacing (for example, a spacing λ between Rx(2) #3 and Rx(2) #4) wider than aperture length ApTxV(2)(=0.5λ) of the transmission antennas in second radar section 10 in the vertical direction, and the transmission antenna spacing in first radar section 10 in the vertical direction includes a spacing (a spacing 1.5λ between Tx(2) #1 and Tx(2) #3) wider than aperture length ApRxV(1)(=0.5λ) of the reception antenna in first radar section 10 in the vertical direction. Thus, the arrangement portion in the vertical direction in the MIMO antenna arrangement illustrated in FIG. 17 satisfies arrangement condition A-2.

Further, the transmission antenna spacing of second radar section 10 in the vertical direction does not include a spacing wider than aperture length ApRxV(1)(=0.5λ) of the reception antenna of first radar section 10 in the vertical direction. Further, the reception antenna spacing of first radar section 10 in the vertical direction does not include a spacing wider than aperture length ApTxV(2)(=0.5λ) of the transmission antennas of second radar section 10 in the vertical direction. Thus, the arrangement portion in the vertical direction in the MIMO antenna arrangement illustrated in FIG. 17 does not satisfy arrangement condition A-3.

The MIMO antenna arrangement illustrated in FIG. 17 satisfies two-dimensional arrangement condition A-Ab. Such an arrangement provides the effect in two-dimensional arrangement condition A-Ab described above.

Note that, in FIGS. 15 to 17, a case where the MIMO antennas added in the vertical direction with respect to the MIMO antenna arrangement illustrated in FIG. 7 are disposed such that the positions thereof are aligned in the horizontal direction (are arrayed in the vertical direction) has been described, but the present disclosure is not limited thereto, and the MIMO antennas may be disposed such that the positions thereof in the horizontal direction are different from each other (for example, in the obliquely upward direction, in the obliquely downward direction).

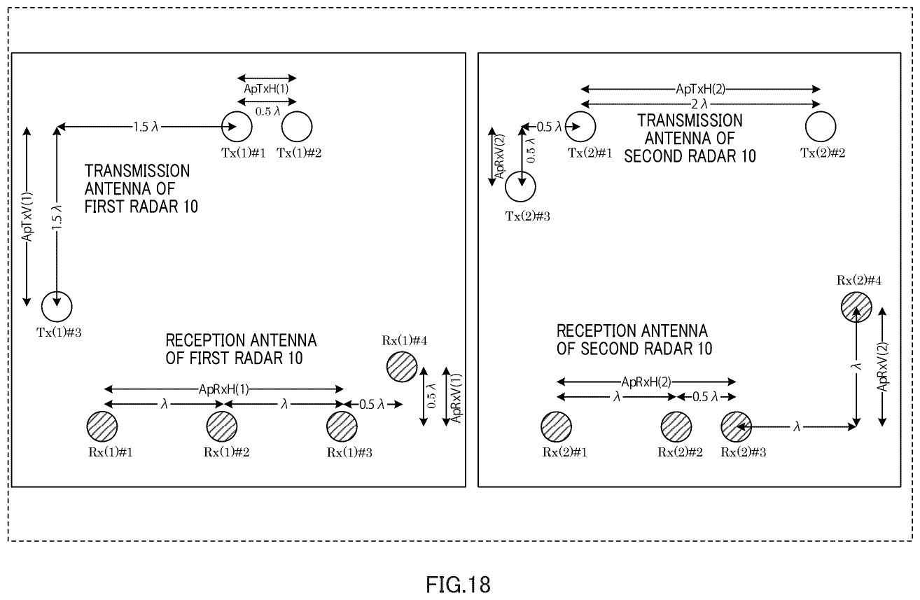

For example, FIG. 18 illustrates an example of arrangement in which the positions in the horizontal direction of MIMO antennas added in the vertical direction illustrated in FIG. 17 are offset to be different from each other. For example, Tx(1) #3 is disposed to be offset by 1.5λ from the position of Tx(1) #1 in the horizontal direction, and Rx(1) #4 is disposed to be offset by 0.52 from the position of Rx(1) #3 in the horizontal direction in FIG. 18. Further, Tx(2) #3 is disposed to be offset by 0.5λ with respect to the position of Tx(2) #1 in the horizontal direction, and Rx(2) #4 is disposed to be offset by λ with respect to the position of Rx(2) #3 in the horizontal direction.

Even in the MIMO antenna arrangement illustrated in FIG. 18, the arrangement relationship in the vertical direction is the same as that in FIG. 17, satisfies two-dimensional arrangement condition A-Ab, and achieves the effects described above. Note that, a non-limiting embodiment of the present disclosure is also applicable to other two-dimensional arrangement conditions.

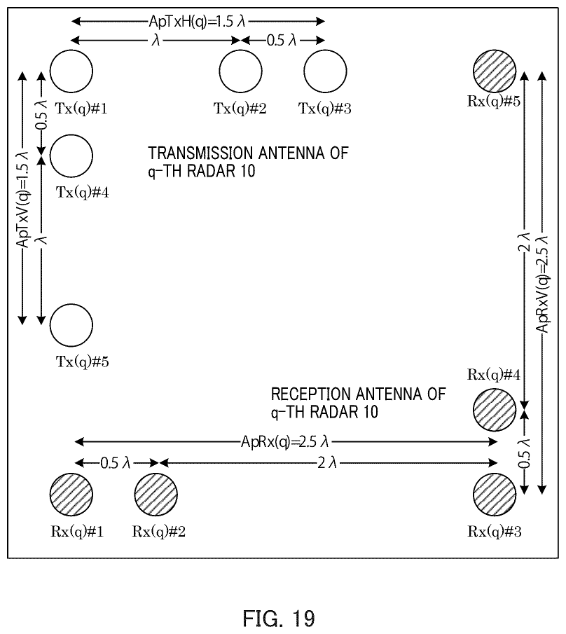

FIG. 19 illustrates an example of the arrangement in which the MIMO antenna arrangement illustrated in FIG. 9 that satisfies arrangement condition B is provided with addition of the MIMO antennas in qth radar section 10 in the vertical direction to satisfy two-dimensional arrangement conditions B-Bb. For example, FIG. 19 illustrates number Nt(1)=Nt(2)=5 of transmission antennas and number Na(1)=Na(2)=5 of reception antennas. Note that, the MIMO antenna arrangement in first radar section 10 and second radar section 10 is the same, and in FIG. 19, q=1 in the case of first radar section 10, and q=2 in the case of second radar section 10.

Hereinafter, an arrangement portion added in the vertical direction in FIG. 19 will be described.

In FIG. 19, minimum antenna spacing MinAS_{V}(Tx(1)) of the transmission antennas of first radar section 10 in the vertical direction is the spacing between Tx(1) #1 and Tx(1) #4 and is 0.5 wavelengths (=0.5λ), and minimum antenna spacing MinAS_{V}(Rx(2)) of the reception antennas of second radar section 10 in the vertical direction is the spacing between Rx(2) #3 and Rx(2) #4 and is 0.5 wavelengths (=0.5λ). Thus, MinAS_{V}(Tx(1)<λ, MinAS_{V}(Rx(2))<λ are satisfied.

Further, minimum antenna spacing MinAS_{V}(Rx(1)) of the reception antennas of first radar section 10 in the vertical direction is, for example, the spacing between Rx(1) #3 and Rx(1) #4 and is 0.5 wavelengths (0.5λ), and minimum antenna spacing MinAS_{V}(Tx(2)) of the transmission antennas of second radar section 10 in the vertical direction is, for example, the spacing between Tx(2) #1 and Tx(2) #4 and is 0.5 wavelengths (0.5λ). Thus, MinAS_{V}(Rx(1))<λ, and MinAS_{V}(Tx(2))<λ.

Thus, the arrangement portion in the vertical direction in the MIMO antenna arrangement illustrated in FIG. 19 satisfies arrangement condition B-1.

Further, the reception antenna spacing in qth radar section 10 in the vertical direction includes a spacing (for example, a spacing of 2λ between Rx(q) #4 and Rx(q) #5) wider than aperture length ApTxV(q)(=1.5λ) of the transmission antennas of qth radar section 10 (here, q is 0 and 1). Thus, the arrangement portion in the vertical direction in the MIMO antenna arrangement illustrated in FIG. 19 satisfies arrangement condition B-2.

Thus, the arrangement portion in the vertical direction in the MIMO antenna arrangement illustrated in FIG. 19 satisfies arrangement condition B. The MIMO antenna arrangement illustrated in FIG. 19 satisfies two-dimensional arrangement condition B-Bc. Such an arrangement provides the effect in two-dimensional arrangement condition B-Bc described above.

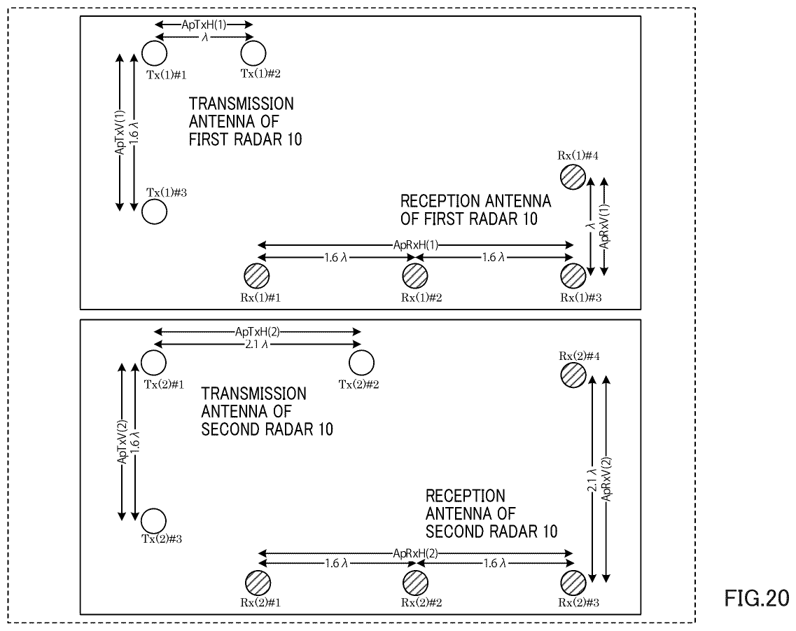

FIG. 20 illustrates an example of an arrangement in which the MIMO antenna arrangement illustrated in FIG. 11 that satisfies arrangement condition C is provided with addition of the MIMO antennas in qth radar section 10 in the vertical direction such that two-dimensional arrangement condition C-Cc is satisfied. For example, FIG. 20 illustrates number Nt(1)=Nt(2)=3 of transmission antennas and number Na(1)=Na(2)=4 of reception antennas.

Hereinafter, an arrangement portion added in the vertical direction in FIG. 20 will be described.

In FIG. 20, minimum antenna spacings MinAS_{V}(Tx(1))=1.6λ and MinAS_{V}(Rx(1))=λ in the vertical direction of the transmission/reception antennas of first radar section 10, and minimum antenna spacings MinAS_{V}(Tx(2))=1.6λ and MinAS_{V}(Rx(2))=2.1λ in the vertical direction of the transmission/reception antennas of second radar section 10. Thus, MinAS_{V}(Rx(1))≠MinAS_{V}(Rx(2)), and thus, arrangement condition C-1 is satisfied.

Further, in the transmission/reception antenna spacings of first radar section 10 and second radar section 10, absolute value SD_{MN1} of the difference between the transmission antenna spacing and the reception antenna spacing of first radar section 10 in the vertical direction is 0.6λ, absolute value of SD_{MN2} of the difference between the transmission antenna spacing and the reception antenna spacing of second radar section 10 in the vertical direction is 0.5λ, and the spacings providing the difference ranging from 0.5 to 0.8 wavelengths are included, and thus, arrangement condition C-2 is satisfied.

Further, absolute value SD_{BM12} of the difference between the transmission antenna spacing of first radar section 10 in the vertical direction and the reception antenna spacing of second radar section 10 in the vertical direction is 0.5λ, absolute value SD_{BM21} of the difference between the transmission antenna spacing of second radar section 10 in the vertical direction and the reception antenna spacing of first radar section 10 in the vertical direction is 0.6λ, and the spacings of from 0.5 to 0.8 wavelengths are included, and thus, arrangement condition C-3 is satisfied.

Thus, the arrangement portion in the vertical direction in the MIMO antenna arrangement illustrated in FIG. 20 satisfies arrangement condition C. The MIMO antenna arrangement illustrated in FIG. 20 satisfies two-dimensional arrangement condition C-Cc. Such an arrangement provides the effect in two-dimensional arrangement condition C-Cc described above.

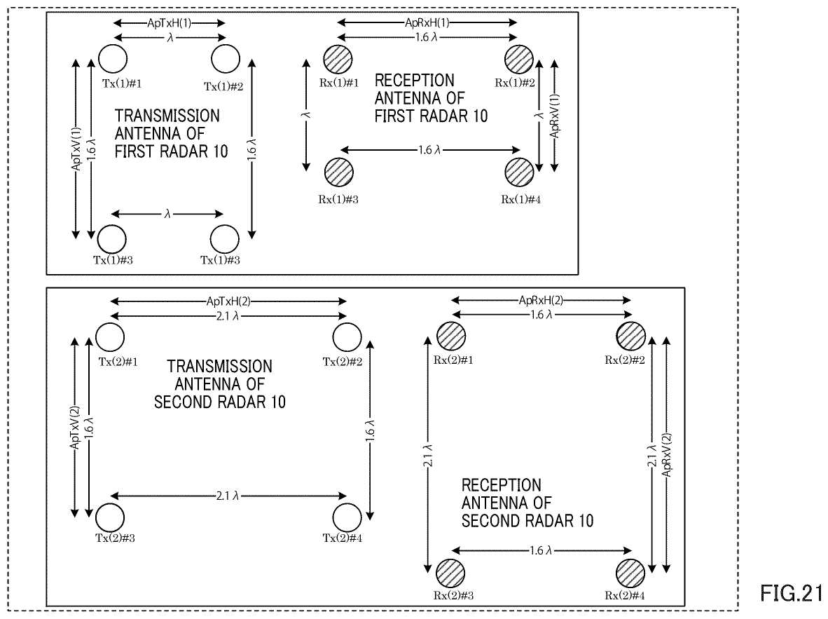

Note that, in FIG. 20, an arrangement example in which one column in the vertical direction satisfies two-dimensional arrangement condition C-Cc has been described, but the present disclosure is not limited thereto. For example, the arrangement in which two-dimensional arrangement condition C-Cc is satisfied in the plurality of columns in the vertical direction may be adopted as illustrated in FIG. 21.

Further, in FIGS. 20 and 21, an example in which MIMO antennas disposed (or added) in the vertical direction are disposed such that the positions thereof are aligned in the horizontal direction (are arrayed in the vertical direction) has been illustrated, but the present disclosure is not limited thereto, and MIMO antennas may be disposed so that positions thereof in the horizontal direction are different from each other (for example, in the obliquely upward direction, in the obliquely downward direction).

### (Variation 4)

In the above-described embodiment, a BMS configuration (for example, two radar sections 10) by first radar section 10 and second radar section 10 has been described, but the number of radar sections 10 that constitute radar apparatus 1 is not limited to two. For example, a BMS configuration may use three or more radar sections 10, and the same effects as those in the above embodiments are obtained.

For example, in a case where three radar sections 10 (for example, first to third radar sections 10) are used and the above-described embodiment is applied, the operation is as follows.

For example, controller 304 outputs transmission switching control signals to transmitters 100 (SW sections 101) of radar sections 10 such that the transmission signals transmitted from first radar section 10, the transmission signals transmitted from second radar section 10, and the transmission signals transmitted from third radar section 10 are switched alternately in a time division manner for each transmission period Tr.

Each receiver 200 of each radar section 10 includes three DA sections 209, three CFAR sections 210, and three angle measurers 212 to receive reflected wave signals for transmission signals of respective radar sections 10 that transmitted in a time-division manner, individually receives and processes the reflected waves based on the transmission signals from respective radar sections 10, and outputs the processed reflected waves to integrator 30. The operations of each of them are the same as those in the embodiment described above, and the similar effects are obtained.

Note that, in the above, an example has been described in which two or more radar sections 10 are switched to transmit the transmission signals in a time-division manner, but the present disclosure is not limited thereto, and radar apparatus 1 may transmit the transmission signals from the plurality of radar sections 10 by simultaneous multiplexing transmissions by another multiplexing transmission method such as Doppler multiplexing or code-division multiplexing. Alternatively, radar apparatus 1 may transmit a transmission signal from two or more of the plurality of radar sections 10 by combining a plurality of simultaneous multiplexing transmission methods, such as a combination of time division transmission and Doppler multiplexing. For example, radar apparatus 1 may perform simultaneous multiplexing transmission such as Doppler multiplexing from two radar sections 10 of the plurality of radar sections 10, and may transmit by switching the combination of radar sections 10 to be simultaneously multiplexed in time division, and the same effects as those in the non-limiting embodiment of the present disclosure are obtained even in the configuration of three or more radar sections 10.

### (Variation 5)

Further, the MIMO antenna arrangement described in the present embodiment may be disposed with the up and down sides reversed, may be disposed with the left and right sides inverted, or may be disposed in the diagonal direction when mounted on a vehicle or the like, and the same effects as those in the non-limiting embodiment of the present disclosure are obtained. Further, in the MIMO antenna arrangement described in the present embodiment, the transmission antennas and the reception antennas may be exchanged.

One exemplary embodiment of the present disclosure has been described above.

### Other Embodiments

Regarding the above-described embodiments, the configuration has been described in which the chirp signals are used as TxSig, but TxSig may be signals differing from the chirp signals. For example, the TxSig may be a pulse compression wave, such as a coded pulse signal. When the coded pulse signal is used for TxSig, mixer 204 of reception radio 203 converts a high-frequency reception signal into a baseband signal, and a correlator (not illustrated) that correlates the high-frequency reception signal with the coded pulse signal transmitted is used instead of beat analyzer 208. Accordingly, the subsequent processing can be performed in the same manner as the processing according to each of the above-described embodiments, and the same effects can be obtained.

In the radar apparatus according to one exemplary embodiment of the present disclosure, the transmitter and the receiver may be individually arranged in physically separate locations from each other. In the receiver according to one exemplary embodiment of the present disclosure, the angle measurer and any other component may be individually arranged in physically separate locations.212 Angle measurer

Further, in an embodiment of the present disclosure, for example, the numerical values used for the parameters such as the number of transmission antennas, the number of reception antennas, the number of DDMs, the number of radars, the DDM interval, the parameter relating to the DDM interval (for example, δ_{q}), the parameter relating to the transmission period (for example, N_{sw}), the antenna spacing, and the antenna aperture length are merely examples and are not limited to the values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module”.

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit or a general-purpose processor and a memory. In addition, a Field Programmable Gate Array (FPGA) that can be programmed after the manufacture of the LSI or a reconfigurable processor in which the connections and the configurations of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one non-limiting and exemplary embodiment of the present disclosure includes: first radar circuitry that includes a plurality of first transmission antennas and a plurality of first reception antennas; and second radar circuitry that includes a plurality of second transmission antennas and a plurality of second reception antennas, in which the plurality of first transmission antennas transmit a first transmission signal having a predetermined center frequency, the plurality of second transmission antennas transmit a second transmission signal having the predetermined center frequency, the plurality of first reception antennas receive at least one of a first reflected wave signal corresponding to the first transmission signal and a second reflected wave signal corresponding to the second transmission signal, the plurality of second reception antennas receive at least one of the first reflected wave signal and the second reflected wave signal, and the minimum spacing between the plurality of first transmission antennas and the minimum spacing between the plurality of second reception antennas in the first direction are 0.5 wavelengths or more and less than 1 wavelength of the first and the second transmission signals.

In one non-limiting and exemplary embodiment of the present disclosure, in the first direction, the minimum spacing between the plurality of first reception antennas and the minimum spacing between the plurality of second transmission antennas are wider than the minimum spacing between the plurality of first transmission antennas and the minimum spacing between the plurality of second reception antennas.

In one non-limiting and exemplary embodiment of the present disclosure, in the first direction, an antenna spacing between adjacent ones of the plurality of first reception antennas includes a spacing wider than an aperture length of the plurality of first transmission antennas, and an antenna spacing between adjacent ones of the plurality of second transmission antennas includes a spacing wider than an aperture length of the plurality of second reception antennas.

In one non-limiting and exemplary embodiment of the present disclosure, in the first direction, an antenna spacing between adjacent ones of the plurality of second reception antennas includes a spacing wider than the aperture length of the plurality of first transmission antennas, or an antenna spacing between adjacent ones of the plurality of first transmission antennas includes a spacing wider than the aperture length of the plurality of second reception antennas.

In one non-limiting and exemplary embodiment of the present disclosure, in the first direction, a first antenna spacing between adjacent ones of the plurality of second transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals.

In one non-limiting and exemplary embodiment of the present disclosure, both of the plurality of first transmission antennas and the plurality of second transmission antennas include three or more antennas, and both of the plurality of first reception antennas and the plurality of second reception antennas include three or more antennas, and in the first direction, the minimum spacing between the plurality of first reception antennas and the minimum spacing between the plurality of second transmission antennas are 0.5 wavelengths or more and less than 1 wavelength of the first and the second transmission signals.

In one non-limiting and exemplary embodiment of the present disclosure, in the first direction, an antenna spacing between adjacent ones of the plurality of first reception antennas and an antenna spacing between adjacent ones of the plurality of second reception antennas include a spacing wider than an aperture length of the plurality of first transmission antennas, or an antenna spacing between adjacent ones of the plurality of first transmission antennas and an antenna spacing between adjacent ones of the plurality of second transmission antennas include a spacing wider than an aperture length of the plurality of second reception antennas.

In one non-limiting and exemplary embodiment of the present disclosure, in the first direction, a first antenna spacing between adjacent ones of the plurality of second transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals.

In one non-limiting and exemplary embodiment of the present disclosure, the first radar circuitry further includes control circuitry, which, when receiving the second reflected wave signal, determines, based on the second reflected wave signal, a direction of departure of the second transmission signal transmitted from the second radar circuitry and a direction of arrival of the second transmission signal received by the first radar circuitry, and, whether or not the second reflected wave signal is a direct wave from a target object based on a distance between the first radar circuitry and the target object reflecting the second transmission signal.

A radar apparatus according to one non-limiting and exemplary embodiment of the present disclosure includes: first radar circuitry that includes a plurality of first transmission antennas and a plurality of first reception antennas; and second radar circuitry that includes a plurality of second transmission antennas and a plurality of second reception antennas, in which the plurality of first transmission antennas transmit a first transmission signal having a predetermined center frequency, the plurality of second transmission antennas transmit a second transmission signal having the predetermined center frequency, the plurality of first reception antennas receive at least one of a first reflected wave signal corresponding to the first transmission signal and a second reflected wave signal corresponding to the second transmission signal, the plurality of second reception antennas receive at least one of the first reflected wave signal and the second reflected wave signal, and in a first direction, a minimum spacing between the plurality of first transmission antennas and a minimum spacing between the plurality of second reception antennas are different from each other by 1 wavelength or more of the first and the second transmission signals, and a minimum spacing between the plurality of first reception antennas and a minimum spacing between the plurality of second transmission antennas are different from each other by 1 wavelength or more of the first and the second transmission signals.

In one non-limiting and exemplary embodiment of the present disclosure, in the first direction, a first antenna spacing between adjacent ones of the plurality of first transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals, and a third antenna spacing between adjacent ones of the plurality of second transmission antennas and a fourth antenna spacing between adjacent ones of the plurality of second reception antennas include spacings which provide a difference between the third antenna spacing and the fourth antenna spacing, the difference being 0.5 wavelengths or more and 0.8 wavelengths or less of the first and the second transmission signals.

In one non-limiting and exemplary embodiment of the present disclosure, in the first direction, a first antenna spacing between adjacent ones of the plurality of first transmission antennas and a second antenna spacing between adjacent ones of the plurality of second reception antennas include spacings which provide a difference between the first antenna spacing and the second antenna spacing, the difference being 0.5 wavelengths or more and 0.8 wavelengths or less of the first and the second transmission signals, and a third antenna spacing between adjacent ones of the plurality of second transmission antennas and a fourth antenna spacing between adjacent ones of the plurality of first reception antennas include spacings which provide a difference between the third antenna spacing and the fourth antenna spacing, the difference being 0.5 wavelengths or more and 0.8 wavelengths or less of the first and the second transmission signals.

In one non-limiting and exemplary embodiment of the present disclosure, the first radar circuitry receives the second reflected wave signal, the second radar circuitry receives the first reflected wave signal, and the radar apparatus further comprises control circuitry, which, in operation, determines, based on a comparison between a positioning result obtained using the first reflected wave signal and a positioning result obtained using the second reflected wave signal, whether or not the first reflected wave signal and the second reflected wave signal are direct waves from a target object.

In one non-limiting and exemplary embodiment of the present disclosure, the minimum spacing between the plurality of first transmission antennas and the minimum spacing between the plurality of second transmission antennas are different from each other, or the minimum spacing between the plurality of first reception antennas and the minimum spacing between the plurality of second reception antennas are different from each other.

In one non-limiting and exemplary embodiment of the present disclosure, the plurality of first transmission antennas, the plurality of first reception antennas, the plurality of second transmission antennas, and the plurality of second reception antennas are two-dimensionally disposed, the two dimensions including the first direction and a second direction different from the first direction, in the second direction, the minimum spacing between the plurality of first transmission antennas and the minimum spacing between the plurality of second reception antennas are 0.5 wavelengths or more and less than 1 wavelength of the first and the second transmission signals, and the minimum spacing between the plurality of first reception antennas and the minimum spacing between the plurality of second transmission antennas are wider than the minimum spacing between the plurality of first transmission antennas and the minimum spacing between the plurality of second reception antennas.

In one non-limiting and exemplary embodiment of the present disclosure, in the second direction, an antenna spacing between adjacent ones of the plurality of first reception antennas includes a spacing wider than an aperture length of the plurality of first transmission antennas, and an antenna spacing between adjacent ones of the plurality of second transmission antennas includes a spacing wider than an aperture length of the plurality of second reception antennas.

In one non-limiting and exemplary embodiment of the present disclosure, in the second direction, an antenna spacing between adjacent ones of the plurality of second reception antennas includes a spacing wider than the aperture length of the plurality of first transmission antennas, or an antenna spacing between adjacent ones of the plurality of first transmission antennas includes a spacing wider than the aperture length of the plurality of second reception antennas.

In one non-limiting and exemplary embodiment of the present disclosure, the plurality of first transmission antennas, the plurality of first reception antennas, the plurality of second transmission antennas, and the plurality of second reception antennas are two-dimensionally disposed, the two dimensions including the first direction and a second direction different from the first direction, both of the plurality of first transmission antennas and the plurality of second transmission antennas include three or more antennas, and both of the plurality of first reception antennas and the plurality of second reception antennas include three or more antennas, and in the second direction, the minimum spacing between the plurality of first transmission antennas and the minimum spacing between the plurality of second reception antennas in the first direction are 0.5 wavelengths or more and less than 1 wavelength of the first and the second transmission signals, and the minimum spacing between the plurality of first reception antennas and the minimum spacing between the plurality of second transmission antennas are 0.5 wavelengths or more and less than 1 wavelength of the first and the second transmission signals.

In one non-limiting and exemplary embodiment of the present disclosure, in the second direction, an antenna spacing between adjacent ones of the plurality of first reception antennas and an antenna spacing between adjacent ones of the plurality of second reception antennas include a spacing wider than an aperture length of the plurality of first transmission antennas, or an antenna spacing between adjacent ones of the plurality of first transmission antennas and an antenna spacing between adjacent ones of the plurality of second transmission antennas include a spacing wider than an aperture length of the plurality of second reception antennas.

In one non-limiting and exemplary embodiment of the present disclosure, the plurality of first transmission antennas, the plurality of first reception antennas, the plurality of second transmission antennas, and the plurality of second reception antennas are two-dimensionally disposed, the two dimensions including the first direction and a second direction different from the first direction, in the second direction, a minimum spacing between the plurality of first transmission antennas and a minimum spacing between the plurality of second reception antennas are different from each other by 1 wavelength or more of the first and the second transmission signals, and a minimum spacing between the plurality of first reception antennas and a minimum spacing between the plurality of second transmission antennas are different from each other by 1 wavelength or more of the first and the second transmission signals.

In one non-limiting and exemplary embodiment of the present disclosure, in the second direction, a first antenna spacing between adjacent ones of the plurality of first transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals, and a third antenna spacing between adjacent ones of the plurality of second transmission antennas and a fourth antenna spacing between adjacent ones of the plurality of second reception antennas include spacings which provide a difference between the third antenna spacing and the fourth antenna spacing, the difference being 0.5 wavelengths or more and 0.8 wavelengths or less of the first and the second transmission signals.

In one non-limiting and exemplary embodiment of the present disclosure, in the second direction, the first antenna spacing and the fourth antenna spacing include spacings which provide a difference between the first antenna spacing and the fourth antenna spacing, the difference being 0.5 wavelengths or more and 0.8 wavelengths or less of the first and the second transmission signals, and the third antenna spacing and the second antenna spacing include spacings which provide a difference between the third antenna spacing and the second antenna spacing, the difference being 0.5 wavelengths or more and 0.8 wavelengths or less of the first and the second transmission signals.

A method for transmission and reception by a radar apparatus according to one non-limiting and exemplary embodiment of the present disclosure includes: transmitting, by first radar circuitry, a first transmission signal having a predetermined center frequency using a plurality of first transmission antennas; transmitting, by second radar circuitry, a second transmission signal having the predetermined center frequency using a plurality of second transmission antennas; receiving, by the first radar circuitry, at least one of a first reflected wave signal corresponding to the first transmission signal and a second reflected wave signal corresponding to the second transmission signal using a plurality of first reception antennas; and receiving, by the second radar circuitry, at least one of the first reflected wave signal and the second reflected wave signal using a plurality of second reception antennas, in which the minimum spacing between the plurality of first transmission antennas and the minimum spacing between the plurality of second reception antennas in the first direction are 0.5 wavelengths or more and less than 1 wavelength of the first and the second transmission signals.

A method for transmission and reception by a radar apparatus according to one non-limiting and exemplary embodiment of the present disclosure includes: transmitting, by first radar circuitry, a first transmission signal having a predetermined center frequency using a plurality of first transmission antennas; transmitting, by second radar circuitry, a second transmission signal having the predetermined center frequency using a plurality of second transmission antennas; receiving, by the first radar circuitry, at least one of a first reflected wave signal corresponding to the first transmission signal and a second reflected wave signal corresponding to the second transmission signal using a plurality of first reception antennas; and receiving, by the second radar circuitry, at least one of the first reflected wave signal and the second reflected wave signal using a plurality of second reception antennas, wherein in a first direction, a minimum spacing between the plurality of first transmission antennas and a minimum spacing between the plurality of second reception antennas are different from each other by 1 wavelength or more of the first and the second transmission signals, and a minimum spacing between the plurality of first reception antennas and a minimum spacing between the plurality of second transmission antennas are different from each other by 1 wavelength or more of the first and the second transmission signals.

While various embodiments have been described herein above, it is to be appreciated that various changes in form and detail may be made without departing from the sprit and scope of the disclosure(s) presently or hereafter claimed.

This application is entitled and claims the benefit of Japanese Patent Application No. 2023-185377, filed on Oct. 30, 2023, the disclosure of which including the specification, drawings and abstract is incorporated herein by reference in its entirety.

### INDUSTRIAL APPLICABILITY

The present disclosure is suitable as a radar apparatus for wide-angle range sensing.

### REFERENCE SIGNS LIST

1 Radar apparatus
10 Radar section
20, 20a Synchronizer
30 Integrator
100 Transmitter
101 Switch section
102 Doppler shifter
103 Transmission antenna
200, 200a Receiver
201 System processor
202 Reception antenna
203 Reception radio
204 Mixer
205 LPF
206 Analyzer
207 A/D converter
208 Beat analyzer
209 Doppler analyzer
210 CFAR section
211 Demultiplexer
212 Angle measurer
301 Generator
302 Modulation signal generator
303 VCO
304 Controller

1. A radar apparatus, comprising:
first radar circuitry which, in operation, includes a plurality of first transmission antennas and a plurality of first reception antennas; and
second radar circuitry which, in operation, includes a plurality of second transmission antennas and a plurality of second reception antennas, wherein
the plurality of first transmission antennas transmit a first transmission signal having a predetermined center frequency,
the plurality of second transmission antennas transmit a second transmission signal having the predetermined center frequency,
the plurality of first reception antennas receive at least one of a first reflected wave signal corresponding to the first transmission signal and a second reflected wave signal corresponding to the second transmission signal,
the plurality of second reception antennas receive at least one of the first reflected wave signal and the second reflected wave signal, and
in a first direction,
a minimum spacing between the plurality of first transmission antennas and a minimum spacing between the plurality of second reception antennas are different from each other by one wavelength or more of the first and the second transmission signals, and
a minimum spacing between the plurality of first reception antennas and a minimum spacing between the plurality of second transmission antennas are different from each other by one wavelength or more of the first and the second transmission signals.

2. The radar apparatus according to claim 1, wherein
in the first direction,
a first antenna spacing between adjacent ones of the plurality of first transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals, and
a third antenna spacing between adjacent ones of the plurality of second transmission antennas and a fourth antenna spacing between adjacent ones of the plurality of second reception antennas include spacings which provide a difference between the third antenna spacing and the fourth antenna spacing, the difference being 0.5 wavelengths or more and 0.8 wavelengths or less of the first and the second transmission signals.

3. The radar apparatus according to claim 1, wherein:
in the first direction,
a first antenna spacing between adjacent ones of the plurality of first transmission antennas and a second antenna spacing between adjacent ones of the plurality of second reception antennas include spacings which provide a difference between the first antenna spacing and the second antenna spacing, the difference being 0.5 wavelengths or more and 0.8 wavelengths or less of the first and the second transmission signals, and
a third antenna spacing between adjacent ones of the plurality of second transmission antennas and a fourth antenna spacing between adjacent ones of the plurality of first reception antennas include spacings which provide a difference between the third antenna spacing and the fourth antenna spacing, the difference being 0.5 wavelengths or more and 0.8 wavelengths or less of the first and the second transmission signals.

4. The radar apparatus according to claim 1, wherein:
the first radar circuitry which, in operation, receives the second reflected wave signal,
the second radar circuitry which, in operation, receives the first reflected wave signal, and
the radar apparatus further comprises control circuitry, which, in operation, determines, based on a comparison between a positioning result obtained using the first reflected wave signal and a positioning result obtained using the second reflected wave signal, whether or not the first reflected wave signal and the second reflected wave signal are direct waves from a target object.

5. The radar apparatus according to claim 1, wherein:
the minimum spacing between the plurality of first transmission antennas and the minimum spacing between the plurality of second transmission antennas are different from each other, or
the minimum spacing between the plurality of first reception antennas and the minimum spacing between the plurality of second reception antennas are different from each other.

6. The radar apparatus according to claim 1, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction, and
in the second direction,
the minimum spacing between the plurality of first transmission antennas and the minimum spacing between the plurality of second reception antennas are 0.5 wavelengths or more and less than one wavelength of the first and the second transmission signals, and
the minimum spacing between the plurality of first reception antennas and the minimum spacing between the plurality of second transmission antennas are wider than the minimum spacing between the plurality of first transmission antennas and the minimum spacing between the plurality of second reception antennas.

7. The radar apparatus according to claim 6, wherein:
in the second direction,
an antenna spacing between adjacent ones of the plurality of first reception antennas includes a spacing wider than an aperture length of the plurality of first transmission antennas, and
an antenna spacing between adjacent ones of the plurality of second transmission antennas includes a spacing wider than an aperture length of the plurality of second reception antennas.

8. The radar apparatus according to claim 7, wherein:
in the second direction,
an antenna spacing between adjacent ones of the plurality of second reception antennas includes a spacing wider than the aperture length of the plurality of first transmission antennas, or
an antenna spacing between adjacent ones of the plurality of first transmission antennas includes a spacing wider than the aperture length of the plurality of second reception antennas.

9. The radar apparatus according to claim 1, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction,
both of the plurality of first transmission antennas and the plurality of second transmission antennas include three or more antennas, and both of the plurality of first reception antennas and the plurality of second reception antennas include three or more antennas, and
in the second direction,
the minimum spacing between the plurality of first transmission antennas and the minimum spacing between the plurality of second reception antennas in the first direction are 0.5 wavelengths or more and less than one wavelength of the first and the second transmission signals, and
the minimum spacing between the plurality of first reception antennas and the minimum spacing between the plurality of second transmission antennas are 0.5 wavelengths or more and less than one wavelength of the first and the second transmission signals.

10. The radar apparatus according to claim 9, wherein
in the second direction,
an antenna spacing between adjacent ones of the plurality of first reception antennas and an antenna spacing between adjacent ones of the plurality of second reception antennas include a spacing wider than an aperture length of the plurality of first transmission antennas, or
an antenna spacing between adjacent ones of the plurality of first transmission antennas and an antenna spacing between adjacent ones of the plurality of second transmission antennas include a spacing wider than an aperture length of the plurality of second reception antennas.

11. The radar apparatus according to claim 1, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction, and
in the second direction,
the minimum spacing between the plurality of first transmission antennas and the minimum spacing between the plurality of second reception antennas are different from each other by one wavelength or more of the first and the second transmission signals, and
the minimum spacing between the plurality of first reception antennas and the minimum spacing between the plurality of second transmission antennas are different from each other by one wavelength or more of the first and the second transmission signals.

12. The radar apparatus according to claim 11, wherein
in the second direction,
a first antenna spacing between adjacent ones of the plurality of first transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals, and
a third antenna spacing between adjacent ones of the plurality of second transmission antennas and a fourth antenna spacing between adjacent ones of the plurality of second reception antennas include spacings which provide a difference between the third antenna spacing and the fourth antenna spacing, the difference being 0.5 wavelengths or more and 0.8 wavelengths or less of the first and the second transmission signals.

13. The radar apparatus according to claim 12, wherein
in the second direction,
the first antenna spacing and the fourth antenna spacing include spacings which provide a difference between the first antenna spacing and the fourth antenna spacing, the difference being 0.5 wavelengths or more and 0.8 wavelengths or less of the first and the second transmission signals, and
the third antenna spacing and the second antenna spacing include spacings which provide a difference between the third antenna spacing and the second antenna spacing, the difference being 0.5 wavelengths or more and 0.8 wavelengths or less of the first and the second transmission signals.

14. A method for transmission and reception by a radar apparatus, the method comprising:
transmitting, by first radar circuitry, a first transmission signal having a predetermined center frequency using a plurality of first transmission antennas;
transmitting, by second radar circuitry, a second transmission signal having the predetermined center frequency using a plurality of second transmission antennas;
receiving, by the first radar circuitry, at least one of a first reflected wave signal corresponding to the first transmission signal and a second reflected wave signal corresponding to the second transmission signal using a plurality of first reception antennas; and
receiving, by the second radar circuitry, at least one of the first reflected wave signal and the second reflected wave signal using a plurality of second reception antennas, wherein
in a first direction,
a minimum spacing between the plurality of first transmission antennas and a minimum spacing between the plurality of second reception antennas are different from each other by one wavelength or more of the first and the second transmission signals, and
a minimum spacing between the plurality of first reception antennas and a minimum spacing between the plurality of second transmission antennas are different from each other by one wavelength or more of the first and the second transmission signals.

15. The method for transmission and reception by a radar apparatus according to claim 14, wherein
in the first direction,
a first antenna spacing between adjacent ones of the plurality of first transmission antennas and a second antenna spacing between adjacent ones of the plurality of first reception antennas include spacings which provide a difference between the first antenna spacing and the second antenna spacing, the difference being 0.5 wavelengths or more and 0.8 wavelengths or less of the first and the second transmission signals, and
a third antenna spacing between adjacent ones of the plurality of second transmission antennas and a fourth antenna spacing between adjacent ones of the plurality of second reception antennas include spacings which provide a difference between the third antenna spacing and the fourth antenna spacing, the difference being 0.5 wavelengths or more and 0.8 wavelengths or less of the first and the second transmission signals.

16. The method for transmission and reception by a radar apparatus according to claim 14, wherein
in the first direction,
a first antenna spacing between adjacent ones of the plurality of first transmission antennas and a second antenna spacing between adjacent ones of the plurality of second reception antennas include spacings which provide a difference between the first antenna spacing and the second antenna spacing, the difference being 0.5 wavelengths or more and 0.8 wavelengths or less of the first and the second transmission signals, and
a third antenna spacing between adjacent ones of the plurality of second transmission antennas and a fourth antenna spacing between adjacent ones of the plurality of first reception antennas include spacings which provide a difference between the third antenna spacing and the fourth antenna spacing, the difference being 0.5 wavelengths or more and 0.8 wavelengths or less of the first and the second transmission signals.

17. The method for transmission and reception by a radar apparatus according to claim 14, wherein:
receiving, by the first radar circuitry, the second reflected wave signal using the plurality of first reception antennas,
receiving, by the second radar circuitry, the first reflected wave signal using the plurality of second reception antennas, and
the method further comprises determining, based on a comparison between a positioning result obtained using the first reflected wave signal and a positioning result obtained using the second reflected wave signal, whether or not the first reflected wave signal and the second reflected wave signal are direct waves from a target object.

18. The method for transmission and reception by a radar apparatus according to claim 14, wherein:
the minimum spacing between the plurality of first transmission antennas and the minimum spacing between the plurality of second transmission antennas are different from each other, or
the minimum spacing between the plurality of first reception antennas and the minimum spacing between the plurality of second reception antennas are different from each other.

19. The method for transmission and reception by a radar apparatus according to claim 14, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction, and
in the second direction,
the minimum spacing between the plurality of first transmission antennas and the minimum spacing between the plurality of second reception antennas are 0.5 wavelengths or more and less than one wavelength of the first and the second transmission signals, and
the minimum spacing between the plurality of first reception antennas and the minimum spacing between the plurality of second transmission antennas are wider than the minimum spacing between the plurality of first transmission antennas and the minimum spacing between the plurality of second reception antennas.

20. The method for transmission and reception by a radar apparatus according to claim 14, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction,
both of the plurality of first transmission antennas and the plurality of second transmission antennas include three or more antennas, and both of the plurality of first reception antennas and the plurality of second reception antennas include three or more antennas, and
in the second direction,
the minimum spacing between the plurality of first transmission antennas and the minimum spacing between the plurality of second reception antennas in the first direction are 0.5 wavelengths or more and less than one wavelength of the first and the second transmission signals, and
the minimum spacing between the plurality of first reception antennas and the minimum spacing between the plurality of second transmission antennas are 0.5 wavelengths or more and less than one wavelength of the first and the second transmission signals.

21. The method for transmission and reception by a radar apparatus according to claim 14, wherein:
the plurality of first transmission antennas, the plurality of first reception antennas, the plurality of second transmission antennas, and the plurality of second reception antennas are two-dimensionally disposed, the two dimensions including the first direction and a second direction different from the first direction, and
in the second direction,
the minimum spacing between the plurality of first transmission antennas and the minimum spacing between the plurality of second reception antennas are different from each other by one wavelength or more of the first and the second transmission signals, and
the minimum spacing between the plurality of first reception antennas and the minimum spacing between the plurality of second transmission antennas are different from each other by one wavelength or more of the first and the second transmission signals.
